(19) United States
(12) Patent Application Publication
(10) Pub. No.: US 2025/0391229 A1
(43) Pub. Date: Dec. 25, 2025

(54) ELECTRONIC GAMING SYSTEMS AND METHODS FOR PRESENTING A BONUS GAME WITH MULTIPLE METAMORPHIC GAME ENHANCEMENTS

(71) Applicant: Aristocrat Technologies, Inc., Las Vegas, NV (US)

(72) Inventor: Kevin Walcomb, Reno, NV (US)

(21) Appl. No.: 18/750,556

(22) Filed: Jun. 21, 2024

(51) Int. Cl. G07F 17/32; G07F 17/34

(52) U.S. Cl. CPC G07F 17/3213; G07F 17/3267; G07F 17/34

(57) ABSTRACT

An electronic gaming system includes a display device, and a game controller in communication with the display device. The game controller includes a processor and a memory, the memory for storing instructions, which when executed by the processor, cause the game controller to: control the display device to display a base reel game; control a plurality of reels to randomly display a game symbol; control the display device to display a base reel game outcome; determine that the base reel game outcome triggers a bonus reel game, the bonus reel game including at least one free spin and a plurality of metamorphic enhancement features; and determine the plurality of metamorphic enhancement features include: a grow feature for increasing a minimum grow value during the spin(s); and a collect feature for determining a collect value based on a cash-on-reel (COR) credit value displayed with the base reel game outcome.

### TECHNICAL FIELD

The field of disclosure relates generally to electronic gaming, and more specifically, to electronic gaming systems and methods that include presenting a bonus game with multiple metamorphic game enhancements.

### BACKGROUND

Electronic gaming machines (“EGMs”) or gaming devices provide a variety of wagering games such as slot games, video poker games, video blackjack games, roulette games, video bingo games, keno games and other types of games that are frequently offered at casinos and other locations. Play on EGMs typically involves a player establishing a credit balance by inputting money, or another form of monetary credit, and placing a monetary wager (from the credit balance) on one or more outcomes of an instance or (single play) of a primary or base game. In some cases, a player may qualify for a special mode of the base game, a secondary game, or a bonus round of the base game by attaining a certain winning combination or triggering event, in or related to, the base game, or after the player is randomly awarded the special mode, secondary game, or bonus round. In the special mode, secondary game, or bonus round, the player is given an opportunity to win extra game credits, game tokens or other forms of payout. In the case of “game credits” that are awarded during play, the game credits are typically added to a credit meter total on the EGM and can be provided to the player upon completion of a gaming session or when the player wants to “cash out.”

“Slot” type games are often displayed to the player in the form of various symbols arrayed in a row-by-column grid or matrix. Specific matching combinations of symbols along predetermined paths or (paylines) through the matrix indicate the outcome of the game. The display typically highlights winning combinations/outcomes for identification by the player. Matching combinations and their corresponding awards are usually shown in a “pay-table” which is available to the player for reference. Often, the player may vary his/her wager to include differing numbers of paylines and/or the amount bet on each line. By varying the wager, the player may sometimes alter the frequency or number of winning combinations, frequency or number of secondary games, and/or the amount awarded.

Typical games use a random number generator (RNG) to randomly determine the outcome of each game. The game is designed to return a certain percentage of the amount wagered back to the player over the course of many plays or instances of the game, which is generally referred to as return to player (RTP). The RTP and randomness of the RNG ensure the fairness of the games and are highly regulated. Notably, some games may include an element of skill on the part of the player and are therefore not entirely random.

### BRIEF DESCRIPTION

In one aspect, an electronic gaming system includes a display device, and a game controller in communication with the display device. The game controller includes at least one processor and at least one memory, the at least one memory for storing instructions, which when executed by the at least one processor, cause the game controller to: control the display device to display a base reel game including a plurality of reels, each reel of the plurality of reels for the base reel game including a predetermined number of rows: control the plurality of reels to randomly display a game symbol of a plurality of game symbols in each row of each reel of the plurality of reels: control the display device to display a base reel game outcome based on the randomly displayed plurality of game symbols in the plurality of reels: determine that the base reel game outcome triggers a bonus reel game, the bonus reel game including at least one free spin and a plurality of metamorphic enhancement features: and determine the plurality of metamorphic enhancement features include: a grow feature for increasing a minimum grow value during the at least one free spin: and a collect feature for determining a collect value based on a cash-on-reel (COR) credit value displayed with the base reel game outcome. The instructions may direct additional, less, or alternate functionality, including that discussed elsewhere herein.

In another aspect, a method of electronic gaming implemented on an electronic gaming machine includes: causing to be displayed a base reel game including a plurality of reels, each reel of the plurality of reels for the base reel game including a predetermined number of rows; controlling the plurality of reels to randomly display a game symbol of a plurality of game symbols in each row of each reel of the plurality of reels; causing to be displayed a base reel game outcome based on the randomly displayed plurality of game symbols in the plurality of reels; determining that the base reel game outcome triggers a bonus reel game, the bonus reel game including at least one free spin and a plurality of metamorphic enhancement features; and determining the plurality of metamorphic enhancement features include: a grow feature for increasing a minimum grow value during the at least one free spin; and a collect feature for determining a collect value based on a cash-on-reel (COR) credit value displayed with the base reel game outcome. The method may include additional less or alternate actions including those discussed elsewhere herein.

In an additional aspect, a non-transitory computer-readable storage medium with instructions stored thereon is provided. The instructions, in response to execution by at least one processor, cause the at least one processor to: control a display device to display a base reel game including a plurality of reels, each reel of the plurality of reels for the base reel game including a predetermined number of rows; control the plurality of reels to randomly display a game symbol of a plurality of game symbols in each row of each reel of the plurality of reels; control the display device to display a base reel game outcome based on the randomly displayed plurality of game symbols in the plurality of reels; determine that the base reel game outcome triggers a bonus reel game, the bonus reel game including at least one free spin and a plurality of metamorphic enhancement features; and determine the plurality of metamorphic enhancement features include: a grow feature for increasing a minimum grow value during the at least one free spin; and a collect feature for determining a collect value based on a cash-on-reel (COR) credit value displayed with the base reel game outcome. The instructions may direct additional, less, or alternate functionality, including that discussed elsewhere herein.

### BRIEF DESCRIPTION OF THE DRAWINGS

FIG. 1 is an exemplary diagram showing several EGMs networked with various gaming related servers.

FIG. 2A is a block diagram showing various functional elements of an exemplary EGM.

FIG. 2B depicts a casino gaming environment according to one example.

FIG. 2C is a diagram that shows examples of components of a system for providing online gaming according to some aspects of the present disclosure.

FIG. 3 illustrates in block diagram form, an implementation of a game processing architecture algorithm that implements a game processing pipeline for the play of a game in accordance with various implementations described herein.

FIG. 4 illustrates an example user interface or screenshot of a base reel game of an example electronic game in accordance with the present disclosure.

FIG. 5 illustrates an example user interface or screenshot of one implementation of a bonus reel game of the example electronic game without an enhancement feature in accordance with the present disclosure.

FIGS. 6 and 7 each illustrate an example user interface or screenshot of the base reel game shown in FIG. 4 where an expand enhancement symbol is displayed in a plurality of reels of the base reel game in accordance with the present disclosure.

FIGS. 8-10 each illustrate an example user interface or screenshot of another implementation of the bonus reel game shown in FIG. 5 and initiated after the base reel game shown in FIGS. 6 and 7, the bonus reel game having multiple free spins and an expand feature in accordance with the present disclosure.

FIG. 11 illustrates an example user interface or screenshot of the base reel game shown in FIG. 4 where a grow enhancement symbol is displayed in a plurality of reels of the base reel game in accordance with the present disclosure.

FIGS. 12-15 each illustrate an example user interface or screenshot of another implementation of the bonus reel game shown in FIG. 5 and initiated after the base reel game shown in FIG. 11, the bonus reel game having multiple free spins and a grow feature in accordance with the present disclosure.

FIG. 16 illustrates an example user interface or screenshot of the base reel game shown in FIG. 4 where a collect enhancement symbol is displayed in a plurality of reels of the base reel game in accordance with the present disclosure.

FIGS. 17-19 each illustrate an example user interface or screenshot of another implementation of the bonus reel game shown in FIG. 5 and initiated after the base reel game shown in FIG. 16, the bonus reel game having multiple free spins and a collect feature in accordance with the present disclosure.

FIG. 20 illustrates an example user interface or screenshot of the base reel game shown in FIG. 4 where a collect enhancement symbol is displayed in a plurality of reels of the base reel game triggering a cash-on-reel collection, in accordance with the present disclosure.

FIG. 21 is an example computer-implemented method of presenting one or more outcomes of a bonus reel game having one or more enhancement features.

FIGS. 22-25 illustrate example screenshots and or interfaces of an electronic game including bonus games with multiple metamorphic game enhancements in accordance with the present disclosure.

### DETAILED DESCRIPTION

In conventional electronic gaming systems and methods, awards and/or outcomes of a primary game may be presented to a player as awards and/or outcomes of a secondary game. For example, an electronic gaming device operating a Class II (e.g. bingo or keno) game may present an outcome of the Class II game as a reel game (e.g. a slot game) simulation. The outcome of the Class II game is determinative of an outcome of the simulated reel game. For example, an award value associated with the Class II game outcome may be presented in the simulated reel game outcome as a symbol combination and/or one or more special symbols that correspond to the same award value. In some known Class II games, the award value of the Class II game outcome may be partitioned or distributed across a base reel game outcome and one or more bonus reel game outcomes (e.g. outcomes of one or more free reel spins). For example, an award value associated with one or more winning bingo patterns may be presented as being awarded in a base reel game outcome and one or more bonus reel game outcomes. While some variations exist for presenting the Class II game outcome across the base reel game outcome and/or the one or more bonus reel game outcomes exist the variability and flexibility in presenting these outcomes remain limited. A need exists to address these limitations to facilitate increasing player excitement and engagement.

Embodiments of the present disclosure provide systems and methods for displaying base reel game outcomes that may include a triggering of one or more metamorphic enhancements, and at least one outcome of a bonus reel game that includes the one or more enhancement features. The enhancement features of the bonus reel game provide additional entertainment aspects of an electronic game by increasing the variability and flexibility in presenting winning outcomes of the bonus reel game. (e.g., winning symbol combinations and/or special symbols). The enhancement feature may include, for example, expanding a reel matrix displayed during the bonus game to increase a number of pay lines for winning symbol combinations and or to increase the number of positions in the reel matrix for a special symbol (e.g., a cash on reel symbol) to be displayed. The enhanced features may further include a “grow” feature for growing the credit value symbols (COR symbols also referred to herein as cash-on-reel symbols) displayed on the reel matrix and a “collect” feature for collecting the COR symbols displayed.

More specifically, the enhancement features may include an expand feature where a plurality of reels used to play the bonus reel game are incrementally increased with each consecutive free spin of the bonus reel game. The expanded reel provides additional symbol positions for players of the electronic gaming machine, which can increase their chances of winning and/or displaying special symbols (e.g., cash-on-reel (COR) symbols). The enhancement features may also include a grow feature which provides an increasing bonus for each free spin of the bonus reel game. The grow feature also increases any displayed COR symbols to be equal to or greater than the increasing bonus value during the free spins. The enhancement features can further include a collect feature, which allows players to collect additional credit values for COR symbols displayed during the free spins of the bonus reel game, by adding and/or multiplying associated credit values when multiple COR symbols appear on a single bonus reel game outcome. Additionally, special characters or symbols associated with the collect feature allow users to compound COR winnings when COR symbols appear in a base reel game outcome and the special symbol associated with the collect feature is displayed in the reel matrix during the base game. Moreover, various combinations of the enhancement features may be implemented to further increase the variability and flexibility in presenting winning outcomes of the bonus reel game. In example systems and methods described herein, the presented base reel game outcome and bonus reel game outcome(s) correspond to an output of a gaming device. The output of the gaming device may be a primary game outcome, such as a Class II (e.g., bingo) game outcome, a Class III (e.g., RNG based) game outcome and/or an outcome of another wagering game. In Class II games, a total award value of one or more winning outcomes (e.g., winning bingo patterns) may be partitioned or distributed across a base reel game outcome and one or more bonus game outcomes. Applying one or more enhancement feature(s) to the bonus reel game facilitates increasing the flexibility and variability in how Class II game outcomes are presented as an outcome of the bonus reel game, and facilitates increasing player excitement during the bonus reel game as each enhancement feature may be perceived as providing an additional opportunity for a winning bonus reel game outcome (e.g., by expanding the reel matrix and/or spinning a different set of reels that include special symbols associated with a credit or monetary value when displayed and or an increased monetary value awarded for a winning bonus reel game outcome (e.g., by applying a multiplier to each winning outcome). In Class III games, the gaming device output may itself be the outcome of the base reel and bonus reel games (e.g., the gaming device output may be a randomly determined symbol combination and/or special symbol(s) displayed in the game outcome), and the enhancement features may be randomly applied to provide additional opportunities to achieve a winning outcome of the bonus reel game outcome and/or to increase a value awarded for a winning bonus reel game outcome, thereby facilitating increasing randomness in Class III bonus reel game outcomes and increasing player excitement and engagement.

Example systems and methods described herein may include causing display of visual effects that are each associated with one of the enhancement features. For example, one or more metamorphics, each associated with one of the enhancement feature(s), may be displayed. Metamorphics include symbols or other graphics capable of transforming (e.g., “metamorphosing”), and as each metamorphic transforms, players may experience a sense that a game feature has been triggered or that the metamorphics are slowly maturing towards a trigger condition for a game feature. In the example embodiments, through the use of metamorphics and other visual graphics, players of the gaming machine can follow, anticipate, and/or feel excited about the potential of the bonus reel game being triggered with free spins and additional, unique enhancement features.

In the example systems and methods described herein, the metamorphics transform between inactive, intermediate, and active states, and as the metamorphics transform, players receive a visual indication as to whether a bonus reel game that is triggered during play of a base reel game includes one or more of the enhancement features. Transformation of the metamorphics may be tied to a base reel game outcome. For example, in a base reel game outcome one or more enhancement symbols may be displayed in a reel matrix, each of the one or more enhancement symbols being associated with one of the enhancement features. For a Class II game, display of an enhancement symbol in the reel matrix in the base reel game outcome may be controlled based on a Class II game (e.g., bingo) outcome and is perceived as triggering an enhancement features of the bonus reel game if the bonus reel game is also triggered during the base reel game. For a Class III game, display of an enhancement symbol in the reel matrix in a base reel game outcome may be randomly determined (e.g., by an RNG outcome) and may serve as the trigger for an enhancement feature of the bonus reel game. In both cases, a visual representation may be displayed that indicates that the at least one enhancement symbol being displayed in the base reel game outcome triggers the enhancement feature of the bonus reel game. For example, upon display of an metamorphic enhancement feature symbol in a base reel game outcome an associated metamorphic may transform to an active state which indicates that a bonus reel game with the associated enhancement feature has been triggered.

The example systems and methods of the present disclosure represent a technical improvement in the field of electronic gaming. Technical improvements represented by the present disclosure include: (i) presenting Class II and Class III game outcomes as one or more outcomes of a bonus reel game having one or more enhancement features; (ii) storing multiple reel sets or distinct reel symbols in a memory that may be added to an expanding plurality of reels during a bonus reel game; (iii) applying one or more enhancement features to the bonus reel game in varying combinations concurrently; (iv) utilizing a special or trigger symbol associated with the enhancement feature for the bonus reel game to provide additional gameplay features winning opportunities in the base reel game; (v) increasing the flexibility and variability in presenting award values of a game outcome as one or more bonus reel game outcomes to facilitate increasing player interest and excitement; (vi) displaying immediate bonus reel game feedback to a player; and/or (vii) displaying potential reward opportunities to the player for a bonus reel game in advance of triggering the bonus reel game. Additional and or alternative technical improvements may exist.

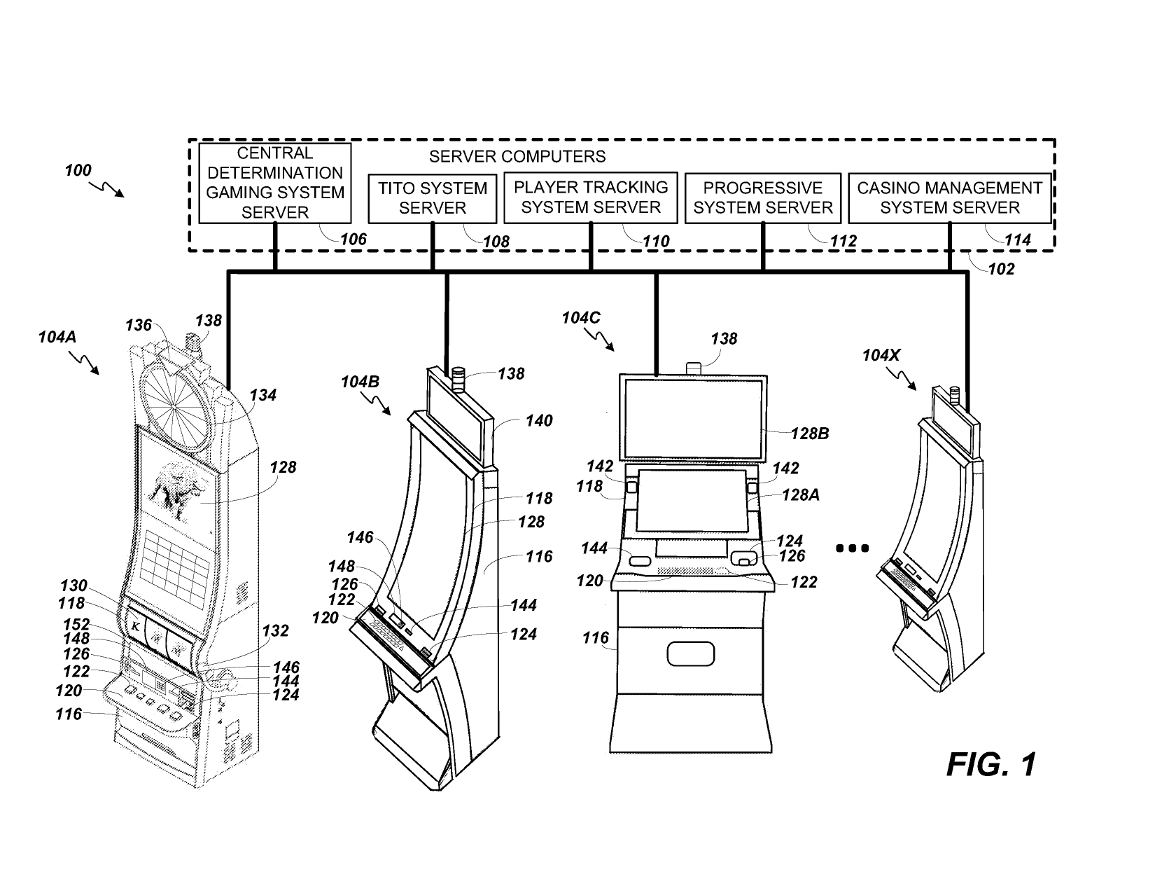

FIG. 1 illustrates several different models of EGMs which may be networked to various gaming related servers. Shown is a system 100 in a gaming environment including one or more server computers 102 (e.g., slot servers of a casino) that are in communication, via a communications network, with one or more gaming devices 104A-104X (EGMs, slots, video poker, bingo machines, etc.) that can implement one or more aspects of the present disclosure. The gaming devices 104A-104X may alternatively be portable and/or remote gaming devices such as, but not limited to, a smart phone, a tablet, a laptop, or a game console. Gaming devices 104A-104X utilize specialized software and/or hardware to form non-generic, particular machines or apparatuses that comply with regulatory requirements regarding devices used for wagering or games of chance that provide monetary awards.

Communication between the gaming devices 104A-104X and the server computers 102, and among the gaming devices 104A-104X, may be direct or indirect using one or more communication protocols. As an example, gaming devices 104A-104X and the server computers 102 can communicate over one or more communication networks, such as over the Internet through a website maintained by a computer on a remote server or over an online data network including commercial online service providers, Internet service providers private networks (e.g., local area networks and enterprise networks) and the like (e.g., wide area networks). The communication networks could allow gaming devices 104A-104X to communicate with one another and/or the server computers 102 using a variety of communication-based technologies, such as radio frequency (RF) (e.g., wireless fidelity (WiFi® and Bluetooth®), cable TV, satellite links and the like.

In some implementation, server computers 102 may not be necessary and/or preferred. For example, in one or more implementations, a stand-alone gaming device such as gaming device 104A, gaming device 104B or any of the other gaming devices 104C-104X can implement one or more aspects of the present disclosure. However, it is typical to find multiple EGMs connected to networks implemented with one or more of the different server computers 102 described herein.

The server computers 102 may include a central determination gaming system server 106, a ticket-in-ticket-out (TITO) system server 108, a player tracking system server 110, a progressive system server 112, and/or a casino management system server 114. Gaming devices 104A-104X may include features to enable operation of any or all servers for use by the player and/or operator (e.g., the casino, resort, gaming establishment, tavern, pub, etc.). For example, game outcomes may be generated on a central determination gaming system server 106 and then transmitted over the network to any of a group of remote terminals or remote gaming devices 104A-104X that utilize the game outcomes and display the results to the players.

Gaming device 104A is often of a cabinet construction which may be aligned in rows or banks of similar devices for placement and operation on a casino floor. The gaming device 104A often includes a main door which provides access to the interior of the cabinet. Gaming device 104A typically includes a button area or button deck 120 accessible by a player that is configured with input switches or buttons 122 an access channel for a bill validator 124, and/or an access channel for a ticket-out printer 126.

In FIG. 1, gaming device 104A is shown as a Relm XLTM model gaming device manufactured by Aristocrat® Technologies Inc. As shown, gaming device 104A is a reel machine having a gaming display area 118 comprising a number (typically 3 or 5) of mechanical reels 130 with various symbols displayed on them. The mechanical reels 130 are independently spun and stopped to show a set of symbols within the gaming display area 118 which may be used to determine an outcome to the game.

In many configurations, the gaming device 104A may have a main display 128 (e.g., video display monitor) mounted to, or above, the gaming display area 118. The main display 128 can be a high-resolution liquid crystal display (LCD), plasma, light emitting diode (LED), or organic light emitting diode (OLED) panel which may be flat or curved as shown, a cathode ray tube or other conventional electronically controlled video monitor.

In some implementations, the bill validator 124 may also function as a “ticket-in” reader that allows the player to use a casino issued credit ticket to load credits onto the gaming device 104A (e.g. in a cashless ticket (“TITO”) system). In such cashless implementations the gaming device 104A may also include a “ticket-out” printer 126 for outputting a credit ticket when a “cash out” button is pressed. Cashless TITO systems are used to generate and track unique bar-codes or other indicators printed on tickets to allow players to avoid the use of bills and coins by loading credits using a ticket reader and cashing out credits using a ticket-out printer 126 on the gaming device 104A. The gaming device 104A can have hardware meters for purposes including ensuring regulatory compliance and monitoring the player credit balance. In addition there can be additional meters that record the total amount of money wagered on the gaming device, total amount of money deposited, total amount of money withdrawn, total amount of winnings on gaming device 104A.

In some implementations, a player tracking card reader 144, a transceiver for wireless communication with a mobile device (e.g., a player’s smartphone), a keypad 146, and/or an illuminated display 148 for reading, receiving, entering, and/or displaying player tracking information is provided in gaming device 104A. In such implementations, a game controller within the gaming device 104A can communicate with the player tracking system server 110 to send and receive player tracking information.

Gaming device 104A may also include a bonus topper wheel 134. When bonus play is triggered (e.g., by a player achieving a particular outcome or set of outcomes in the primary game), bonus topper wheel 134 is operative to spin and stop with indicator arrow 136 indicating the outcome of the bonus game. Bonus topper wheel 134 is typically used to play a bonus game, but it could also be incorporated into play of the base or primary game.

A candle 138 may be mounted on the top of gaming device 104A and may be activated by a player (e.g., using a switch or one of buttons 122) to indicate to operations staff that gaming device 104A has experienced a malfunction or the player requires service. The candle 138 is also often used to indicate a jackpot has been won and to alert staff that a hand payout of an award may be needed.

There may also be one or more information panels 152 which may be a back-lit, silkscreened glass panel with lettering to indicate general game information including, for example a game denomination (e.g. $0.25 or $1), pay lines, pay tables, and/or various game related graphics. In some implementations, the information panel(s) 152 may be implemented as an additional video display.

Gaming devices 104A have traditionally also included a handle 132 typically mounted to the side of main cabinet 116 which may be used to initiate game play.

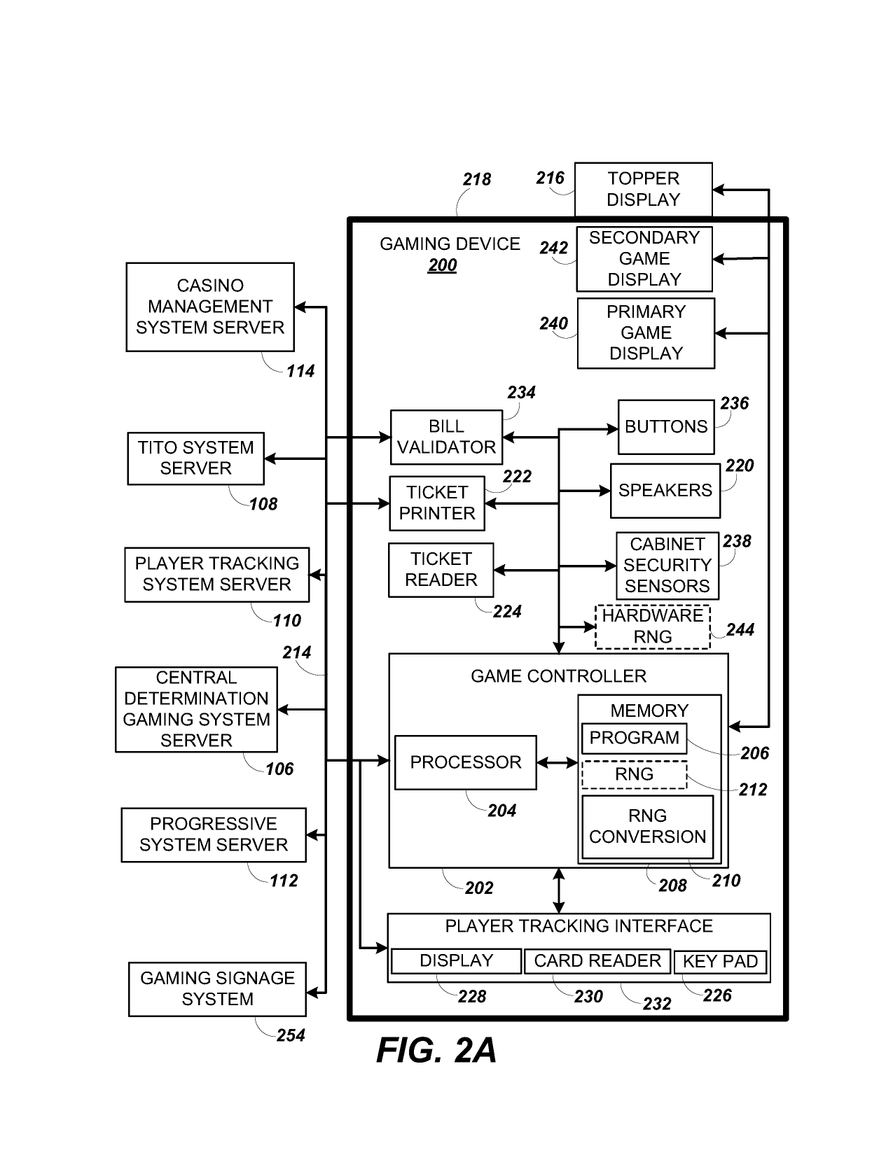

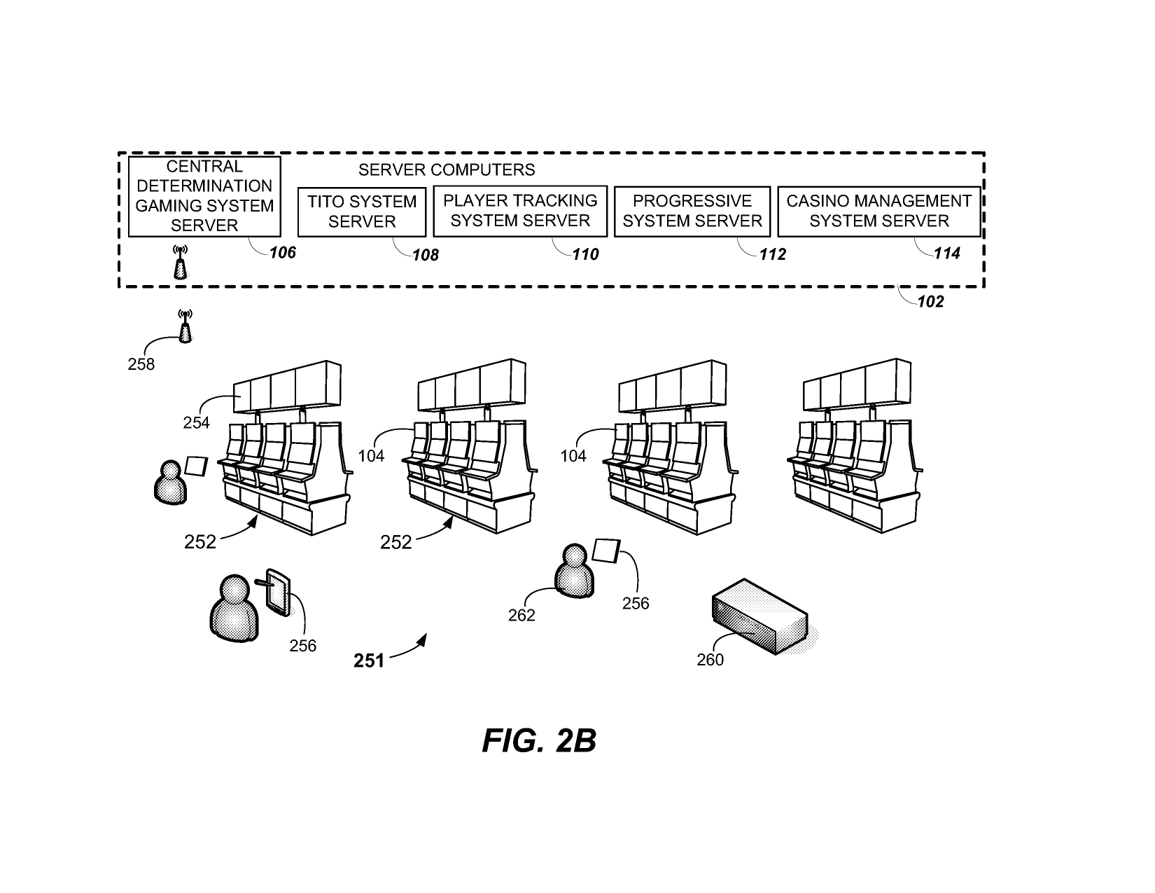

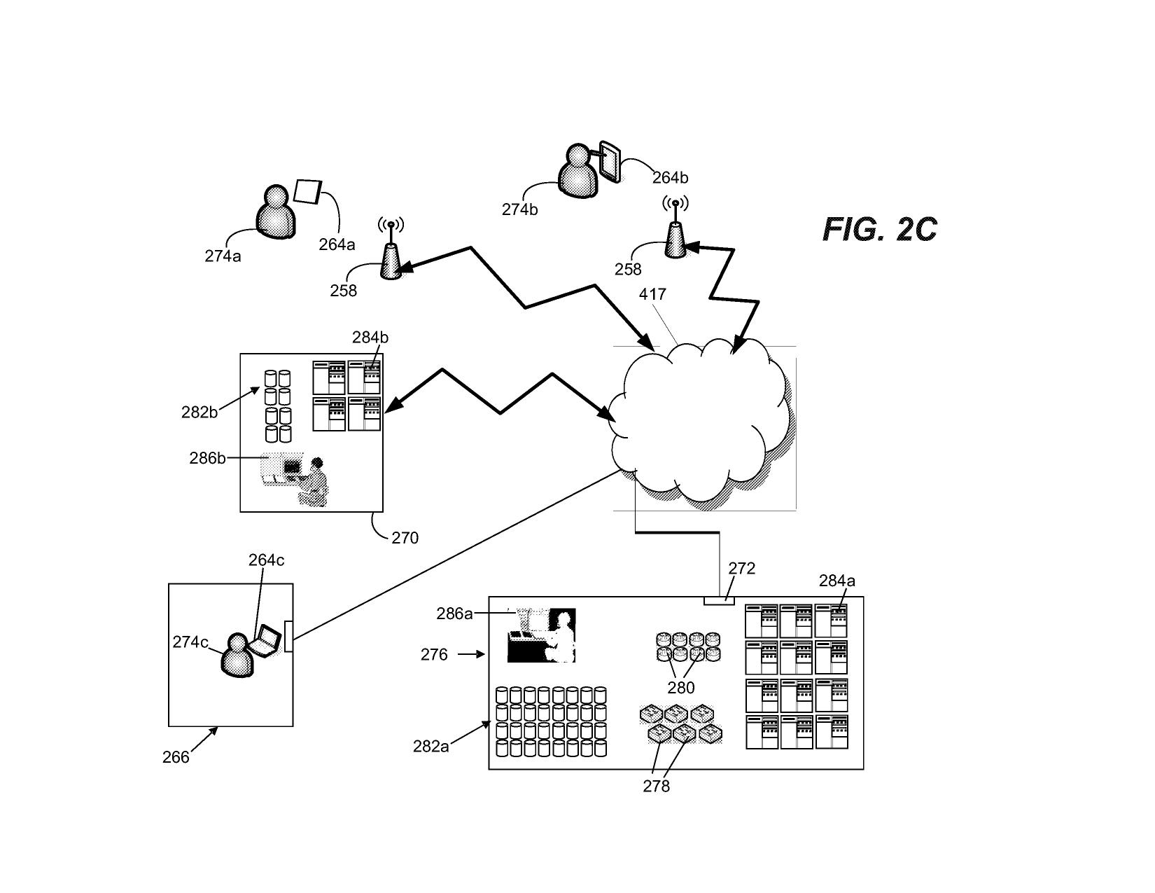

Many or all the above-described components can be controlled by circuitry (e.g., a game controller) housed inside the main cabinet 116 of the gaming device 104A, the details of which are shown in FIG. 2A.

An alternative example gaming device 104B illustrated in FIG. 1 is the ArcTM model gaming device manufactured by Aristocrat® Technologies Inc. Note that where possible, reference numerals identifying similar features of the gaming device 104A implementation are also identified in the gaming device 104B implementation using the same reference numbers. Gaming device 104B does not include physical reels and instead shows game play functions on main display 128. An optional topper screen 140 may be used as a secondary game display for bonus play, to show game features or attraction activities while a game is not in play, or any other information or media desired by the game designer or operator. In some implementations, the optional topper screen 140 may also or alternatively be used to display progressive jackpot prizes available to a player during play of gaming device 104B.

Example gaming device 104B includes a main cabinet 116 including a main door which opens to provide access to the interior of the gaming device 104B. The main or service door is typically used by service personnel to refill the ticket-out printer 126 and collect bills and tickets inserted into the bill validator 124. The main or service door may also be accessed to reset the machine, verify and/or upgrade the software, and for general maintenance operations.

Another example gaming device 104C shown is the Helix^{TM} model gaming device manufactured by Aristocrat® Technologies Inc. Gaming device 104C includes a main display 128A that is in a landscape orientation. Although not illustrated by the front view provided the main display 128A may have a curvature radius from top to bottom, or alternatively from side to side. In some implementations, main display 128A is a flat panel display. Main display 128A is typically used for primary game play while secondary display 128B is typically used for bonus game play, to show game features or attraction activities while the game is not in play or any other information or media desired by the game designer or operator. In some implementations, example gaming device 104C may also include speakers 142 to output various audio such as game sound, background music, etc.

Many different types of games, including mechanical slot games, video slot games, video poker, video blackjack, video pachinko, keno, bingo, and lottery, may be provided with or implemented within the depicted gaming devices 104A-104C and other similar gaming devices. Each gaming device may also be operable to provide many different games. Games may be differentiated according to themes, sounds, graphics, type of game (e.g., slot game vs. card game vs. game with aspects of skill), denomination, number of paylines, maximum jackpot, progressive or non-progressive, bonus games, and may be deployed for operation in Class 2 or Class 3, etc.

FIG. 2A is a block diagram depicting exemplary internal electronic components of a gaming device 200 connected to various external systems. All or parts of the gaming device 200 shown could be used to implement any one of the example gaming devices 104A-X depicted in FIG. 1. As shown in FIG. 2A, gaming device 200 includes a topper display 216 or another form of a top box (e.g., a topper wheel, a topper screen, etc.) that sits above cabinet 218. Cabinet 218 or topper display 216 may also house a number of other components which may be used to add features to a game being played on gaming device 200, including speakers 220, a ticket printer 222 which prints bar-coded tickets or other media or mechanisms for storing or indicating a player’s credit value a ticket reader 224 which reads bar-coded tickets or other media or mechanisms for storing or indicating a player’s credit value, and a player tracking interface 232. Player tracking interface 232 may include a keypad 226 for entering information, a player tracking display 228 for displaying information (e.g., an illuminated or video display a card reader 230 for receiving data and/or communicating information to and from media or a device such as a smart phone enabling player tracking. FIG. 2A also depicts utilizing a ticket printer 222 to print tickets for a TITO system server 108. Gaming device 200 may further include a bill validator 234, player-input buttons 236 for player input, cabinet security sensors 238 to detect unauthorized opening of the cabinet 218, a primary game display 240, and a secondary game display 242, each coupled to and operable under the control of game controller 202.

The games available for play on the gaming device 200 are controlled by a game controller 202 that includes one or more processors 204. Processor 204 represents a general-purpose processor, a specialized processor intended to perform certain functional tasks, or a combination thereof. As an example, processor 204 can be a central processing unit (CPU) that has one or more multi-core processing units and memory mediums (e.g., cache memory) that function as buffers and/or temporary storage for data. Alternatively, processor 204 can be a specialized processor, such as an application specific integrated circuit (ASIC), graphics processing unit (GPU), field-programmable gate array (FPGA), digital signal processor (DSP), or another type of hardware accelerator. In another example, processor 204 is a system on chip (SoC) that combines and integrates one or more general-purpose processors and/or one or more specialized processors. Although FIG. 2A illustrates that game controller 202 includes a single processor 204 game controller 202 is not limited to this representation and instead can include multiple processors 204 (e.g., two or more processors).

FIG. 2A illustrates that processor 204 is operatively coupled to memory 208. Memory 208 is defined herein as including volatile and nonvolatile memory and other types of non-transitory data storage components. Volatile memory is memory that do not retain data values upon loss of power. Nonvolatile memory is memory that do retain data upon a loss of power. Examples of memory 208 include random access memory (RAM), read-only memory (ROM), hard disk drives, solid-state drives, universal serial bus (USB) flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, examples of RAM include static random-access memory (SRAM), dynamic random access memory (DRAM), magnetic random access memory (MRAM), and other such devices. Examples of ROM include a programmable read-only memory (PROM), an erasable programmable read-only memory (EPROM), an electrically erasable programmable read-only memory (EEPROM), or other like memory device. Even though FIG. 2A illustrates that game controller 202 includes a single memory 208, game controller 202 could include multiple memories 208 for storing program instructions and/or data.

Memory 208 can store one or more game programs 206 that provide program instructions and/or data for carrying out various implementations (e.g., game mechanics) described herein. Stated another way, game program 206 represents an executable program stored in any portion or component of memory 208. In one or more implementations, game program 206 is embodied in the form of source code that includes human-readable statements written in a programming language or machine code that contains numerical instructions recognizable by a suitable execution system, such as a processor 204 in a game controller or other system. Examples of executable programs include (1) a compiled program that can be translated into machine code in a format that can be loaded into a random access portion of memory 208 and run by processor 204; (2) source code that may be expressed in proper format such as object code that is capable of being loaded into a random access portion of memory 208 and executed by processor 204, and (3) source code that may be interpreted by another executable program to generate instructions in a random access portion of memory 208 to be executed by processor 204.

Alternatively, game programs 206 can be set up to generate one or more game instances based on instructions and/or data that gaming device 200 exchanges with one or more remote gaming devices, such as a central determination gaming system server 106 (not shown in FIG. 2A but shown in FIG. 1). For purpose of this disclosure, the term “game instance” refers to a play or a round of a game that gaming device 200 presents (e.g., via a user interface (UI) to a player. The game instance is communicated to gaming device 200 via the network 214 and then displayed on gaming device 200. For example, gaming device 200 may execute game program 206 as video streaming software that allows the game to be displayed on gaming device 200. When a game is stored on gaming device 200, it may be loaded from memory 208 (e.g., from a read only memory (ROM) or from the central determination gaming system server 106 to memory 208.

Gaming devices, such as gaming device 200, are highly regulated to ensure fairness and, in many cases, gaming device 200 is operable to award monetary awards (e.g., typically dispensed in the form of a redeemable voucher). Therefore, to satisfy security and regulatory requirements in a gaming environment, hardware and software architectures are implemented in gaming devices 200 that differ significantly from those of general-purpose computers. Adapting general purpose computers to function as gaming devices 200 is not simple or straightforward because of: (1) the regulatory requirements for gaming devices 200, (2) the harsh environment in which gaming devices 200 operate, (3) security requirements, (4) fault tolerance requirements, and (5) the requirement for additional special purpose componentry enabling functionality of an EGM. These differences require substantial engineering effort with respect to game design implementation, game mechanics, hardware components, and software.

One regulatory requirement for games running on gaming device 200 generally involves complying with a certain level of randomness. Typically, gaming jurisdictions mandate that gaming devices 200 satisfy a minimum level of randomness without specifying how a gaming device 200 should achieve this level of randomness. To comply, FIG. 2A illustrates that gaming device 200 could include an RNG 212 that utilizes hardware and or software to generate RNG outcomes that lack any pattern. The RNG operations are often specialized and non-generic in order to comply with regulatory and gaming requirements. For example, in a slot game, game program 206 can initiate multiple RNG calls to RNG 212 to generate RNG outcomes, where each RNG call and RNG outcome corresponds to an outcome for a reel. In another example, gaming device 200 can be a Class II gaming device where RNG 212 generates RNG outcomes for creating Bingo cards. In one or more implementations, RNG 212 could be one of a set of RNGs operating on gaming device 200. More generally, an output of the RNG 212 can be the basis on which game outcomes are determined by the game controller 202. Game developers could vary the degree of true randomness for each RNG (e.g., pseudorandom) and utilize specific RNGs depending on game requirements. The output of the RNG 212 can include a random number or pseudorandom number (either is generally referred to as a “random number”).

In FIG. 2A, RNG 212 and hardware RNG 244 are shown in dashed lines to illustrate that RNG 212, hardware RNG 244, or both can be included in gaming device 200. In one implementation, instead of including RNG 212,gaming device 200 could include a hardware RNG 244 that generates RNG outcomes. Analogous to RNG 212, hardware RNG 244 performs specialized and non-generic operations in order to comply with regulatory and gaming requirements. For example, because of regulation requirements, hardware RNG 244 could be a random number generator that securely produces random numbers for cryptography use. The gaming device 200 then uses the secure random numbers to generate game outcomes for one or more game features. In another implementation, the gaming device 200 could include both hardware RNG 244 and RNG 212. RNG 212 may utilize the RNG outcomes from hardware RNG 244 as one of many sources of entropy for generating secure random numbers for the game features.

Another regulatory requirement for running games on gaming device 200 includes ensuring a certain level of RTP. Similar to the randomness requirement discussed above, numerous gaming jurisdictions also mandate that gaming device 200 provides a minimum level of RTP (e.g., RTP of at least 75%). A game can use one or more lookup tables (also called weighted tables) as part of a technical solution that satisfies regulatory requirements for randomness and RTP. In particular, a lookup table can integrate game features (e.g., trigger events for special modes or bonus games; newly introduced game elements such as extra reels, new symbols, or new cards; stop positions for dynamic game elements such as spinning reels, spinning wheels, or shifting reels; or card selections from a deck) with random numbers generated by one or more RNGs, so as to achieve a given level of volatility for a target level of RTP. (In general, volatility refers to the frequency or probability of an event such as a special mode, payout, etc. For example, for a target level of RTP, a higher-volatility game may have a lower payout most of the time with an occasional bonus having a very high payout, while a lower-volatility game has a steadier payout with more frequent bonuses of smaller amounts.) Configuring a lookup table can involve engineering decisions with respect to how RNG outcomes are mapped to game outcomes for a given game feature, while still satisfying regulatory requirements for RTP. Configuring a lookup table can also involve engineering decisions about whether different game features are combined in a given entry of the lookup table or split between different entries (for the respective game features), while still satisfying regulatory requirements for RTP and allowing for varying levels of game volatility.

FIG. 2A illustrates that gaming device 200 includes an RNG conversion engine 210 that translates the RNG outcome from RNG 212 to a game outcome presented to a player. To meet a designated RTP, a game developer can set up the RNG conversion engine 210 to utilize one or more lookup tables to translate the RNG outcome to a symbol element, stop position on a reel strip layout, and/or randomly chosen aspect of a game feature. As an example, the lookup tables can regulate a prize payout amount for each RNG outcome and how often the gaming device 200 pays out the prize payout amounts. The RNG conversion engine 210 could utilize one lookup table to map the RNG outcome to a game outcome displayed to a player and a second lookup table as a pay table for determining the prize payout amount for each game outcome. The mapping between the RNG outcome to the game outcome controls the frequency in hitting certain prize payout amounts.

FIG. 2A also depicts that gaming device 200 is connected over network 214 to player tracking system server 110. Player tracking system server 110 may be, for example, an OASIS® system manufactured by Aristocrat® Technologies, Inc. Player tracking system server 110 is used to track play (e.g., amount wagered, games played, time of play and/or other quantitative or qualitative measures) for individual players so that an operator may reward players in a loyalty program. The player may use the player tracking interface 232 to access his/her account information, activate free play, and/or request various information. Player tracking or loyalty programs seek to reward players for their play and help build brand loyalty to the gaming establishment. The rewards typically correspond to the player's level of patronage (e.g., to the player's playing frequency and/or total amount of game plays at a given casino). Player tracking rewards may be complimentary and/or discounted meals, lodging, entertainment and/or additional play. Player tracking information may be combined with other information that is now readily obtainable by a casino management system.

When a player wishes to play the gaming device 200, he/she can insert cash or a ticket voucher through a coin acceptor (not shown) or bill validator 234 to establish a credit balance on the gaming device. The credit balance is used by the player to place wagers on instances of the game and to receive credit awards based on the outcome of winning instances. The credit balance is decreased by the amount of each wager and increased upon a win. The player can add additional credits to the balance at any time. The player may also optionally insert a loyalty club card into the card reader 230. During the game, the player views with one or more UIs, the game outcome on one or more of the primary game display 240 and secondary game display 242. Other game and prize information may also be displayed.

For each game instance, a player may make selections, which may affect play of the game. For example, the player may vary the total amount wagered by selecting the amount bet per line and the number of lines played. In many games, the player is asked to initiate or select options during course of game play (such as spinning a wheel to begin a bonus round or select various items during a feature game). The player may make these selections using the player-input buttons 236, the primary game display 240 which may be a touch screen, or using some other device which enables a player to input information into the gaming device 200.

During certain game events, the gaming device 200 may display visual and auditory effects that can be perceived by the player. These effects add to the excitement of a game, which makes a player more likely to enjoy the playing experience. Auditory effects include various sounds that are projected by the speakers 220. Visual effects include flashing lights, strobing lights or other patterns displayed from lights on the gaming device 200 or from lights behind the information panel 152(FIG. 1).

When the player is done, he/she cashes out the credit balance (typically by pressing a cash out button to receive a ticket from the ticket printer 222). The ticket may be “cashed-in” for money or inserted into another machine to establish a credit balance for play.

Additionally, or alternatively, gaming devices 104A-104X and 200 can include or be coupled to one or more wireless transmitters, receivers, and/or transceivers (not shown in FIGS. 1 and 2A) that communicate (e.g., Bluetooth® or other near-field communication technology) with one or more mobile devices to perform a variety of wireless operations in a casino environment. Examples of wireless operations in a casino environment include detecting the presence of mobile devices, performing credit, points, comps, or other marketing or hard currency transfers, establishing wagering sessions, and/or providing a personalized casino-based experience using a mobile application. In one implementation, to perform these wireless operations, a wireless transmitter or transceiver initiates a secure wireless connection between a gaming device 104A-104X and 200 and a mobile device. After establishing a secure wireless connection between the gaming device 104A-104X and 200 and the mobile device, the wireless transmitter or transceiver does not send and/or receive application data to and or from the mobile device. Rather, the mobile device communicates with gaming devices 104A-104X and 200 using another wireless connection (e.g., WiFi® or cellular network). In another implementation, a wireless transceiver establishes a secure connection to directly communicate with the mobile device. The mobile device and gaming device 104A-104X and 200 sends and receives data utilizing the wireless transceiver instead of utilizing an external network. For example, the mobile device would perform digital wallet transactions by directly communicating with the wireless transceiver. In one or more implementations, a wireless transmitter could broadcast data received by one or more mobile devices without establishing a pairing connection with the mobile devices.

Although FIGS. 1 and 2A illustrate specific implementations of a gaming device (e.g., gaming devices 104A-104X and 200), the disclosure is not limited to those implementations shown in FIGS. 1 and 2. For example, not all gaming devices suitable for implementing implementations of the present disclosure necessarily include top wheels, top boxes, information panels, cashless ticket systems, and/or player tracking systems. Further, some suitable gaming devices have only a single game display that includes only a mechanical set of reels and/or a video display, while others are designed for bar counters or tabletops and have displays that face upwards. Gaming devices 104A-104X and 200 may also include other processors that are not separately shown. Using FIG. 2A as an example, gaming device 200 could include display controllers (not shown in FIG. 2A) configured to receive video input signals or instructions to display images on game displays 240 and 242. Alternatively, such display controllers may be integrated into the game controller 202. The use and discussion of FIGS. 1 and 2 are examples to facilitate ease of description and explanation.

FIG. 2B depicts a casino gaming environment according to one example. In this example, the casino 251 includes banks 252 of EGMs 104. In this example, each bank 252 of EGMs 104 includes a corresponding gaming signage system 254 (also shown in FIG. 2A). According to this implementation, the casino 251 also includes mobile gaming devices 256, which are also configured to present wagering games in this example. The mobile gaming devices 256 may, for example, include tablet devices, cellular phones, smart phones and/or other handheld devices. In this example, the mobile gaming devices 256 are configured for communication with one or more other devices in the casino 251, including but not limited to one or more of the server computers 102, via wireless access points 258.

According to some examples, the mobile gaming devices 256 may be configured for stand-alone determination of game outcomes. However, in some alternative implementations the mobile gaming devices 256 may be configured to receive game outcomes from another device, such as the central determination gaming system server 106, one of the EGMs 104, etc.

Some mobile gaming devices 256 may be configured to accept monetary credits from a credit or debit card via a wireless interface (e.g., via a wireless payment app), via tickets, via a patron casino account, etc. However, some mobile gaming devices 256 may not be configured to accept monetary credits via a credit or debit card. Some mobile gaming devices 256 may include a ticket reader and/or a ticket printer whereas some mobile gaming devices 256 may not, depending on the particular implementation.

In some implementations the casino 251 may include one or more kiosks 260 that are configured to facilitate monetary transactions involving the mobile gaming devices 256, which may include cash out and or cash in transactions. The kiosks 260 may be configured for wired and/or wireless communication with the mobile gaming devices 256. The kiosks 260 may be configured to accept monetary credits from casino patrons 262 and/or to dispense monetary credits to casino patrons 262 via cash, a credit or debit card, via a wireless interface (e.g., via a wireless payment app), via tickets, etc. According to some examples, the kiosks 260 may be configured to accept monetary credits from a casino patron and to provide a corresponding number of monetary credits to a mobile gaming device 256 for wagering purposes, e.g., via a wireless link such as a near-field communications link. In some such examples, when a casino patron 262 is ready to cash out, the casino patron 262 may select a cash out option provided by a mobile gaming device 256 which may include a real button or a virtual button eg a button provided via a graphical user interface in some instances In some such examples the mobile gaming device 256 may send a “cash out” signal to a kiosk 260 via a wireless link in response to receiving a “cash out” indication from a casino patron The kiosk 260 may provide monetary credits to the casino patron 262 corresponding to the “cash out” signal which may be in the form of cash a credit ticket a credit transmitted to a financial account corresponding to the casino patron etc.

In some implementations, a cash-in process and/or a cash-out process may be facilitated by the TITO system server 108. For example, the TITO system server 108 may control or at least authorize ticket-in and ticket-out transactions that involve a mobile gaming device 256 and/or a kiosk 260.

Some mobile gaming devices 256 may be configured for receiving and or transmitting player loyalty information. For example, some mobile gaming devices 256 may be configured for wireless communication with the player tracking system server 110. Some mobile gaming devices 256 may be configured for receiving and/or transmitting player loyalty information via wireless communication with a patron’s player loyalty card, a patron’s smartphone, etc.

According to some implementations, a mobile gaming device 256 may be configured to provide safeguards that prevent the mobile gaming device 256 from being used by an unauthorized person. For example, some mobile gaming devices 256 may include one or more biometric sensors and may be configured to receive input via the biometric sensor(s) to verify the identity of an authorized patron. Some mobile gaming devices 256 may be configured to function only within a predetermined or configurable area, such as a casino gaming area.

FIG. 2C is a diagram that shows examples of components of a system for providing online gaming according to some aspects of the present disclosure. As with other figures presented in this disclosure, the numbers, types and arrangements of gaming devices shown in FIG. 2C are merely shown by way of example. In this example, various gaming devices, including but not limited to end user devices (EUDs) 264a,264b and 264c are capable of communication via one or more networks 417. The networks 417 may, for example, include one or more cellular telephone networks, the Internet, etc. In this example, the EUDs 264a and 264b are mobile devices: according to this example the EUD 264a is a tablet device and the EUD 264b is a smart phone. In this implementation, the EUD 264c is a laptop computer that is located within a residence 266 at the time depicted in FIG. 2C. Accordingly, in this example the hardware of EUDs is not specifically configured for online gaming although each EUD is configured with software for online gaming. For example, each EUD may be configured with a web browser. Other implementations may include other types of EUD, some of which may be specifically configured for online gaming.

In this example, a gaming data center 276 includes various devices that are configured to provide online wagering games via the networks 417. The gaming data center 276 is capable of communication with the networks 417 via the gateway 272 In this example switches 278 and routers 280 are configured to provide network connectivity for devices of the gaming data center 276 including storage devices 282a servers 284aand one or more workstations 286a The servers 284a may for example be configured to provide access to a library of games for online game play In some examples code for executing at least some of the games may initially be stored on one or more of the storage devices 282a The code may be subsequently loaded onto a server 284a after selection by a player via an EUD and communication of that selection from the EUD via the networks 417 The server 284a onto which code for the selected game has been loaded may provide the game according to selections made by a player and indicated via the player’s EUD In other examples code for executing at least some of the games may initially be stored on one or more of the servers 284a Although only one gaming data center 276 is shown in FIG. 2C some implementations may include multiple gaming data centers 276.

In this example, a financial institution data center 270 is also configured for communication via the networks 417. Here, the financial institution data center 270 includes servers 284b, storage devices 282b, and one or more workstations 286b. According to this example, the financial institution data center 270 is configured to maintain financial accounts, such as checking accounts, savings accounts, loan accounts, etc. In some implementations one or more of the authorized users 274a–274c may maintain at least one financial account with the financial institution that is serviced via the financial institution data center 270.

According to some implementations, the gaming data center 276 may be configured to provide online wagering games in which money may be won or lost. According to some such implementations, one or more of the servers 284a may be configured to monitor player credit balances, which may be expressed in game credits, in currency units, or in any other appropriate manner. In some implementations, the server(s) 284a may be configured to obtain financial credits from and/or provide financial credits to one or more financial institutions, according to a player’s “cash in” selections, wagering game results and a player’s “cash out” instructions. According to some such implementations, the server(s) 284a may be configured to electronically credit or debit the account of a player that is maintained by a financial institution, e.g., an account that is maintained via the financial institution data center 270. The server(s) 284a may, in some examples, be configured to maintain an audit record of such transactions.

In some alternative implementations, the gaming data center 276 may be configured to provide online wagering games for which credits may not be exchanged for cash or the equivalent. In some such examples, players may purchase game credits for online game play, but may not “cash out” for monetary credit after a gaming session. Moreover, although the financial institution data center 270 and the gaming data center 276 include their own servers and storage devices in this example, in some examples the financial institution data center 270 and/or the gaming data center 276 may use offsite “cloud-based” servers and or storage devices. In some alternative examples, the financial institution data center 270 and/or the gaming data center 276 may rely entirely on cloud-based servers.

One or more types of devices in the gaming data center 276 (or elsewhere) may be capable of executing middleware e.g., for data management and/or device communication. Authentication information, player tracking information, etc., including but not limited to information obtained by EUDs 264 and/or other information regarding authorized users of EUDs 264 (including but not limited to the authorized users 274a–274c), may be stored on storage devices 282 and/or servers 284. Other game-related information and/or software, such as information and/or software relating to leaderboards, players currently playing a game, game themes, game-related promotions, game competitions, etc., also may be stored on storage devices 282 and/or servers 284. In some implementations, some such game-related software may be available as “apps” and may be downloadable (e.g., from the gaming data center 276) by authorized users.

In some examples, authorized users and/or entities (such as representatives of gaming regulatory authorities) may obtain gaming-related information via the gaming data center 276. One or more other devices such (EUDs 264 or devices of the gaming data center 276) may act as intermediaries for such data feeds. Such devices may, for example, be capable of applying data filtering algorithms, executing data summary and/or analysis software, etc. In some implementations, data filtering, summary and/or analysis software may be available as “apps” and downloadable by authorized users.

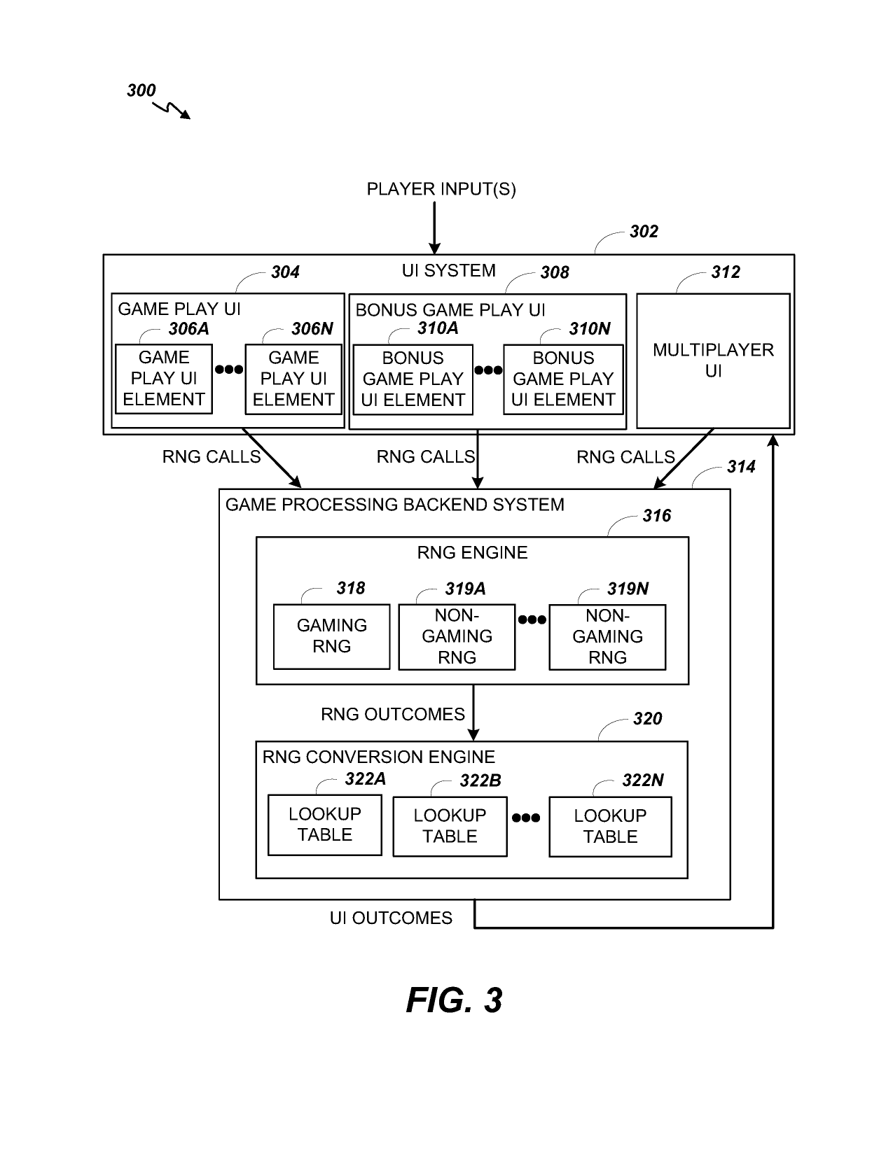

FIG. 3 illustrates, in block diagram form, an implementation of a game processing architecture 300 that implements a game processing pipeline for the play of a game in accordance with various implementations described herein. As shown in FIG. 3, the gaming processing pipeline starts with having a UI system 302 receive one or more player inputs for the game instance. Based on the player input(s), the UI system 302 generates and sends one or more RNG calls to a game processing backend system 314. Game processing backend system 314 then processes the RNG calls with RNG engine 316 to generate one or more RNG outcomes. The RNG outcomes are then sent to the RNG conversion engine 320 to generate one or more game outcomes for the UI system 302 to display to a player. The game processing architecture 300 can implement the game processing pipeline using a gaming device such as gaming devices 104A-104X and 200 shown in FIGS. 1 and 2 respectively. Alternatively, portions of the gaming processing architecture 300 can implement the game processing pipeline using a gaming device and one or more remote gaming devices, such as central determination gaming system server 106 shown in FIG. 1.

The UI system 302 includes one or more UIs that a player can interact withThe UI system 302 could include one or more game play UIs 304 one or more bonus game play UIs 308, and one or more multiplayer UIs 312, where each UI type includes one or more mechanical UIs and/or graphical UIs (GUIs). In other words, game play UI 304, bonus game play UI 308, and the multiplayer UI 312 may utilize a variety of UI elements, such as mechanical UI elements (e.g., physical “spin” button or mechanical reels) and/or GUI elements (e.g., virtual reels shown on a video display or a virtual button deck) to receive player inputs and/or present game play to a player. Using FIG. 3 as an example, the different UI elements are shown as game play UI elements 306A-306N and bonus game play UI elements 310A-310N.

The game play UI 304 represents a UI that a player typically interfaces with for a base game. During a game instance of a base game, the game play UI elements 306A-306N (e.g., GUI elements depicting one or more virtual reels) are shown and/or made available to a user. In a subsequent game instance, the UI system 302 could transition out of the base game to one or more bonus games. The bonus game play UI 308 represents a UI that utilizes bonus game play UI elements 310A-310N for a player to interact with and or view during a bonus game. In one or more implementations, at least some of the game play UI element 306A-306N are similar to the bonus game play UI elements 310A-310N. In other implementations, the game play UI element 306A-306N can differ from the bonus game play UI elements 310A-310N.

FIG. 3 also illustrates that UI system 302 could include a multiplayer UI 312 purposed for game play that differs or is separate from the typical base game. For example, multiplayer UI 312 could be set up to receive player inputs and/or presents game play information relating to a tournament mode. When a gaming device transitions from a primary game mode that presents the base game to a tournament mode, a single gaming device is linked and synchronized to other gaming devices to generate a tournament outcome. For example, multiple RNG engines 316 corresponding to each gaming device could be collectively linked to determine a tournament outcome. To enhance a player’s gaming experience, tournament mode can modify and synchronize sound, music, reel spin speed, and/or other operations of the gaming devices according to the tournament game play. After tournament game play ends operators can switch back the gaming device from tournament mode to a primary game mode to present the base game. Although FIG. 3 does not explicitly depict that multiplayer UI 312 includes UI elements, multiplayer UI 312 could also include one or more multiplayer UI elements.

Based on the player inputs, the UI system 302 could generate RNG calls to a game processing backend system 314. As an example, the UI system 302 could use one or more application programming interfaces (APIs) to generate the RNG calls. To process the RNG calls, the RNG engine 316 could utilize gaming RNG 318 and/or non-gaming RNGs 319A-319N. Gaming RNG 318 could corresponds to RNG 212 or hardware RNG 244 shown in FIG. 2A. As previously discussed with reference to FIG. 2A, gaming RNG 318 often performs specialized and non-generic operations that comply with regulatory and/or game requirements. For example, because of regulation requirements, gaming RNG 318 could correspond to RNG 212 by being a cryptographic RNG or pseudorandom number generator (PRNG) (e.g., Fortuna PRNG) that securely produces random numbers for one or more game features. To securely generate random numbers, gaming RNG 318 could collect random data from various sources of entropy, such as from an operating system (OS) and/or a hardware RNG (e.g., hardware RNG 244 shown in FIG. 2A) Alternatively, non-gaming RNGs 319A-319N may not be cryptographically secure and/or be computationally less expensive. Non-gaming RNGs 319A-319N can, thus, be used to generate outcomes for non-gaming purposes. As an example, non-gaming RNGs 319A-319N can generate random numbers for generating random messages that appear on the gaming device.

The RNG conversion engine 320 processes each RNG outcome from RNG engine 316 and converts the RNG outcome to a UI outcome that is feedback to the UI system 302. With reference to FIG. 2A RNG conversion engine 320 corresponds to RNG conversion engine 210 used for game play. As previously described, RNG conversion engine 320 translates the RNG outcome from the RNG 212 to a game outcome presented to a player. RNG conversion engine 320 utilizes one or more lookup tables 322A-322N to regulate a prize payout amount for each RNG outcome and how often the gaming device pays out the derived prize payout amounts. In one example, the RNG conversion engine 320 could utilize one lookup table to map the RNG outcome to a game outcome displayed to a player and a second lookup table as a pay table for determining the prize payout amount for each game outcome. In this example, the mapping between the RNG outcome and the game outcome controls the frequency in hitting certain prize payout amounts. Different lookup tables could be utilized depending on the different game modes, for example, a base game versus a bonus game.

After generating the UI outcome, the game processing backend system 314 sends the UI outcome to the UI system 302. Examples of UI outcomes are symbols to display on a video reel or reel stops for a mechanical reel. In one example, if the UI outcome is for a base game, the UI system 302 updates one or more game play UI elements 306A-306N, such as symbols, for the game play UI 304. In another example, if the UI outcome is for a bonus game, the UI system could update one or more bonus game play UI elements 310A-310N (e.g., symbols) for the bonus game play UI 308. In response to updating the appropriate UI, the player may subsequently provide additional player inputs to initiate a subsequent game instance that progresses through the game processing pipeline.

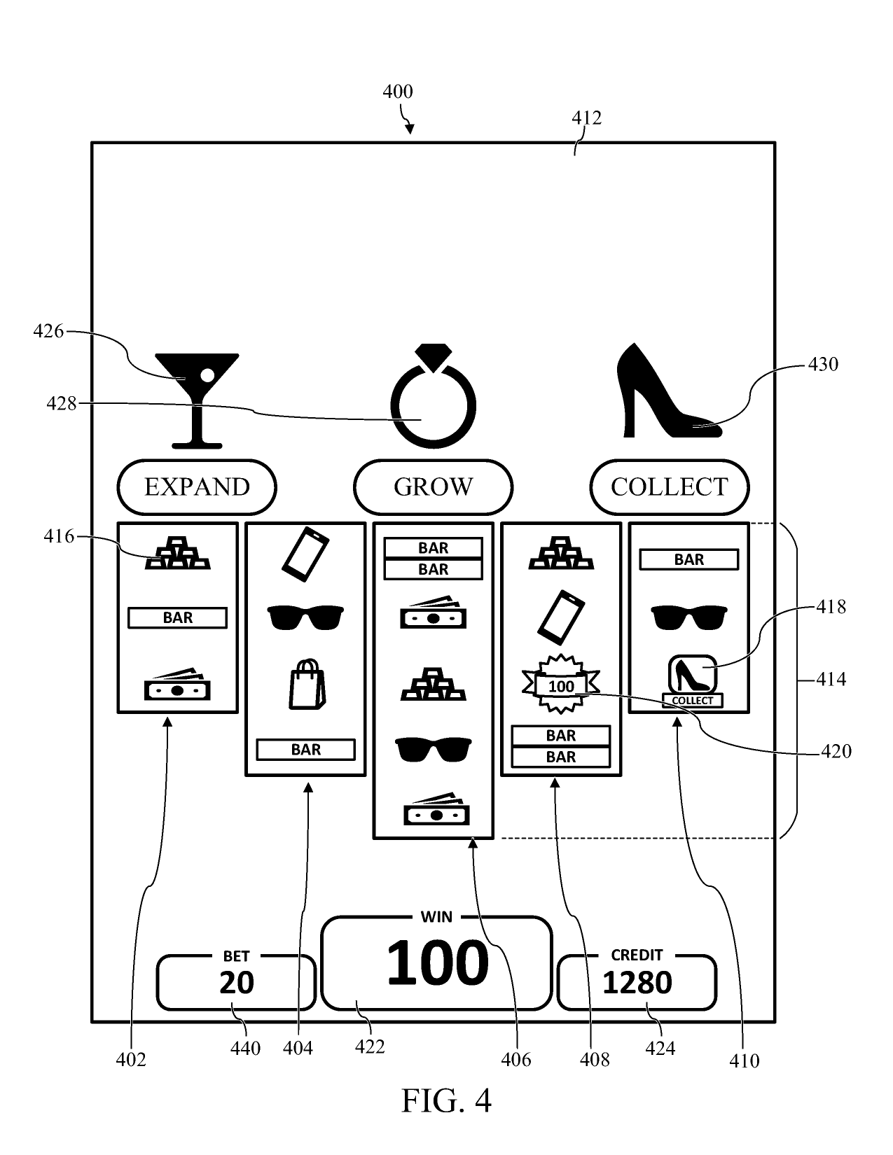

FIG. 4 is a user interface or screenshot of an example base reel game 400 played on a gaming device (e.g., gaming devices 104A-104X in FIG. 1, and/or gaming device 200 and/or mobile gaming device 256 in FIG. 2). Specifically, FIG. 4 shows a base reel game 400, in which a base reel game outcome is displayed that corresponds to (e.g., presents, represents, and/or is determined from) an output of the gaming device. The output may be a primary game outcome determined in response to a wager received from a player. In example implementations, described in further detail herein, the primary game outcome is a Class II (e.g., bingo) game outcome. Although the example implementations are described herein primarily with reference to presenting outcomes of a Class II (e.g., bingo) game using the base reel game 400,in other implementations the base reel game outcome may be and/or corresponds to an outcome of a Class III or Las-Vegas style game. In various implementations, the base reel game 400 may be implemented to present an outcome of any suitable game of chance. Specific details of the type of primary game outcomes presented using the base reel game 400 are not central to an understanding of the present disclosure. However, additional detail related to at least one implementation (e.g., an implementation employing the base reel game 400 to present a primary bingo-based or Class II game outcome) may be obtained with reference to U.S. Published Patent Application No. 20120270638, filed April 20, 2011, and entitled GAMING MACHINE WITH FREE PLAY BONUS MODE PRESENTING ONLY WINNING OUTCOMES, the disclosure of which is hereby incorporated by reference herein in its entirety.

The base reel game 400 may be initiated on a gaming device 104A-104X and 200. Specifically, a player may fund the base reel game 400 via bill validator 234 and/or ticket reader 224. Once funded, the base reel game 400, which includes a first plurality of reels 402, 404, 406, 408,and/or 410,each including a plurality of game symbols 414, may appear on a primary display 412. The first plurality of reels 402-410 may be physical reels and/or virtual reels. As used herein, physical reels are mechanical in nature and may be physically rotated during gameplay. In contrast, virtual reels are rendered or visually created by game controller 202 on a display, such as primary game display 240, and are merely animated to give the appearance of being spun. The first plurality of reels 402-410 of the example base reel game 400 include five reels. In other examples, the number of reels may range from one reel to five or more reels in number. The base reel game 400 may be played on display 412. However, in other implementations, the base reel game 400 may be played on several displays including display 412 and an additional or auxiliary displays.

The base reel game 400 may be played on several displays, such as the primary display 412 and a secondary display. However, in other implementations, the base reel game 400 may be played on a single display and/or on greater than two displays. In the example shown in FIG. 4, the base reel game 400 includes a first reel matrix on the primary display 412. The first reel matrix includes a plurality of symbol positions arranged in a plurality of rows and a plurality of columns. The first reel matrix may also therefore be referred to as a “matrix of symbol positions.” While, in the example shown in FIG. 4, the first reel matrix is displayed on the primary display 412, the first reel matrix may appear in other locations on an EGM 104A-104X and/or on other displays, such as, for example, the secondary display, a display of button deck 120, and the like.

In the example embodiment shown in FIG. 4, the plurality of reels 402-410 form five distinct reels and/or five columns. Each reel 402-410 also includes a predetermined number of rows as well. In the example, the number of predetermined number of rows increases as the reel position moves toward the center reel 406. More specifically, reels 402, 410 have three (3) rows, reels 404, 408 have four (4) rows, and (central) reel 406 has five (5) rows. As a result, in the example embodiment the plurality of reels 402-410 for base reel game 400 include a 3x4x5x4x3 arrangement, as depicted on display 412, and include nineteen (19) game symbol positions. In other implementations, the plurality of reels 402-410 may be any size/uniformity (e.g., 2×2, 3×3, 4×4, 10×10, etc.), and a number of game symbol positions for the plurality of reels 402-410 may vary depending upon a number of rows and columns of the plurality of reels 402-410.In some implementations, the plurality of reels 402-410 may be replaced by one or more mechanical reels, and the implementations described herein work equally well with mechanical reels as with the virtual plurality of reels 402-410, as shown in FIG. 4. Each row of the plurality of reels 402-410 may be designated by a row number (e.g., “1,” “2,” “3,” etc.). Each column of the plurality of reels 402-410 may be designated by a column letter (e.g., “A,” “B,” “C,” “D,” “E,” etc.). Each game symbol position of the plurality of reels 402-410 may therefore be designated by a symbol position identifier comprising a row number (e.g., “1,” “2,” “3,” etc.) and a column letter (e.g., “A,” “B,” “C,” “D,” “E,” etc.). For example, the upper-left-most game symbol position, occurring at the intersection of row 1 and column A, may be designated by the game symbol position identifier “1A.” In another example, the bottom most game symbol position for reel 406, occurring at the intersection of row 5 and column C, may be designated by the game symbol position identifier “5C.”

As described herein, during play of the base reel game 400, game symbols 414 may be selected (e.g., such as from the plurality of reels 402-410) and displayed in the game symbol positions of each column and row of the plurality of reels 402-410. Although not central to an understanding of the present disclosure, each of the plurality of reels 402-410 may include a plurality of game symbols 414 arranged in a vertical column. A number of game symbols 414 of each reel 402-410, corresponding to the number of rows of the plurality of reels 402-410, is displayed in a column of game symbol positions within the plurality of reels 402-410 during play of the base reel game 400. To display symbols from a reel within the plurality of reels 402-410, processor 204 may simulate rotation or spinning of one or more of the plurality of reels 402-410 within a respective column of the plurality of reels 402-410. Here again, however mechanical reels having physical reel strips may be used as well. When a respective reel is simulated to halt or stop within an associated column, one or more game symbols 414 may be displayed from the reel 402-410 in the game symbol positions of the column. The game symbols 414 displayed after spinning and stopping each reel strip in a respective column of the plurality of reels 402-410 may be referred to herein as a “reel outcome” or a “base reel game outcome” or a “base game outcome.” More broadly, an “outcome” of a reel game, such as a base reel game (e.g., the base reel game 400) or a bonus reel game (e.g., a bonus reel game 500 described in more detail herein), refers to the game symbols 414 displayed in the plurality of reels 402-410 after reel strips are spun and stopped. Thus, a rotation and stopping of a plurality of reel strips (also referred to herein as a "spin and stop sequence") may be simulated by processor 204 within the columns of the plurality of reels 402-410 to cause a reel outcome, including a plurality of game symbols 414, to be displayed from the plurality of reel strips within the columns of the plurality of reels 402-410.

Briefly turning to the example shown in FIG. 4, and as discussed herein, the plurality of game symbols 414 included and/or displayed within the plurality of reels 402-410 include and/or are formed from various symbol types. For example, graphic game symbols 416 of the plurality of game symbols 414 include predetermined graphics, symbols, and/or art works that can be based on a theme, story, and/or visual representation of base reel game 400.Additionally, or alternatively, graphic game symbols 416 include suitable graphics, symbols, and/or artworks commonly associated with gaming device (e.g., “BAR,” “SPIN,” “WILD,” etc.). In Class II games, and as discussed herein, graphic game symbols help, at least in part, in creating façades for base reel game 400 and/or bonus reel game 500. The plurality of game symbols 414 also include metamorphic enhancement feature symbols 418.Metamorphic enhancement feature symbols 418 are associated with a particular meta morphic enhancement feature (e.g., expand feature, grow feature, collect feature) for bonus reel game 500, as discussed herein. Furthermore, the plurality of game symbols 414 include cash-on-reel (COR) symbol 420 displayed within the plurality of reels 402-410.COR symbols 420 include, display, depict, and/or are associated with a predetermined credit value (e.g., COR credit value) that can provide additional award credits to the player during base reel game 400 and/or bonus reel game 500, as discussed herein.

In operation, the reel outcome presented during play of the base reel game 400 (e.g., base reel game outcome) corresponds to, presents, represents, and/or is determined from a primary game outcome. For example, the reel outcome (base reel game outcome) may correspond to a primary or underlying Class II game, or the reel outcome may be determined randomly (e.g., in Class III games).

In the example implementation, the reel outcome of the base reel game 400 corresponds to, presents, represents, and/or is determined from a Class II (e.g., bingo) game outcome. In some implementations, a player and/or a gaming device (e.g., gaming devices 104A-104X and 200) may be provided with a bingo card, such as by a bingo gaming system server (e.g., the server 106). For example, a player may be provided a new bingo card each time a “Spin” or “Play” button is pressed by the player (e.g., via user interface) provided the player has made a wager. In some examples, more than one bingo card may be generated in response to wager. A bingo number listing (also referred to as a “ball call”) may be randomly generated, such as by bingo gaming system server 106. The bingo card may be compared to the current bingo number listing, and numbered cells on the bingo card that match numbers in the bingo number listing may be marked or “daubed” on the bingo card. Finally, the marked or daubed bingo card may be evaluated against a paytable of winning bingo patterns.

The bingo number listing may be continually generated until a maximum amount of numbers are listed (e.g., seventy-five numbers listed) or until a game-ending pattern is awarded to a player participating in the bingo game. A typical game-ending pattern may be a bingo card blackout pattern, in which each of the numbers of a bingo card match a number displayed in the bingo number listing. Other game-ending patterns are also possible. When the game-ending pattern is awarded, the bingo number listing is reset, and the process repeats. In some examples, a single play of the bingo game includes a wager, a bingo card, a bingo number listing, a matching of the numbers called with those on a bingo card, a determination of a bingo game outcome, and a presentation of an associated award, if any. As described herein, the presentation of the associated award is implemented using the base reel game 400 and, if conditions are satisfied by the award, a bonus reel game 500 is triggered and played, as described in more detail below.

To determine a bingo game outcome, the bingo card may be daubed by the game controller 202 (e.g., via the processor 204) based upon a list of numbers included in the ball call. Once the bingo card is daubed, the game controller 202 may compare the numbers daubed on the bingo card to every winning pattern in a database of winning patterns to determine one or more winning outcomes of the bingo game outcome. As those of skill will appreciate the number of winning patterns may be determined based upon the ball call. The daubed bingo card may also be displayed (e.g., on the primary display 412 or a secondary display), such as, for example, by highlighting each daubed number, and the ball call may be displayed as well. Moreover, a table or database of winning patterns may be stored in a computer memory of any of EGMs 104A-104X or 200, such as memory 208, which may be a tangible, non-transitory, computer-readable memory. If the daubed bingo card does not include a pattern that matches a pattern in the database of winning patterns, then a losing bingo outcome is determined, and no award may be provided or presented to the player. If the bingo card does include a pattern that matches a pattern in the database of winning patterns, then a winning bingo outcome is determined, and an award may be presented to the player, as described herein.

The bingo game outcome may, in some instances, include a plurality of winning patterns. Different winning patterns may be associated with different awards. The award for a winning bingo game outcome may be based on an amount wagered, an associated bingo game paytable, an associated set of rules for the bingo game, a probability (and/or likelihood) of achieving a particular bingo pattern/combination, an amount of bingo numbers needed to achieve the particular bingo pattern/combination, and/or other considerations. In some examples, the player may be awarded for multiple patterns (e.g., all winning patterns) that are matched when the daubed bingo card is evaluated against the database of winning patterns. In some examples, the player may be awarded for only the highest priority pattern (e.g., the highest paying winning pattern) that is matched. In some examples, during play of a Class II game, a player is provided or selects a single bingo card for multiple plays of the bingo game, with a new bingo number listing generated for each play of the bingo game. Other methods of play of a Class II bingo game are also possible and are within the scope of this disclosure.

The bingo game outcome may be presented to the player via a spinning reel game simulation. That is for each play of the bingo game, the bingo game outcome is presented as a reel outcome (e.g., base reel game outcome) or a sequence of reel outcomes in a reel game (e.g., base reel game 400, bonus reel game 500). In the example shown in FIG. 4, a bingo game outcome (not shown) is presented by the base reel game 400 simulation as a spin and stop sequence or multiple spin and stop sequences of the plurality of reels 402-410. The spin and stop sequence(s) and associated outcome(s) of a reel game (e.g., the base reel game 400)that present the bingo game (or another Class II game) outcome may also be referred to as a “façade” or a “script.” A table or database may be stored in a computer memory of any of EGMs 104A-104X or 200 and/or the server computers 102, such as memory 208, that associates bingo game outcomes with façades for presenting the bingo game outcomes. The game controller 202 (e.g., via the processor 204) may thereby query the table or database to identify façades, which each contain one or more spin and stop sequence(s) and associated outcome(s) of the reel game, to present a bingo game outcome. The processor 204 may randomly select from multiple façades identified for a given bingo game outcome. For example, for a given bingo game outcome, a number of façades, e.g., five, ten, fifteen, or any other number of different ways (façades), may exist and be stored in the table or database to present the bingo game outcome. A façade may be randomly selected from multiple identified façades for a given bingo game outcome, for example, based upon a random number provided by the RNG 212. When a façade is selected by the processor 204 to present a bingo game outcome the processor 204 may control the reel game to present the one or more spin and stop sequence(s) and associated outcome(s) contained in the façade.

In the example implementation, for a given bingo game outcome, the processor 204 selects a façade for presenting the bingo game outcome. Based on the selected façade, the processor 204 controls the base reel game 400 to cause display of one or more spin and stop sequences of the plurality of reels 402-410 and the associated outcome(s) of the base reel game 400. One or more combinations of game symbols 414 and/or one or more special symbol types (e.g., metamorphic enhancement feature symbols 418, cash-on-reel (COR) symbols 420) in the base reel game outcome of the base reel game 400 may be associated with an award value that is equal to an award value of the bingo game outcome. Similarly, a losing bingo game outcome may be displayed as a losing base reel game outcome of the base game 400 (e.g., no winning game symbol 414 combinations or winning special symbols 418, 420 are displayed).

To illustrate, the base reel game 400 may be initiated in response to a bingo game outcome that includes a winning pattern having an award value of 100 credits. The processor 204 queries the table or database to identify façades for presenting the winning pattern and/or the award value as one or more spin and stop sequences of the plurality of reels 402-410 and the associated base reel game outcome(s) of the base reel game 400. The processor 204 then selects one of the identified façades for the bingo game outcome and initiates a play of the base reel game 400. During the base reel game 400 based on the selected façade, the processor 204 causes the first plurality of reels 402-410 to spin and stop to display a combination of game symbols 414 that include a winning symbol combination corresponding to a 100 credit award value (shown in FIG. 4) that matches the award value of the winning bingo game outcome. The award value is then displayed in a win meter 422 and subsequently added to a credit meter 424. The win meter 422 displays an immediately awarded value for an outcome the base reel game 400, and the credit meter 424 displays a credit balance (calculated as a sum total of credits input and awards accrued minus wagers placed) accrued until a player cashes out. Each of the win meter 422 and the credit meter 424 are shown displayed on display 412, however, each may appear in other locations on an EGM 104A-104X or 200 and/or on other displays, such as, for example, a secondary display, a display of button deck 120, and the like.

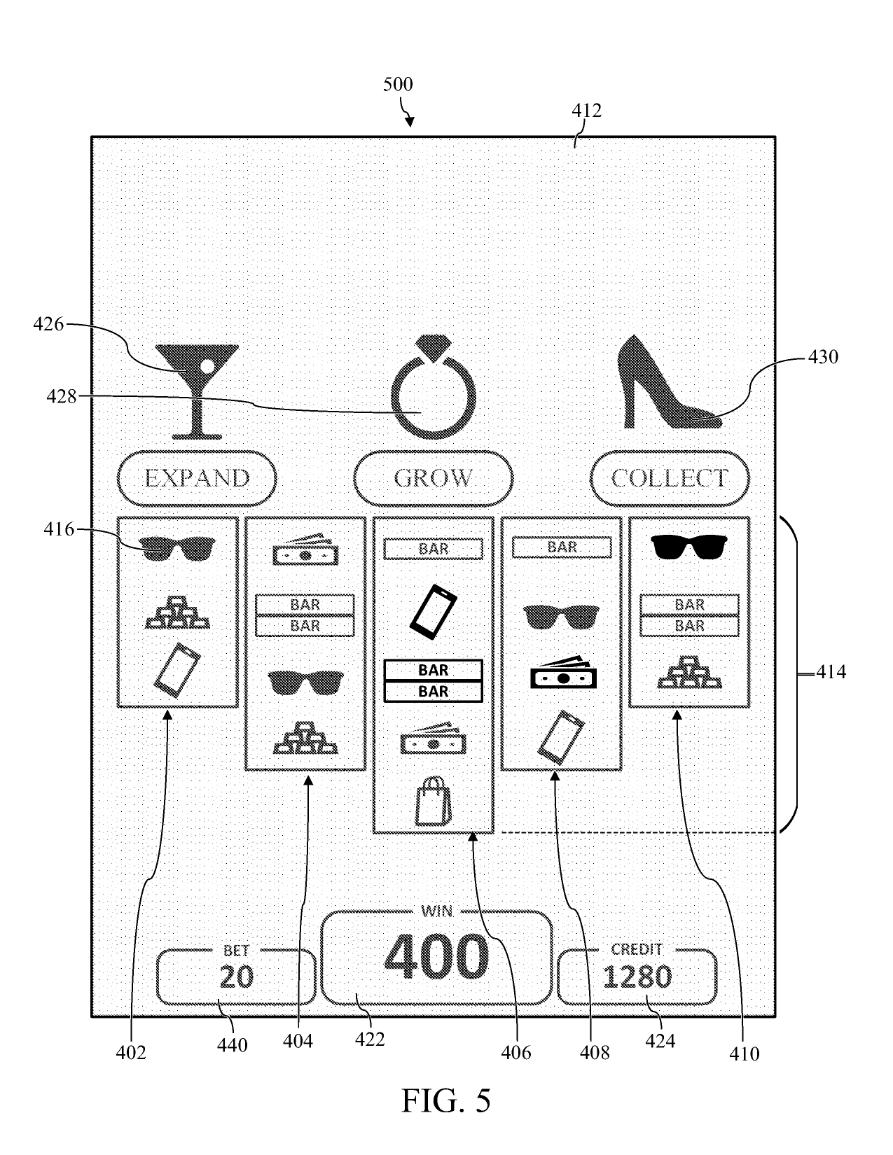

Referring to FIG. 5, a user interface or screenshot of an example bonus reel game 500 initiated after play of the base reel game 400 is displayed. The bonus reel game 500 is triggered by the primary game outcome (e.g., base reel game outcome) satisfying a bonus reel game condition, described in further detail below. In the example implementation, the bonus reel game 500 may include a number of free spins of the first plurality of reels 402-410. Thus, the bonus reel game 500 may also be referred to herein as a bonus reel game 500 or a free spin bonus reel game 500. In various implementations, the bonus reel game 500 may be played as a primary or base game and/or as a bonus game that is initiated after play of a primary game (e.g., the base reel game 400). In other words, the functionality described herein with respect to free spin bonus reel game 500 may be implemented in any base reel game as well as in any bonus game. Moreover, the bonus reel game 500 is not limited to a reel game, and may be implemented as another suitable wagering game. However, in the illustrated implementation, the bonus reel game 500 is a bonus reel game that includes one or more free spins, and is initiated after play of the base reel game 400.

The bonus reel game 500 is triggered in response to a game controller (e.g., the game controller 202) determining that a bonus reel game condition is satisfied by the primary or base reel game outcome. The primary game outcome may include a number of (e.g., multiple) awards or winning game outcomes (e.g., winning combinations, patterns, etc.). For example, the game controller 202 may determine that a bingo game outcome includes a number of (e.g., multiple) winning bingo patterns. The bonus reel game condition may be satisfied by a predefined or preselected number of awards or winning game outcomes of the primary or base reel game outcome. For example, in Class II bingo game implementations, the bonus reel game condition may be a predefined or preselected number of winning bingo patterns included in the bingo game outcome. The game controller 202 may identify and translate the number of winning patterns occurring on the bingo card to a number of free spins in the free spin bonus reel game 500.For example, if a number “n” winning patterns are identified on the bingo card, the game controller 202 may award a number “n” free spins during the free spin bonus reel game 500. Likewise, the game controller 202 may not trigger free spin bonus reel game 500 until the number of winning patterns exceeds a predefined or preselected number of winning patterns (e.g., two or more winning patterns). To this end, the game controller 202 may in some implementations, count, or determine a number of, winning patterns and/or free spins awarded.

In various implementations, a bonus reel game condition may include any suitable trigger condition, such as, for example, generation by RNG 212 of an RNG outcome (e.g., a random number within a range of random numbers) and performing a lookup operation to map the random number to a decision as to whether the bonus reel game condition is satisfied. The RNG outcome for mapping to the decision as to whether the bonus reel game condition is satisfied may be generated after each play of a base game (e.g., the base reel game 400),or may itself be randomly generated based on an additionally generated RNG outcome. Additionally, and/or alternatively, in a Class III implementation, the bonus reel game condition may be satisfied when a preselected or predefined symbol combination and/or a preselected or predefined symbol type (e.g., special game symbol) is displayed on the plurality of reels 402-410 in an outcome the base reel game 400. For example, a game symbol 414 combination and/or symbol type associated with a game award that is greater than or equal to a predetermined award value may satisfy the bonus reel game condition. In some implementations, a preselected or predefined game symbol 414 combination and/or symbol type being displayed in an outcome of a base reel game may generate an RNG outcome that is mapped to a decision as to whether the bonus reel game condition is satisfied.

In some implementations, and as described in additional detail herein, the bonus reel game condition may be satisfied when a number of winning patterns in a primary Class II game (e.g., a bingo game) exceeds a predefined or preselected number of winning patterns. In other implementations, the bonus reel game condition may be satisfied when an award associated with a bingo winning pattern is greater than or equal to a predetermined award value and/or when the predetermined award value is capable of being partitioned into or distributed across a predefined or preselected number of free spins. It will, however, be appreciated that these bonus reel game conditions are described by way of example only and that other bonus reel game conditions may be implemented as well.

When the free spin bonus reel game 500 is triggered, the game controller 202 may award at least one or more free spins of the plurality of reels 402-410 displayed in the base reel game 400. The number of free spins awarded may be based upon any suitable criterion or group of criteria, such as, for example, the value of the random number generated by RNG 212, the game symbol 414 combination occurring on reels 402-410 in a base reel game outcome of the base reel game 400, and the like.

In another Class II implementation, the number of free spins awarded may correspond to a number of segments or partitions of a subdivided bingo game award. For example, when the bonus reel game condition is satisfied by a bingo game award of sufficient value (as described above), the bingo game award may be subdivided into a plurality of smaller awards, each of which may be associated with a free spin. As an example, a bingo game award of 1000 credits may be subdivided into eight smaller awards e.g., of 125 credits each. In other examples, the eight awards may be of different, i.e., unequal, amounts. Each of the eight smaller awards may be associated with an individual free spin, and each of these individual free spins may provide or award one of the eight smaller awards.

In at least one Class III implementation, the number of free spins awarded may correspond to a number of partitions of a subdivided game award in the Class III base game. For example, when the bonus reel game condition is satisfied by a primary or base reel game award of sufficient value (as described above), the game award may be subdivided into a plurality of smaller awards, each of which may be associated with a free spin and provided in conjunction with one of the smaller sub-awards.

In another Class II or Class III implementation, each free spin may correspond to a particular game outcome, such as any winning and/or non-winning game outcome. For example, winning and/or non-winning game outcomes may, in some implementations, result in free spins. However, and in at least some implementations, only winning game outcomes may result in free spins. Moreover, as described above, in some implementations, the game controller 202 may simply (randomly) award a number of free spins.

Thus, the free spin bonus reel game 500 may be implemented in Class II and Class III implementations, and a bonus reel game condition and/or a number of free spins awarded during the free spin bonus reel game 500 may be variously determined. In addition, the methods for determining the bonus reel game condition and/or a number of free spins described above are merely illustrative, and it will be appreciated that other approaches are contemplated and within the scope of the present disclosure.

The free spin bonus reel game 500 may be provided with a displayed indication that the bonus reel game 500 is distinct from the base reel game 400. For example, the free spin bonus reel game 500 may be provided in conjunction with a change to an overlaid translucent or transparent colored graphic effect (shown in FIG. 5 ) around the plurality of reels 402-410 and display 412. For instance, in one implementation, display 412 may change to include a red color overlay or a “red screen.” The red screen may be displayed for the duration of the free spin bonus reel game 500 to let a player know that each free spin will be accompanied by an award (e.g., corresponding to an award of each of the multiple winning patterns of the bingo game outcome). In other implementations, words, symbols, letters, metamorphics, and/or other visual effects may be displayed on or adjacent the plurality of reels 402-410, display 412, and/or auxiliary displays, in addition to and/or alternative to the displayed red screen.

An outcome of each free spin of the bonus reel game 500 may, in some implementations, correspond to an award value associated with the primary or base reel game outcome. For example, the outcome of each free spin of the bonus reel game 500 may correspond to a winning bingo pattern. The game controller 202 may, as a result, determine or identify (e.g., by querying a table or database stored in a memory as described below) an award value associated with an outcome of each free spin based upon the corresponding winning game outcome or award of the primary game outcome. For example, if a winning bingo pattern associated with a first free spin or bonus reel game outcome corresponds to an award of 100 credits (e.g., determined based upon a bingo paytable), the game controller 202 may re-spin the reels during the first free spin, and control display of the reels in a first free spin or bonus reel game outcome to provide an award in association with the first free spin or bonus reel game outcome of 100 credits. Thus, each free spin of the reels may include display of a winning free spin or bonus reel game outcome, and an award value of each bonus reel game outcome may correspond to an award value associated with the winning bingo pattern (or more broadly, a winning game outcome) mapped or corresponding to the free spin.

In the example implementation, the bonus reel game 500 is simulated in conjunction with the base reel game 400 as a façade for presenting a bingo game outcome that satisfies the bonus reel game condition. As described above with reference to the base reel game 400, a table or database may be stored in a computer memory of any of EGMs 104A-104X or 200 and/or the server computers 102, such as memory 208, that associates bingo game outcomes with façades for presenting the bingo game outcomes, and the game controller 202 (e.g., via the processor 204) may query the table or database to identify façades to present a bingo game outcome. For certain bingo game outcomes, for example, those that include a predefined or preselected number of winning patterns and/or one or more winning patterns associated with a certain award value, one or more façades may exist that present the bingo game outcome as outcomes of the base reel game 400 and outcome(s) of one or more free spins of the bonus reel game 500. These bingo game outcomes satisfy the bonus reel game condition as they are able to be presented by one or more façades that contain outcome(s) of the base reel game 400 and outcome(s) of one or more free spins of the bonus reel game 500. The processor 204 may select a façade for presenting the bingo game outcome that satisfies the bonus reel game condition and based on the selected façade, the processor 204 causes display of one or more spin and stop sequences of the plurality of reels 402-410 and the associated outcome(s) of the base reel game 400 and one or more free spins of the plurality of reels 402-410 and the associated outcome(s) of the bonus reel game 500. One or more combinations of game symbols 414 and or one or more special symbol types in the outcomes of the base reel game 400 and the bonus reel game 500 may be associated with an award value that is equal to an award value of the bingo game outcome.

To illustrate, the bingo game outcome may include multiple winning patterns associated with a 10, credit a 100, credit and a 1000 credit pattern win. The processor 204 queries the table or database to identify façades for presenting the winning patterns and/or the award value(s) as one or more spin and stop sequences and the associated outcome(s) of the base reel game 400 and one or more free spins and the associated outcome(s) of the bonus reel game 500.For example, one or more façades may exist that contain a spin and stop sequence and associated outcome of the base reel game 400 for presenting the 10 credit pattern win and one or more free spins and the associated outcome(s) of the bonus reel game 500 for presenting the 100 credit pattern win and the 1000 credit pattern win and the processor 204 identifies these façades by querying the table or database. The processor 204 then selects (e.g., randomly selects based upon a random number provided by the RNG 212) one of the identified façades for the bingo game outcome and, in response and based on the selected façade, the processor 204 causes display of the spin and stop sequence and associated outcome of the base reel game 400 for presenting the 10 credit pattern win and one or more free spins and the associated outcome(s) of the bonus reel game 500 for presenting the 100 credit pattern win and the 1000 credit pattern win.

A total award value accrued during the base reel game 400 and the free spins of the bonus reel game 500 may be displayed, such as, for example, in the win meter 422. The award value displayed in the win meter 422 during the free spin bonus reel game 500 may increase incrementally (e.g., as determined by the selected façade) after each free spin or bonus reel game outcome to build player excitement, such as, for example, where the player knows that a number of free spins have been awarded based upon the appearance of the free spin bonus reel game 500, but where the player does not know specifically how many free spins have been awarded. In some implementations, the processor 204 may control (e.g., as determined by the selected façade) the free spin sequence during the free spin bonus reel game 500 such that an equal or greater award value is presented after each successive free spin to facilitate further increasing player excitement. Once the number of free spins awarded during the bonus reel game 500 has been reached, the total award value may be added to the credit meter 424 and the free spin bonus reel game 500 is completed. Upon completion of the bonus reel game 500, the displayed indication (e.g., the red screen) may be removed to visually inform the player that the bonus reel game 500 has been completed.

Additional detail related to the displayed indication (e.g., the red screen) during bonus reel game 500 may be obtained with reference to U.S. Patent Application No. 18/303,002, filed April 19, 2023, and entitled ELECTRONIC GAMING SYSTEMS AND METHODS FOR PRESENTING A BONUS GAME WITH ENHANCEMENT FEATURES, the disclosure of which is hereby incorporated by reference herein in its entirety.

The features of the free spin bonus reel game 500 (e.g., the displayed red screen and/or the progressive display of increasing award values during successive spins of the bonus reel game 500) may only facilitate increasing player excitement to a limited extent. Still referring to FIG. 5, during the bonus reel game 500, each free spin includes a spin and stop sequence of the first plurality of reels 402-410. Even though the player may anticipate a winning outcome for each free spin, the player may not perceive that the bonus reel game 500 provides any additional opportunity for a winning outcome beyond the opportunities provided during the base reel game 400.

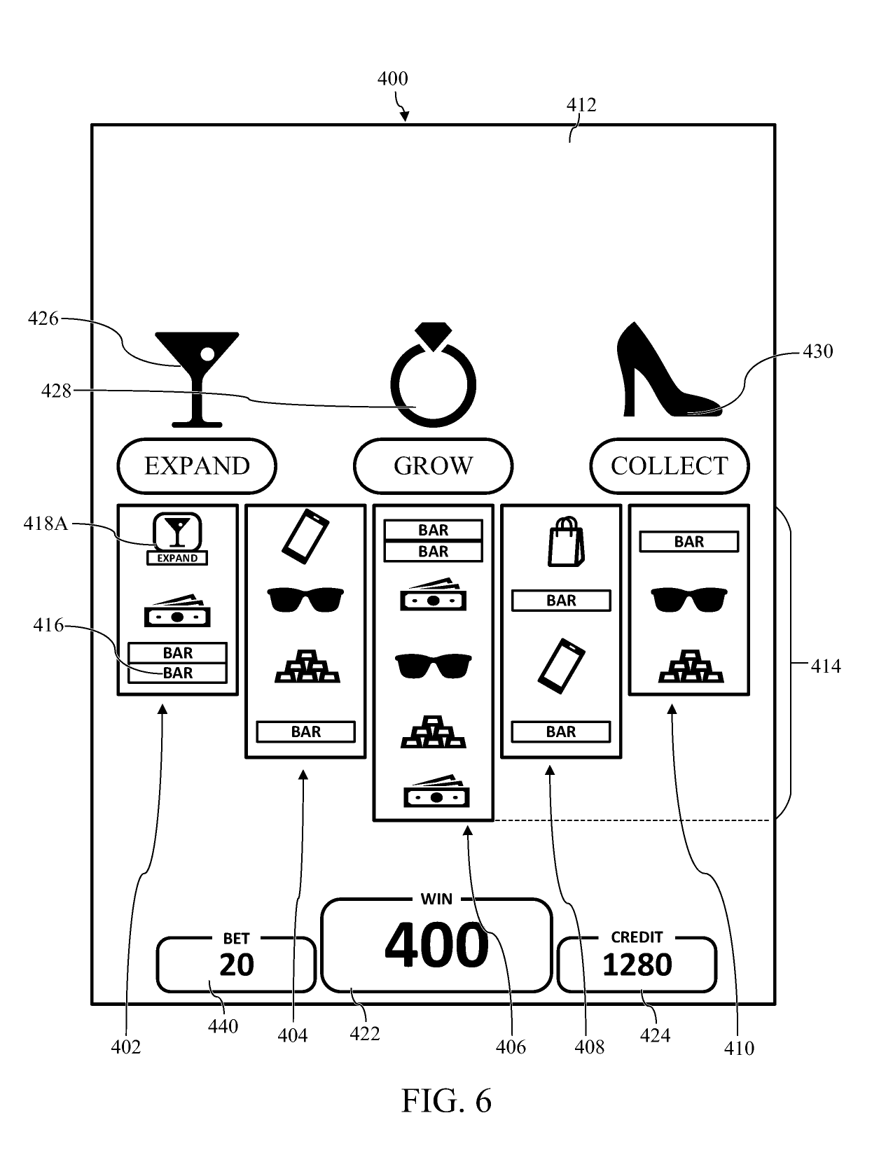

Accordingly, with additional reference to FIGS. 6-20 generally, the free spin bonus reel game 500 may include metamorphic enhancement features that increase the flexibility in presenting winning outcomes during the number of free spins that correspond to winning outcomes or awards of the base reel game outcome or primary outcome (e.g., a bingo game outcome). The metamorphic enhancement features of the free spin bonus reel game 500 facilitate increasing player excitement during the bonus reel game 500 as each metamorphic enhancement feature is perceived as providing an additional opportunity for a winning free spin or bonus reel game outcome (e.g., by expanding the plurality of reels 402-410 and/or collecting cash-on-reel credit values), and/or an increased monetary value awarded for a winning free spin or bonus reel game outcome (e.g., applying multipliers to credit values associated with cash-on-reel (COR) symbols).

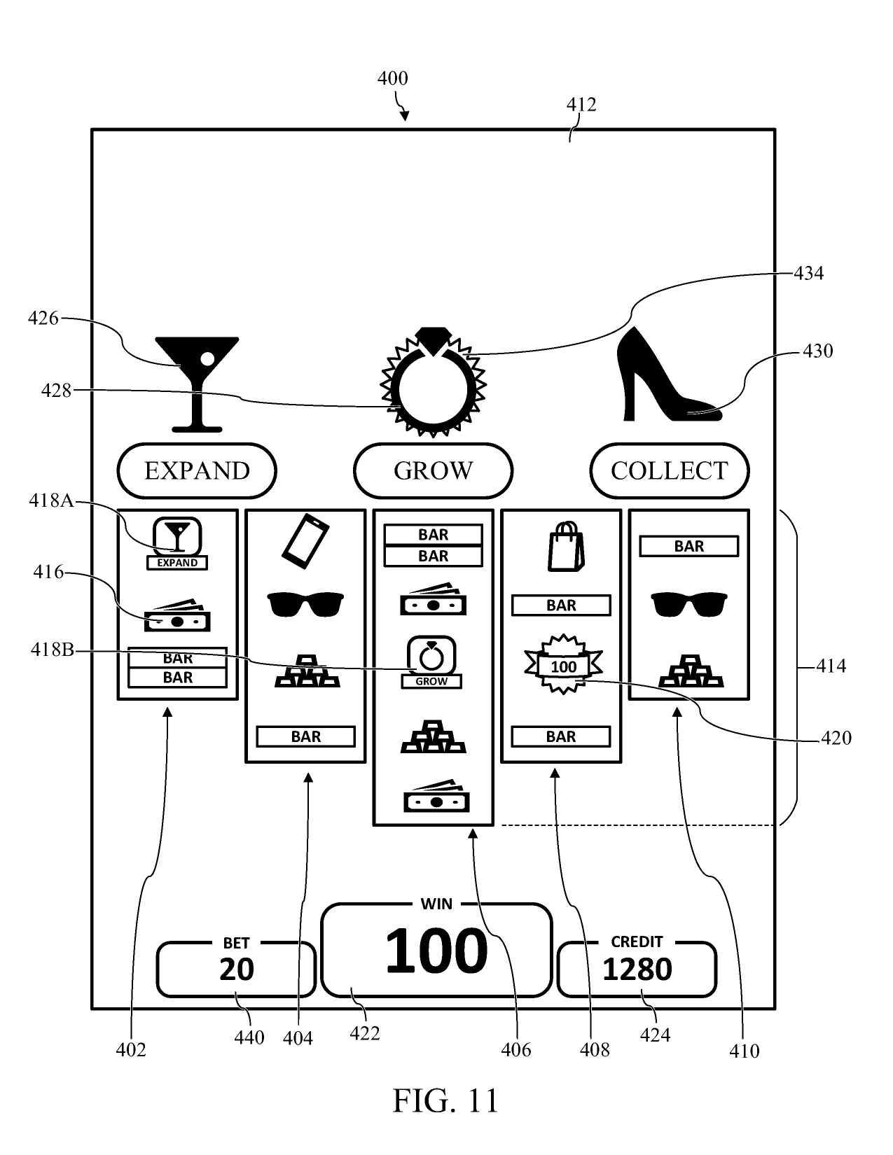

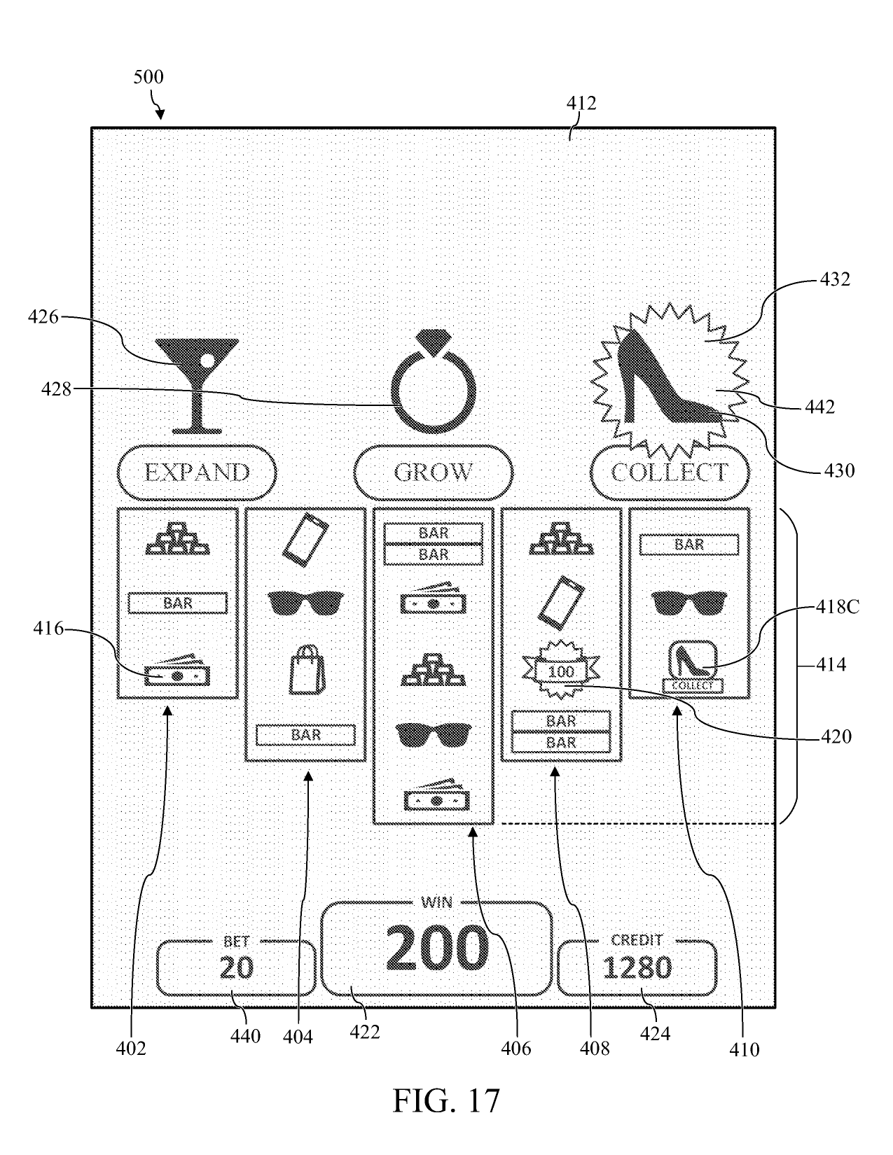

In the example implementation, the metamorphic enhancement features of the bonus reel game 500 include an expanded feature described in further detail below with reference to FIGS. 6-10, a grow feature described in further detail below with reference to FIGS. 11-16, and a collect feature described in further detail below with reference to FIGS. 17-20). The bonus reel game 500 may include one or any combination of two or more of the metamorphic enhancement features. Although the metamorphic enhancement features are described with respect to an expand feature, a grow feature, and an collect feature, the bonus reel game 500 may include any suitable metamorphic enhancement features that provide an additional or alternative award option during the bonus reel game 500 beyond display of winning game symbol 414 combinations of the first plurality of reels 402-410 and/or a nominal credit value awarded for each winning game symbol 414 combination that are available during the base reel game 400. As a result, although a variety of award options based on the enhancement features of the bonus reel game 500 are described herein, it will be appreciated that any suitable award option and/or metamorphic enhancement feature may be presented and/or offered in conjunction with the free spin bonus reel game 500 within the scope of the present disclosure.

As described above, the bonus reel game 500 is triggered in response to the game controller 202 (e.g., via the processor 204) determining that the primary game outcome satisfies a bonus reel game condition (e.g., a preselected or predetermined number of winning patterns included in and/or a total award value of a bingo game outcome). The bonus reel game 500 having one or more metamorphic enhancement features is triggered in response to the game controller 202 further determining that the primary game outcome also satisfies an enhancement condition.

In various Class III implementations, an enhancement condition may include any suitable trigger condition, such as, for example, generation by RNG 212 of an RNG outcome and performing a lookup operation to map the random number to a decision as to whether the enhancement condition is satisfied. The RNG outcome for mapping to the decision as to whether the enhancement condition is satisfied may be generated after each play of a base game (e.g., the base reel game 400), or may itself be randomly generated based on an additionally generated RNG outcome. The RNG outcome for determining whether the enhancement condition is satisfied may be generated in conjunction with determining whether the bonus reel game condition is satisfied (e.g., a single RNG outcome may be utilized to determine whether each condition is satisfied) or may be an additional RNG outcome generated in response to the bonus reel game condition being satisfied. Additionally, and/or alternatively, in a Class III implementation, the enhancement condition may be satisfied when a preselected or predefined game symbol 414 combination and/or a preselected or predefined symbol type (e.g. a special symbol) is displayed on the first plurality of reels 402-410 in a base reel game outcome for base reel game 400.A preselected or predefined game symbol 414 combination and/or symbol type may satisfy both the bonus reel game condition and the enhancement condition, or different symbol combinations and/or symbol types may independently satisfy the bonus reel game condition and the enhancement condition. In some implementations, a preselected or predefined game symbol 414 combination and/or symbol type being displayed in an outcome of a base game (e.g., the base reel game 400) may generate an RNG outcome that is mapped to a decision as to whether the enhancement condition is satisfied. The lookup tables utilized for lookup operations performed using generated RNG outcomes to determine whether the enhancement condition is satisfied and/or to determine outcomes of the base reel game 400 that determine whether the enhancement condition is satisfied may suitably be weighted to control randomness and payout volatility by controlling the overall "hit rate" of the enhancement condition being satisfied.

In various Class II implementations, an enhancement condition may be satisfied if the game controller 202 (e.g., via the processor 204) determines that an outcome of the primary Class II game can be presented as outcome(s) of free spin(s) of the bonus reel game 500 having one or more enhancement features. The determination of whether an enhancement condition is satisfied by the bingo game outcome may be performed after a number of free spins is determined for the bonus reel game 500,or may be performed in conjunction with determining a number of free spins to award. In particular, during or after determining that a bonus reel game condition is satisfied by the primary game outcome (e.g., bingo game outcome), the processor 204 may determine that one or more winning combinations of the primary game outcome satisfy the bonus reel game condition and determine whether outcome(s) of one or more free spins of the bonus reel game 500 having one or more enhancements may be presented that correspond to the one or more winning combinations.

As described above, in the example implementation, the bonus reel game 500 is simulated in conjunction with the base reel game 400 as a façade for presenting a bingo game outcome that satisfies the bonus reel game condition. The enhancement condition is satisfied where the bingo game outcome is associated with one or more façades that present the bingo game outcome as outcomes of the base reel game 400 and outcome(s) of one or more free spins of the bonus reel game 500 having one or more enhancement features. As described above, the façades may be stored in a table or database in a computer memory of any of EGMs 104A-104X or 200 and/or the server computers 102, such as memory 208, and the game controller 202 (e.g., via the processor 204) may query the table or database to identify façades that contain one or more free spin or bonus reel game outcome of the bonus reel game 500 having one or more enhancement features. The processor 204 may query the same or a different database or table to identify façades that contain one or more outcomes of the base game 400 for the bingo game outcome, façades that contain one or more free spin or bonus reel game outcome of the bonus reel game 500 without an enhancement feature, and façades that contain one or more free spin or bonus reel game outcome of the bonus reel game 500 having one or more enhancement features. If the processor 204 based on the query, maps the bingo game outcome to one or more façades containing free spin(s) and associated outcome(s) of the bonus reel game 500 having one or more enhancement features, the processor 204 may determine that the associated enhancement condition is satisfied by the bingo game outcome. The processor 204 may select a façade for presenting the bingo game outcome that satisfies the bonus reel game condition and the enhancement condition and based on the selected façade the processor 204 causes display of one or more spin and stop sequences and the associated outcomes of the base reel game 400 and one or more free spins and the associated outcomes of the bonus reel game 500 having one or more enhancement features. If no free spin or bonus reel game outcome for the bonus reel game 500 with or without an enhancement feature exist for the winning patterns the processor 204 may present the winning patterns as one or more outcomes of the base game 400 (e.g., for a given bingo game outcome, only façades that contain one or more outcomes of the base game 400 may be identified and selected from).

In some implementations, façades may be stored that contain a sequence of spins and outcomes of the base game 400 and the bonus reel game 500 (with or without enhancement feature(s)) for presenting each of the winning patterns. That is, façades may exist that contain a sequence of spins and outcomes including an outcome of the base reel game 400, one or more free spin or bonus reel game outcomes of the bonus reel game 500 without an enhancement feature, and/or one or more free spin or bonus reel game outcomes of the bonus reel game 500 having one or more enhancement features for presenting all the winning patterns. In these implementations, the processor 204 may select a single façade to present the bingo game outcome. To illustrate, returning to the example where the bingo game outcome includes multiple winning patterns associated with a 10 credit, a 100 credit, and a 1000 credit pattern win, the processor 204 may query the table or database to identify façades for presenting each of the winning patterns and/or the award value(s) as one or more spin and stop sequences and the associated outcome(s) of the base reel game 400 and one or more free spins and the associated outcome(s) of the bonus reel game 500 having one or more enhancement features. For example, one or more façades may exist that contain a spin and stop sequence and associated outcome of the base reel game 400 for presenting the 10 credit pattern win and one or more free spins and the associated outcome(s) of the bonus reel game 500 having an expand feature, a grow feature, a collect feature, or any combination thereof, for presenting the 100 credit pattern win and the 1000 credit pattern win. Additionally, and/or alternatively, one or more façades may exist that contain a spin and stop sequence and associated outcome of the base reel game 400 for presenting the 10 credit pattern win one or more free spins and the associated outcome(s) of the bonus reel game 500 without an enhancement feature for presenting the 100 credit pattern win, and one or more free spins and the associated outcome(s) of the bonus reel game 500 having one or more enhancement features for presenting the 1000 credit pattern win. Additionally, and/or alternatively, one or more façades may exist that contain one or more spin and stop sequences and associated outcome(s) of the base reel game 400 for presenting the 10 credit pattern win and the 100 credit win, and one or more free spins and the associated outcome(s) of the bonus reel game 500 having one or more enhancement features for presenting the 1000 credit pattern win The processor 204 then selects eg randomly selects based upon a random number provided by the RNG 212 one of the identified façades for the bingo game outcome and in response and based on the selected façade the processor 204 causes display of the sequence of spins and outcomes including an outcome of the base reel game 400, one or more free spin or bonus reel game outcomes of the bonus reel game 500 without an enhancement feature, and/or one or more free spin or bonus reel game outcomes of the bonus reel game 500 having one or more enhancement features for presenting the 10 credit pattern win, the 100 credit pattern win, and the 1000 credit pattern win.

In some implementations, façades may be stored that contain one or more spins and outcomes of the base game 400 and/or the bonus reel game 500 (with or without enhancement feature(s)) for presenting a single winning pattern of a bingo game outcome. In these implementations, the processor 204 may separately select a façade for each winning pattern of the bingo game outcome to be presented. The processor 204 may identify the façades containing free spin(s) and associated outcome(s) for a bonus reel game 500 having an enhancement feature (or combination of enhancement features) that is common between the winning patterns of the bingo game outcome. For each winning pattern, the processor 204 may randomly select, from the identified façades, a façade that contains free spin(s) and associated outcome(s) of the bonus reel game 500 having the common enhancement feature(s). The processor 204 may then initiate the bonus reel game 500 having the enhancement feature(s) commonly triggered by the winning patterns of the bingo game outcome and cause display of the randomly selected façade(s). If no façades that contain free spin or bonus reel game outcome(s) for the bonus reel game 500 having common enhancement feature(s) exist in the table or database for the winning patterns of the bingo game outcome, the processor 204 may initiate the bonus reel game 500 without an enhancement feature (shown in FIG. 5). Alternatively, the processor 204 may present one of the winning patterns of the bingo game outcome (e.g., a winning pattern associated with a smaller award value) as an outcome of the base game 400 and/or an outcome of the bonus reel game 500 without an enhancement feature, and present another one of the winning patterns (e.g., a winning pattern associated with a larger award value) as a free spin or bonus reel game outcome of a bonus reel game 500 having one or more enhancement features.

To illustrate returning to the example where the bingo game outcome includes multiple winning patterns associated with a 10 credit a 100 credit and a 1000 credit pattern win the processor 204 may query the table or database to separately identify façades for presenting each of the 10 credit pattern win the 100 credit pattern win and the 1000 credit pattern win That is the processor 204 separately identifies one or more façades for presenting each of the 10 credit pattern win one or more façades for presenting the 100 credit pattern win and one or more façades for presenting the 1000 credit pattern In some examples the façades identified for the 10 credit pattern win may only contain spins and associated outcomes for the base reel game 400 and façades may be identified for the 100 credit pattern win that contain free spins and associated outcomes for the bonus reel game 500 having one or more enhancement features and façades may be identified for the 1000 credit pattern win that contain free spins and associated outcomes for the bonus reel game 500 having one or more enhancement features The processor 204 may initially and separately identify subsets of the façades for presenting the 100 credit pattern win and subsets of the façades for presenting the 1000 credit pattern win that contain free spins and associated outcomes for the bonus reel game 500 having common enhancement features For example if façades are identified for the 100 credit pattern win and the 1000 credit pattern win that contain free spins and associated outcomes for the bonus reel game 500 having an expand feature the processor 204 would identify these façades for each of the 100 credit pattern win and the 1000 credit pattern win as a subset The processor 204 then may randomly select a subset of the façades for each of the 100 credit pattern win and the 1000 credit pattern win and from the randomly selected subset randomly select a façade for each of the 100 credit pattern win and the 1000 credit pattern win In some instances the identified façades for the 100 credit pattern win and the 1000 credit pattern win may not contain free spins and associated outcomes for a bonus reel game 500 having a common enhancement features The processor 204 may select façades for each of the 100 credit pattern win and the 1000 credit pattern win that contain free spins and associated outcomes for a bonus reel game 500 without an enhancement feature and or the processor 204 may select a façade for the 100 credit pattern win that contains one or more spins and associated outcomes of the base game 400 and or the bonus reel game 500 without an enhancement feature and select a façade for the 1000 credit pattern win that contains one or more free spins and associated outcomes of a bonus reel game 500 having one or more enhancement features Thus based on the selected façades the 10 credit pattern win and the 100 credit pattern win may be presented as spins and associated outcomes of the base reel game 400 and or the bonus reel game 500 without an enhancement feature and the 1000 credit pattern win may be presented as one or more free spins and associated outcomes of the bonus reel game 500 having one or more enhancement features This game design advantageously provides flexibility and variability in presenting the largest pattern wins under a distinct façade eg as a bonus reel game 500 having enhancement features not applied when presenting other winning patterns.

Thus, the enhancement features of the free spin bonus reel game 500 may be implemented in Class II and Class III games, and whether an enhancement condition is satisfied may be determined by various means. The methods described herein for determining whether the enhancement condition is satisfied are merely illustrative, and other suitable approaches are contemplated and within the scope of the present disclosure.

In the example implementation, in both Class II and Class III games, in response to the bonus reel game condition and enhancement condition being satisfied, the bonus reel game 500 having one or more enhancement features is triggered after an outcome of the base reel game 400 is displayed. When the bonus reel game 500 having one or more enhancement features is triggered, one or more enhancement feature symbols 418 may be displayed in the plurality of reels 402-410 in an outcome of the base reel game 400. Each enhancement feature symbol 418 is associated with one of the enhancement features of the bonus reel game 500. In Class II games, enhancement feature symbol 418 being displayed in the plurality of reels 402-410 in a base reel game outcome of the base reel game 400 is merely representative of an enhancement condition being satisfied. That is, the processor 204 may determine that an enhancement condition is satisfied for an enhancement feature (or combination of enhancement features) of the bonus reel game 500 based on an outcome of the Class II (e.g., bingo) game, and, in response controls one or more of the first plurality of reels 402-410 to display the associated enhancement feature symbol 418 (or combination of enhancement feature symbols) in the plurality of reels 402-410 in an outcome of the base reel game 400.The bonus reel game 500 including the enhancement feature (or combination of enhancement features) is subsequently initiated, and a player thereby perceives that the display of the enhancement feature symbol (or combination of enhancement feature) symbols triggers the enhancement feature or combination of enhancement features of the bonus reel game.

In Class III games, enhancement feature symbol 418 being displayed in the plurality of reels 402-410 in an outcome the base reel game 400 may itself satisfy an enhancement condition of the enhancement feature associated with the enhancement feature symbol 418 that is displayed. In some implementations, the display of the enhancement feature symbol 418 may be necessary but not sufficient to trigger a bonus reel game 500 having the associated enhancement feature. Specifically, the display of the enhancement feature symbol may not satisfy the bonus reel game condition. As such, in some implementations, there may be instances where, in an outcome of the base reel game 400,an enhancement feature symbol 418 is displayed in the plurality of reels 402-410 and a bonus reel game 500 is not triggered. Similarly, in Class II games as described in further detail below there may be instances where an enhancement feature symbol 418 is displayed but the bonus reel game 500 is not triggered.

In addition to the enhancement feature symbols 418,a plurality of metamorphics 426-430 may be displayed on display 412 of an EGM 104A-104X or 200, whereby the plurality of metamorphics 426-430 may appear above and/or adjacent to the plurality of reels 402-410. Each metamorphic 426-430 is associated with an enhancement feature of the bonus reel game 500, and is activated when a bonus reel game 500having the associated enhancement feature is triggered. It will be appreciated that the metamorphics 426-430 may appear in any other suitable location as well as on any display of an EGM 104A-104X or 200.For example, in at least some implementations, the metamorphics 426-430 appear on an auxiliary display. In other implementations, the metamorphics 426-430 may appear on a display of button deck 120.

In the example implementation, the base reel game 400 includes display of three metamorphics 426-430. These include an expand metamorphic 426 (associated with the expand feature), a grow metamorphic 428 (associated with the grow feature), and a collect metamorphic 430 (associated with the collect feature). Although three metamorphics 426-430 are shown and described, it will be appreciated that any suitable number of metamorphics may be included in base reel game 400 and/or bonus reel game 500. For example, the number of metamorphics may vary to match a number of potential enhancement features of the bonus reel game 500.

The metamorphics 426-430 may be used in conjunction with the enhancement feature symbols 418 that are displayed in the plurality of reels 402-410 to provide a visual representation to a player that an enhancement feature symbol 418 being displayed in the plurality of reels 402-410 after base reel game 400 triggers the associated enhancement feature of the bonus reel game 500. In particular, each enhancement feature symbol 418 is associated with one of the metamorphics 426-430, the association being establish by a common enhancement feature associated with the enhancement feature symbol 418 and the metamorphic 426-430. During the base reel game 400, the metamorphics 426-430 may each be in an inactive state. For example, each metamorphic 426-430 is a unique graphic and in the inactive state, the unique graphic is displayed with no additional accents or animations. In response to an enhancement feature symbol 418 being displayed in the plurality of reels 402-410 in a base reel game outcome of the base reel game 400, the associated metamorphic 426-430 is transformed to either an intermediate state or an active state. In non-limiting examples, in the intermediate state the graphic representing each metamorphic can moves and/or grows in size, and in an active state the graphic can perform secondary movement (e.g., explode) or grow to maximum size. In other non-limiting examples, a metamorphic indicator 432 can be positioned behind each graphic representing the metamorphics 426-430. In an inactive state, no metamorphic indicator 432 is shown. In an intermediate state, the metamorphic indicator 432 can grow in size and/or move (e.g., pulse) as each enhancement feature symbol 418 is displayed in the plurality of reels 402-410. Finally in an active state, metamorphic indicator 432 may grow to a maximum size (along with the graphic representing the metamorphics 426-430) to indicate to a play that the metamorphic 426-430 is in an active state.

Whether the associated metamorphic 426-430 transforms to the intermediate state or the active state may be determined based on whether the bonus reel game 500 is triggered in conjunction with the display of the enhancement feature symbol (i.e., whether a primary game outcome presented by the outcome of the base game 400 also triggers the bonus reel game 500). If the bonus reel game 500 is not triggered, the metamorphic 426-430 associated with an enhancement feature symbol 418 in the plurality of reels 402-410 transforms to the intermediate state. By transforming the metamorphic 426-430 to the intermediate state (e.g., moves and/or grows in size, metamorphic indicator 432), the player may perceive that the opportunity for a bonus reel game 500 having the enhancement feature associated with the transformed metamorphic 426-430 has increased. If the bonus reel game 500 is triggered, the metamorphic 426-430 associated with an enhancement feature symbol in the plurality of reels 402-410 transforms to the active state (e.g., graphic/metamorphic indicator 432 grows, moves, explodes). By transforming the metamorphic 426-430 to the active state, the player is informed that a bonus reel game 500 having the enhancement feature associated with the transformed metamorphic 426-430 has been triggered and perceives, via the visual representation, that the enhancement feature symbol 418 being displayed in the plurality of reels 402-410 triggers the associated enhancement feature of the bonus reel game 500. If multiple enhancement feature symbols 418 are displayed in the plurality of reels 402-410, each associated metamorphic 426-430 is transformed to either the intermediate state or the active state, depending on whether the bonus reel game 500 is triggered. Further, a visual representation that the transformation of the metamorphic 426-430 is caused by the associated enhancement feature symbol 418 being displayed in the plurality of reels 402-410 may be provided, such as by moving the enhancement feature symbol up toward the associated metamorphic 426-430 before and or during the metamorphic 426-430 being transformed.

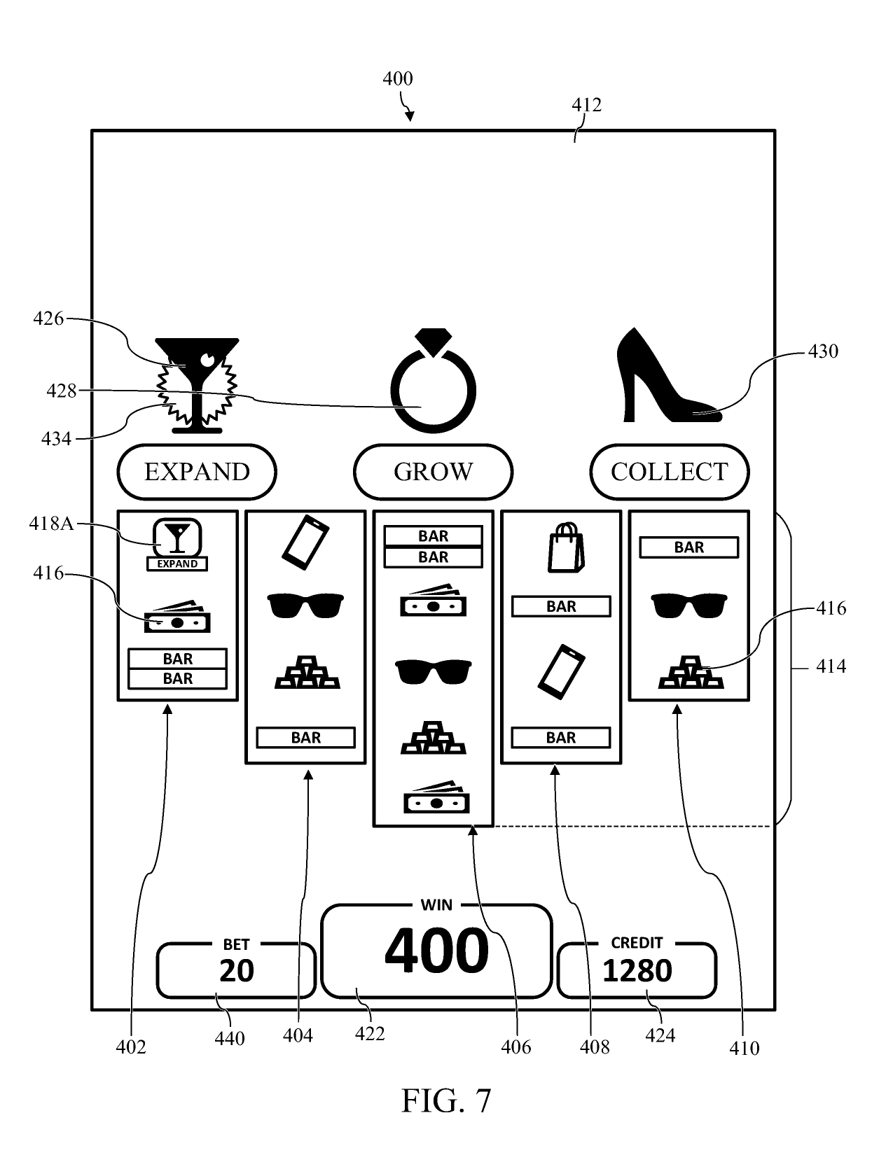

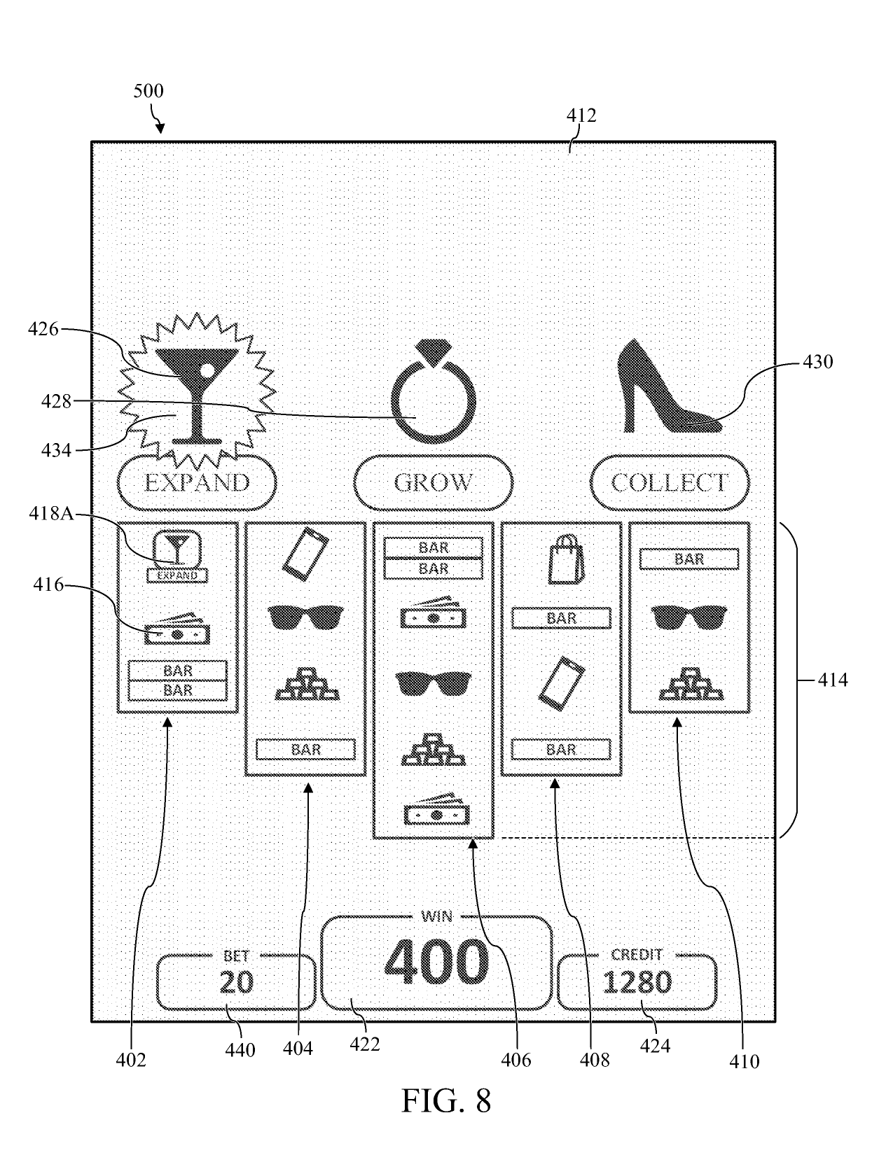

Turning to FIGS. 6-10 user interfaces or screen shots of a sequence between the base reel game 400 (FIGS. 6 and 7) and the bonus reel game 500 (FIGS. 8-10) having an enhancement feature and more specifically an expand feature, are shown. As shown in FIG. 6, in the displayed base reel game outcome of the base reel game 400 enhancement feature symbol 418 associated with the expand feature of the metamorphic enhancement features is displayed in the plurality of reels 402-410. More specifically, an expand feature symbol 418A associated with the expand feature for bonus reel game 500 is shown, depicted, and/or displayed in reel 402 of the plurality of reels 402-410. Although shown and discussed herein as being depicted or included within reel 402, it is understood that expand feature symbol 418A may be shown on any of the plurality of reels 402-410 during base reel game 400 and/or bonus reel game .

The inclusion, depiction, and/or displaying of expand feature symbol 418A in the plurality of reels 402-410 can modify, alter, adjust and/or transform metamorphic 426 associated with the expand feature and/or metamorphic indicator 432 associated with metamorphic 426. As shown in FIG. 6, expand feature metamorphic 426 is in an inactive state prior to or as the base reel game outcome is displayed. As such, expand feature metamorphic is not animated, increased in size, and/or does not include a visible metamorphic indicator 432. FIG. 7 depicts a non-limiting example where expand feature metamorphic 426 is transformed to an intermediate state (e.g., expand feature metamorphic 426 grows/moves, metamorphic indicator 432 present). With reference to the base reel game outcome shown in FIG. 6, expand feature metamorphic 426 shown in FIG. 7 may be in an intermediate state in response to expand feature symbol 418A being displayed in the plurality of reels 402-410 in the outcome of the base reel game 400. In another non-limiting example, FIG. 8 depicts expand feature metamorphic 426 in an active state (e.g., expand feature metamorphic 426 grows/moves/explodes, metamorphic indicator 432 at maximum size). In the example, the expand feature metamorphic 426/metamorphic indicator 432 transforming to the active state from an inactive state (e.g., FIG. 6) or intermediate state (e.g., FIG. 7), visually represents that bonus reel game 500 having the expand feature of the metamorphic enhancement features is triggered. In other examples, if the bonus reel game 500 is not triggered, the expand feature metamorphic 426 may transform or remain in the intermediate state in response to the expand feature symbol 418A being displayed in the plurality of reels 402-410 in the outcome of the base reel game 400.

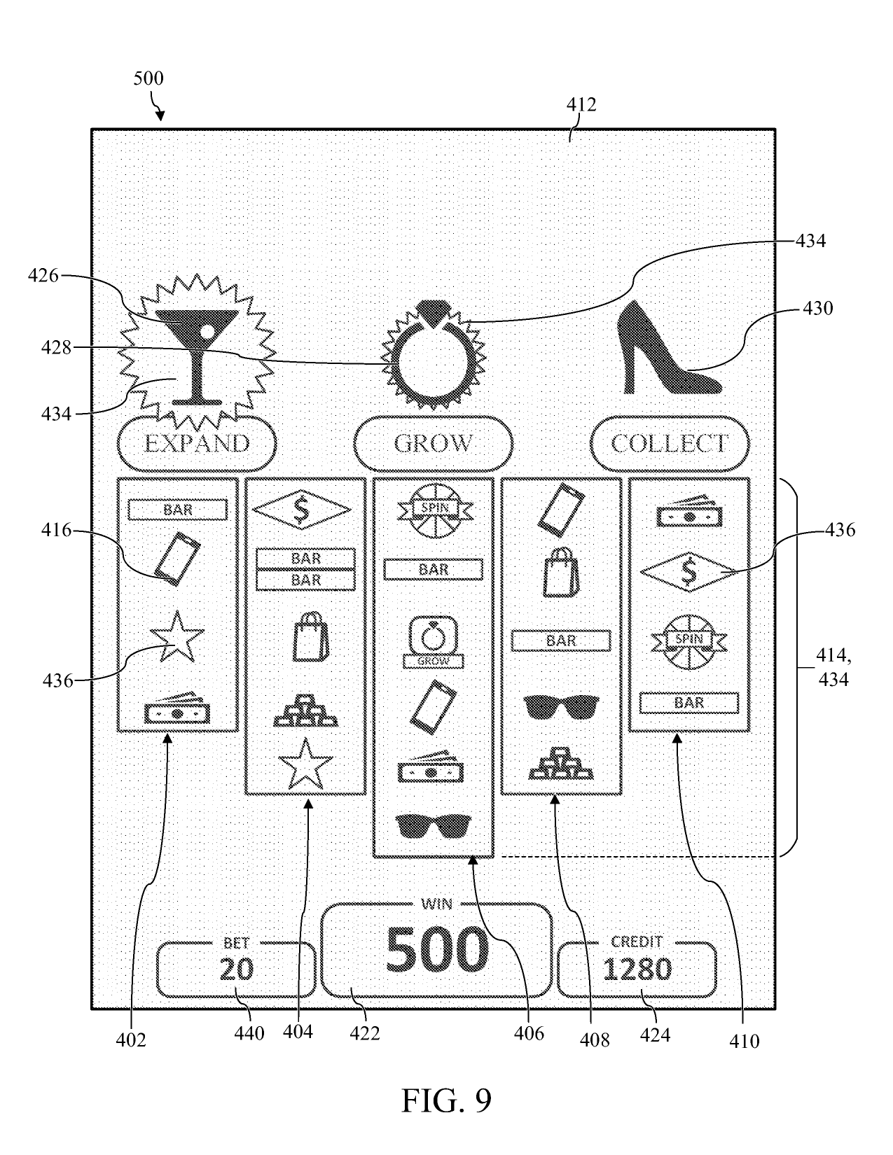

As shown in FIG. 9, after expand feature symbol 418A is displayed in the plurality of reels 402-410 in the base reel game outcome of the base reel game 400, and during and/or after the expand feature metamorphic 426 transforms to the active state, the bonus reel game 500 having the expand feature is initiated and the plurality of reels 402-410 expand. More specifically, upon activating or including the expand feature in bonus reel game 500,each of the plurality of reels 402-410 utilized for bonus reel game 500 gain at least one additional row. In a non-limiting example, the plurality of reels 402-410 expand or gain rows incrementally or in a cascading effect during the at least one free spin and for each subsequent spin of the bonus reel game 500 until a predetermined row threshold is reached. FIG. 9 shows bonus reel game 500 before or during a first free spin of bonus reel game 500. With comparison to FIGS. 6-8, each of the plurality of reels 402-410 include an additional row, making the arrangement of “expanded” plurality of reels 402-410 4x5x6x5x4, as compared to the base reel game arrangement of 3x4x5x4x3 (see, FIG. 6). During the first free spin of the at least one free spin for bonus reel game 500 the plurality of reels 402-410 for bonus reel game include twenty-four (24) game symbol positions (e.g., compared to nineteen).

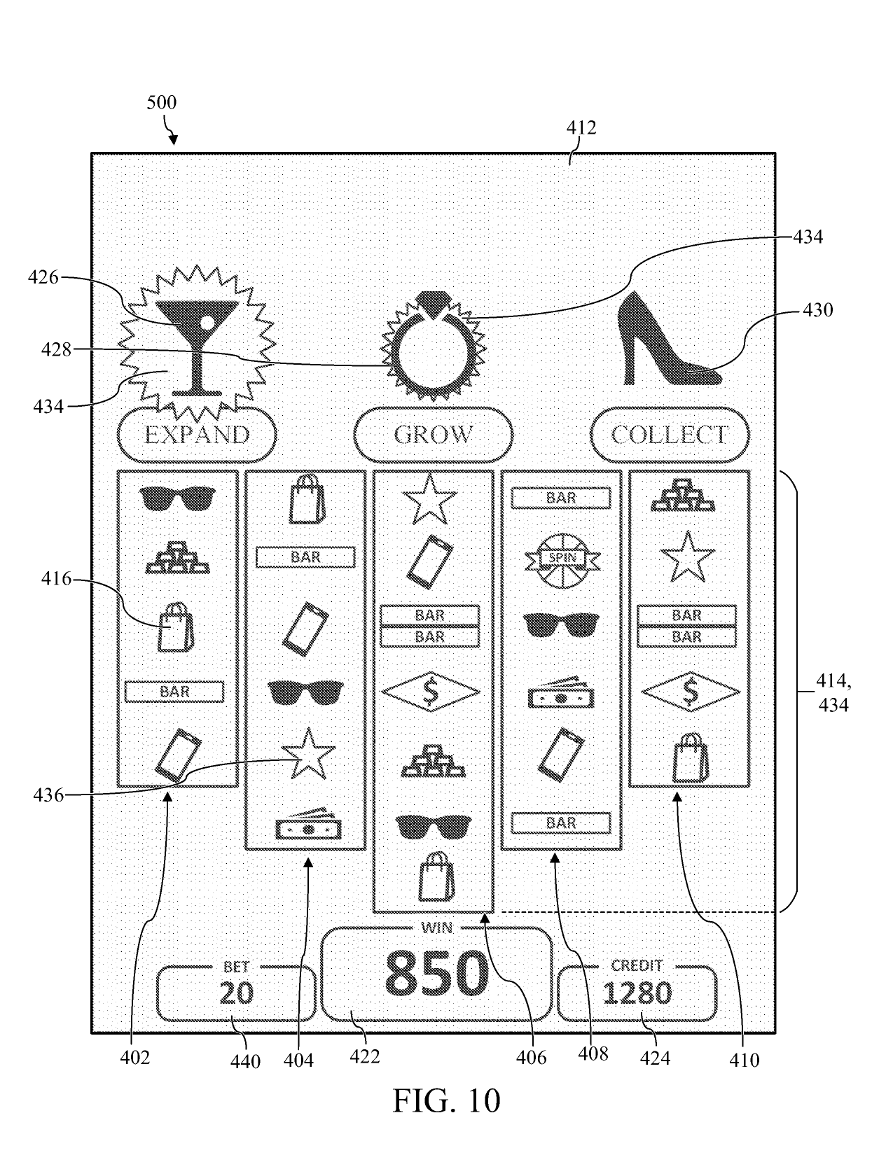

If more than one free spin is awarded or included with bonus reel game 500, additional rows can be added to the plurality of reels 402-410 for each subsequent spin of the bonus reel game 500 until a predetermined row threshold is reached. FIG. 10 shows bonus reel game 500 before or during a second free spin of bonus reel game 500. With comparison to FIG. 9, each of the plurality of reels 402-410 include another row, making the arrangement of “expanded” plurality of reels 402-410 5x6x7x6x5, as compared to the base reel game arrangement of 3x4x5x4x3 (see, FIG. 6) or subsequent expansion arrangement of 4x5x6x5x4 for reels 402-410 after the first or initial free spin (see, FIG. 9). During the second free spin of the at least one free spin for bonus reel game 500 the plurality of reels 402-410 for bonus reel game include twenty-nine (29) game symbol positions (e.g., compared to nineteen or twenty-four). Rows may be continuously added to the plurality of reels 402-410 until it the arrangement equals or is configured similar to a predetermined row or arrangement threshold. In a non-limiting example, the predetermined row or arrangement threshold can be an arrangement for the plurality of reels 402-410 that is 7x8x9x8x7. In this example, reels 402-410 can continue to expand for each subsequent free spin until the fourth (4th) free spin of bonus reel game 500. An subsequent free spins after the fourth free spin may maintain the plurality of reels 402-410 in the 7x8x9x8x7 arrangement. Although discussed herein as occurring incrementally or in a cascading effect, it is understood that once bonus reel game 500 having the expand feature is initiated and the plurality of reels 402-410 may be expanded to the predetermined row or arrangement threshold (e.g., 7x8x9x8x7) before the first free of the bonus reel game 500. The free spins of the bonus reel game 500 having the incrementally expanding reels 402-410 under the expand feature are displayed, and the free spins include spin and stop sequences of the plurality of reels 402-410 as discussed herein.

As discussed herein, the plurality of game symbols 414 are utilized by both base reel game 400 and bonus reel game 500.As such, all game symbols 414 included in base reel game 400 are also included in bonus reel game 500. However, when bonus reel game 500 includes the expand feature and the plurality of reels 402-410 are expanded during the at least one free spin, a plurality of distinct game symbols 434 may be included within the plurality of reels 402-410. As shown in the non-limiting examples of FIGS. 9 and 10, the plurality of distinct game symbols 434 can include distinct, graphic game symbols 436 that are displayed within the plurality of reels 402-410. In examples where base reel game 400 and bonus reel game 500 are formed as Class II games, the inclusion of the distinct game symbols 434 may aid in the creation of the façade, where additional symbols 436 are added to the plurality of reels 402-410 as they expand to maintain the same “odds” of winning or receiving awards based on the symbols 414, 434 position within the reels 402-410. Conversely where base reel game 400 and bonus reel game 500 are formed as Class III games, the plurality of distinct game symbols 434 are add to the plurality of game symbols 414 proportionally to the number of rows added to the plurality of reels 402-410 to maintain the predetermined winning odds based on the position and/or combination of symbols 414, 434 during the bonus reel game 500.

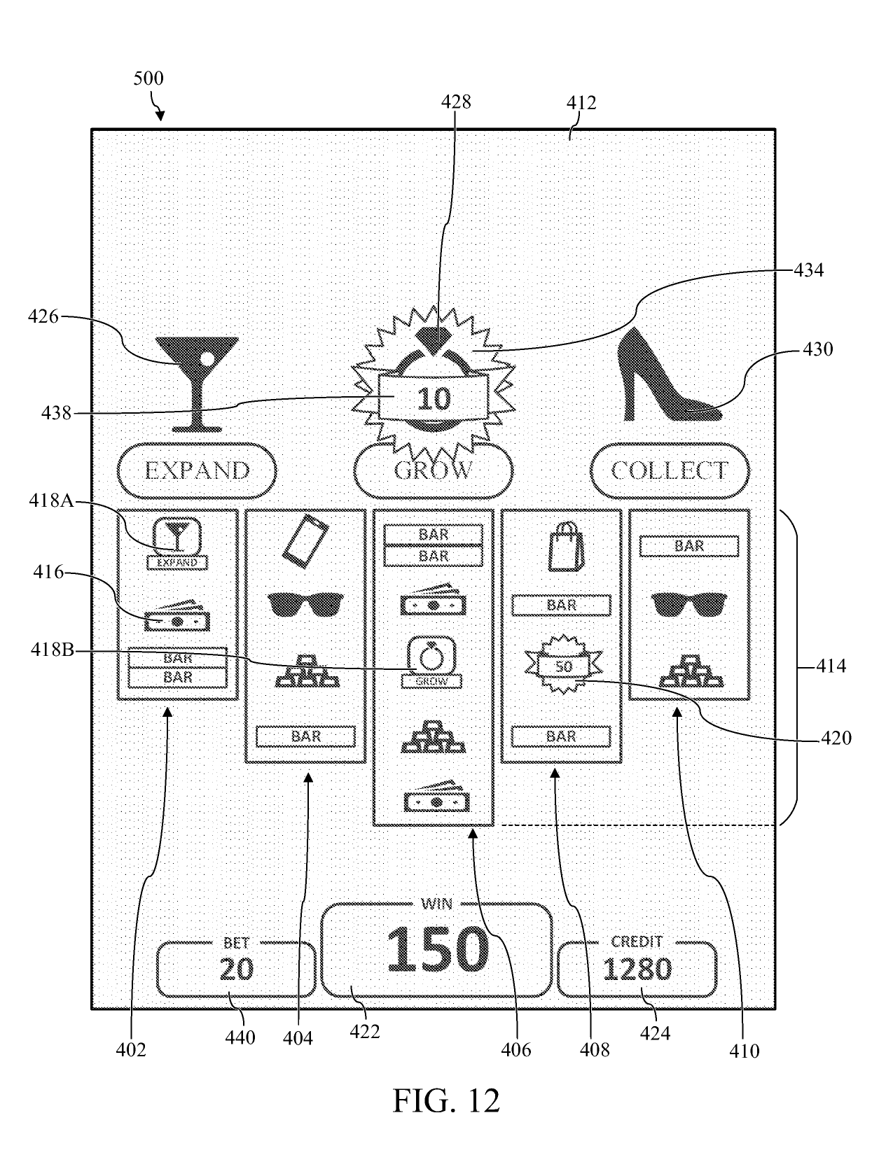

With reference now to FIGS. 11-14, user interfaces or screen shots of a sequence between the base reel game 400 (FIG. 11), and the bonus game 500 (FIGS. 12-14) having a grow feature, are shown. As shown in FIG. 11, in the displayed base reel game outcome of the base reel game 400, enhancement feature symbol 418B associated with the grow feature of the metamorphic enhancement features is displayed in the plurality of reels 402-410. More specifically, grow feature symbol 418B associated with the grow feature for bonus reel game 500 is shown, depicted, and/or displayed in reel 406 of the plurality of reels 402-410. Although shown and discussed herein as being depicted or included within reel 406, it is understood that grow feature symbol 418B may be shown on any of the plurality of reels 402-410 during base reel game 400 and/or bonus reel game 500.

The inclusion, depiction, and/or displaying of grow feature symbol 418B in the plurality of reels 402-410 can modify, alter, adjust and/or transform metamorphic 428 associated with the grow feature and/or metamorphic indicator 432 associated with metamorphic 428. As shown in FIG. 11, grow feature metamorphic 428 is in an intermediate state (e.g., grow feature metamorphic 428 grows/moves, metamorphic indicator 432 present). Grow feature metamorphic 428 may be in an intermediate state in response to grow feature symbol 418B being displayed in the plurality of reels 402-410 in the outcome of the base reel game 400.In the non-limiting example of FIG. 12, grow feature metamorphic 428 is depicted in the active state (e.g., grow feature metamorphic 428 grows/moves/explodes, metamorphic indicator 432 at maximum size) In the example, the grow feature metamorphic 428/ metamorphic indicator 432 transforming to the active state from the intermediate state (e.g., FIG. 11), visually represents that bonus reel game 500 having the grow feature of the plurality of metamorphic enhancement features is triggered. FIG. 12 also shows a user interface or screen shot prior to the first free spin of the at least one free spin for bonus reel game 500. In other examples, if the bonus reel game 500 is not triggered, the grow feature metamorphic 428 may transform or remain in the intermediate state in response to the grow feature symbol 418B being displayed in the plurality of reels 402-410 in the outcome of the base reel game 400.

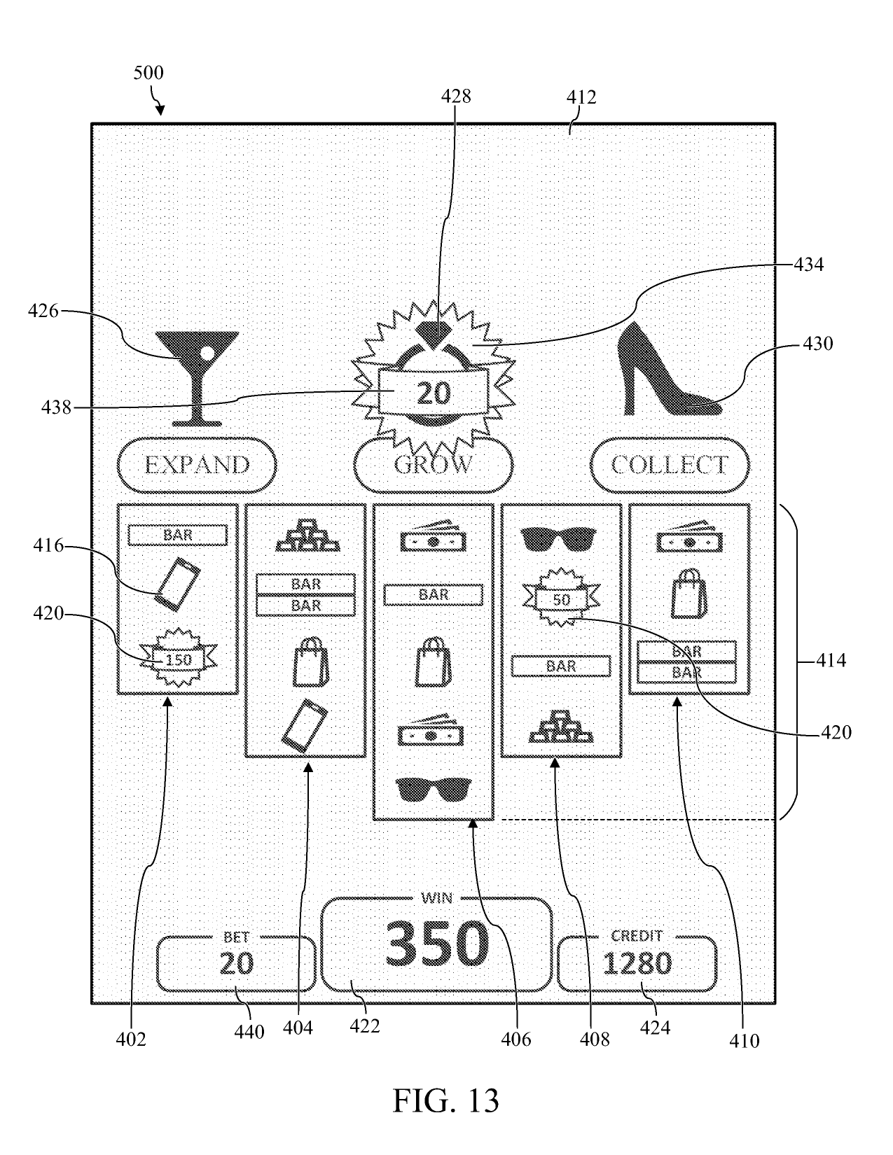

As shown in FIG. 12, after grow feature symbol 418B is displayed in the plurality of reels 402-410 in the base reel game outcome of the base reel game 400,and during and/or after the grow feature metamorphic 428 transforms to the active state, the bonus reel game 500 including the grow feature is initiated and a grow value is established. More specifically, upon activating or including the grow feature in bonus reel game 500, a minimum grow value for bonus reel game 500 is determined and displayed via grow value banner 438. The minimum grow value for bonus reel game 500 is determined before the first free spin of the at least one free spin for bonus reel game 500. In a non-limiting example, minimum grow value is determined, established, generated, and/or calculated based on the wager made for the base reel game 400.The wager made for the base reel game 400 can establish or define the minimum grow value even when COR symbol 420 is depicted in the base reel game outcome and/or subsequent bonus reel game outcomes. That is, and as shown in FIG. 12, although COR symbol 420 includes a credit value of “50,” the minimum grow value for bonus reel game 500 is defined by the wager made for the base reel game (e.g. 20 cr – wager meter 440), as well as the number of free spins for bonus reel game 500. Additionally, the minimum grow value for bonus reel game 500 is defined, determined, and/or calculated independent of the COR credit values associated with displayed COR symbols 420. As discussed herein, the “50” credits associated with COR symbol 420 displayed in reels 402-410 is collected and or added to win meter 422. For example, the “50” credits displayed on COR symbol 420 is added to the “100” credits awarded as a result of the base reel game outcome. Win meter 422 therefore displays “150” credits prior to the first free spin of bonus reel game 500. However, the credit value associated with the displayed COR symbol 420 does not define, adjust, and/or affect the minimum grow value displayed in banner 438. Instead, the minimum grow value will remain dependent and/or based on the wager made for the base reel game 400,and increased by the predetermined factor for each subsequent bonus reel game 500, as similarly discussed herein.

Where the wager defines the minimum grow value for bonus reel games 500 the minimum grow value for each free spin can be multiplied by a predetermined factor. That is, for each free spin of bonus reel game 500, the minimum grow value may be defined, determined, and/or calculated by multiplying the wager of base reel game 400 by a predetermined factor, where the predetermined factor may increase with each subsequent free spin. In a non-limiting example, the minimum grow for the first free spin can be multiplied by a predetermined factor of 0.5 times the wager (0.5x wager). As shown in FIG. 12, and prior to the first free spin of bonus reel game 500,the minimum grow value for the first free spin of bonus reel game 500 is 10 credits (e.g., 05 x 20 cr. 10 cr.). The minimum grow value displayed in grow value banner 438 defines a minimum for the COR credit values associated with COR symbols 420 that may be displayed during the bonus reel game 500. More specifically, and during each free spin of bonus reel game 500 when the grow feature is triggered, no COR symbol 420 may be included in the bonus reel game outcome that has a displayed COR credit value less than the minimum grow value displayed in grow value banner 438. For example, no COR symbol 420 included in the bonus reel game outcome for the first free spin (e.g., FIG. 13) will include a COR credit value less than “10” credits.

Each subsequent free spin can include an increased multiplier to define the minimum grow value. For example, FIG. 13 shows a user interface or screen shot displaying the bonus reel game outcome for the first free spin for bonus reel game 500,and/or prior to a second free spin. The bonus reel game outcome for the first free spin includes two COR symbols 420, displaying “150” credits and “50” credits. These credit values are added to win meter 422 (e.g., 150 cr. (FIG. 12) + 200 cr. (FIG. 13) = 350 cr.) Additionally in the exemplary embodiment, none of the COR credit values associated with COR symbols 420 are less than the minimum grow value for the first free spin and displayed in grow value banner 438.

For the second free spin, the grow value may be increased. More specifically, for the second free spin, the grow value may be defined, determined, and/or calculated as 1.0x the wager for the base reel game 400 (e.g., 20 cr. – wager meter 440) As shown in FIG. 13, the (minimum) grow value for the second free spin of bonus reel game 500 is increased to 20 credits (e.g. 1.0 x 2.0 cr. = 2.0 cr.). As similarly discussed herein, no COR symbol 420 may be included in the subsequent bonus reel game outcome (e.g., second free spin) that has a displayed COR credit value less than the minimum grow value displayed in grow value banner 438.

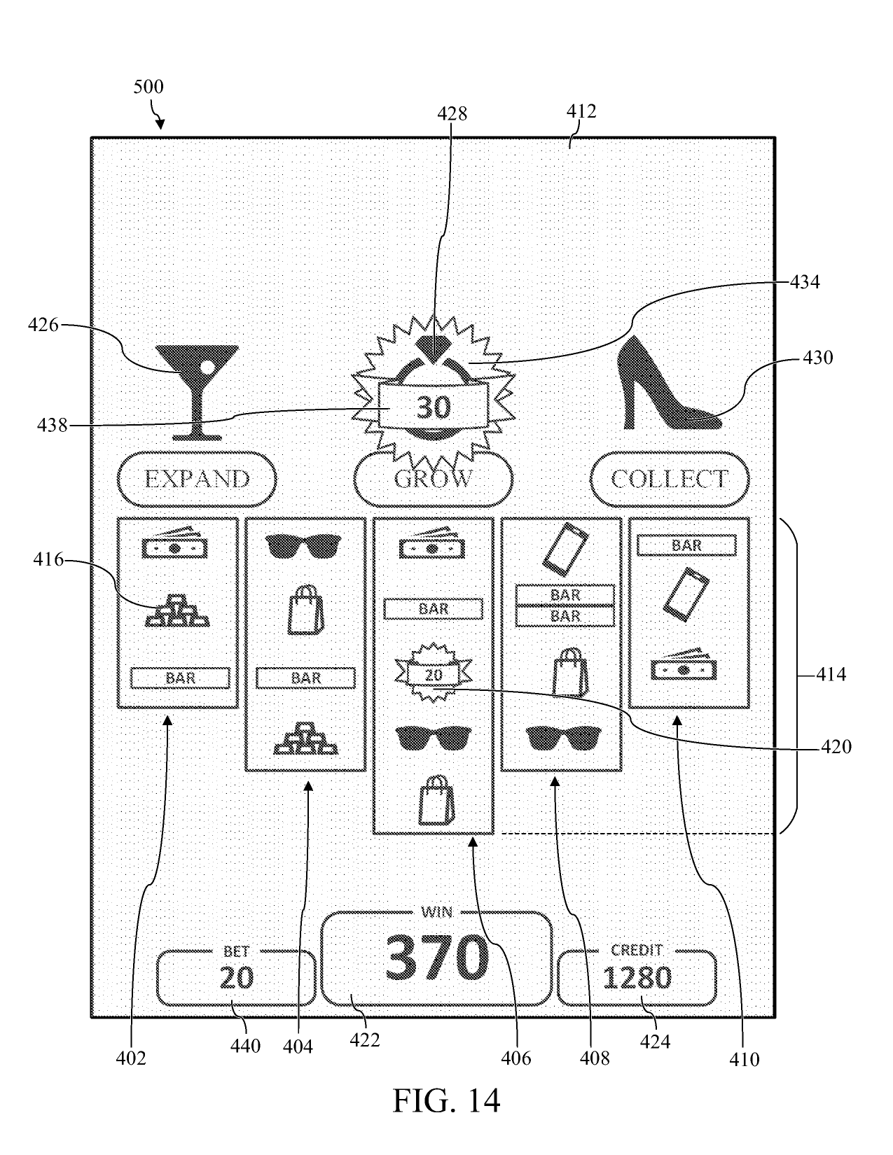

FIG. 14 shows a user interface or screen shot displaying the bonus reel game outcome for the second free spin for bonus reel game 500, and/or prior to a third free spin. The bonus reel game outcome for the second free spin includes a single COR symbol 420 displaying “20” credits. The COR credit value is added to win meter 422 (e.g., 350 cr. (FIG. 13) + 20 cr. (FIG. 14) = 370 cr.). Additionally in the exemplary embodiment, COR credit value associated with COR symbol 420 shown in FIG. 14 is less than the minimum grow value for the second free spin (e.g., 20 cr – FIG. 13). For the third free spin of bonus reel game 500 the grow value may again be increased. More specifically, for the third free spin, the grow value may be defined, determined, and/or calculated as 1.5x the wager for the base reel game 400 (e.g., 20 cr. – wager meter 440). As shown in FIG. 14, the minimum grow value for the third free spin of bonus reel game 500 is increased to 30 credits (e.g., 1.5 x 20 cr. = 30 cr.).

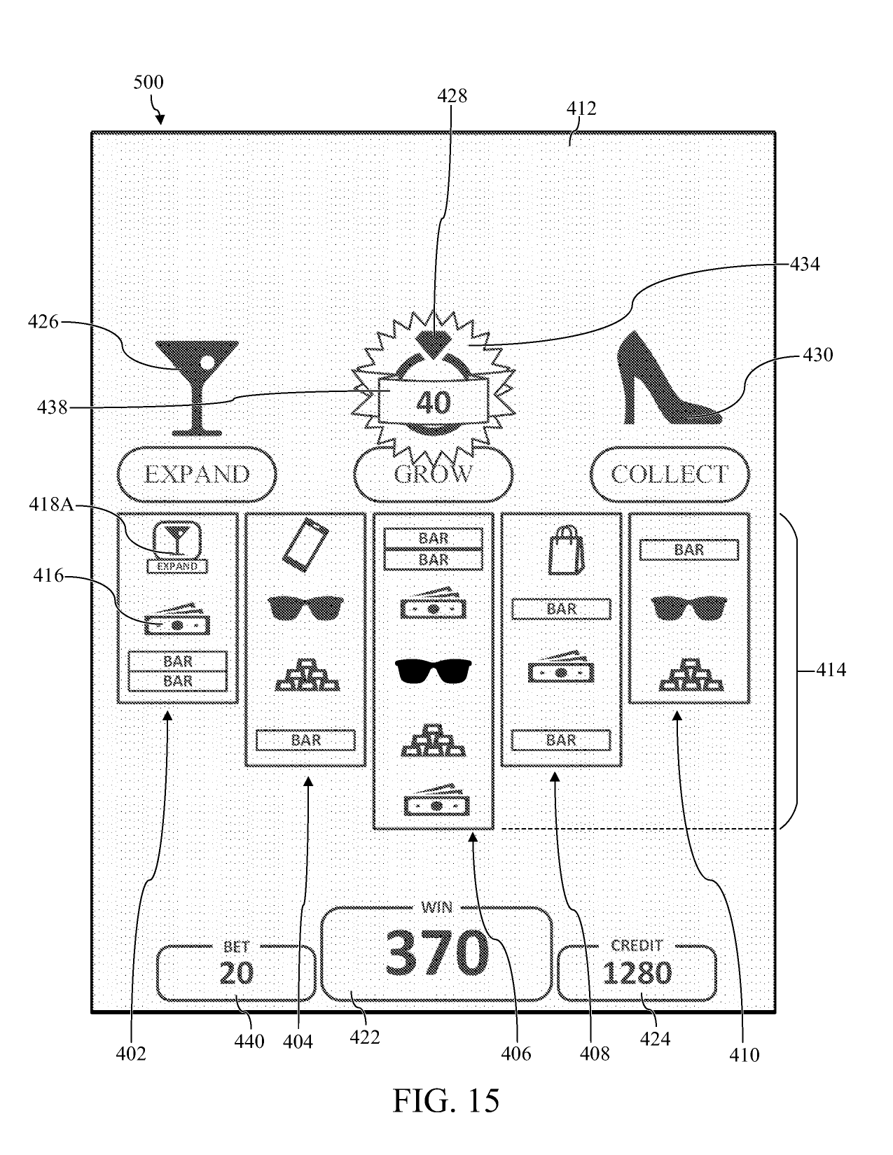

FIG. 15 shows a user interface or screen shot displaying the bonus reel game outcome for the third free spin for bonus reel game 500, and/or prior to a fourth free spin. The bonus reel game outcome for the second free spin includes no COR symbols 420. As such, the credit value included and/or displayed within win meter 422 may not be changed, adjusted, and/or increased. However, the grow value may be increased in anticipation of a fourth free spin of bonus reel game 500. More specifically, for the fourth free spin the grow value may be defined, determined, and/or calculated as 2.0x the wager for the base reel game 400 (e.g., 20 cr. – wager meter 440).As shown in FIG. 15, the minimum grow value for the fourth free spin of bonus reel game 500 is increased to 40 credits (e.g., 2.0 x 20 cr. = 30 cr.).

It is understood that the predetermined factors for increasing the minimum grow value discussed herein are exemplary. As such, bonus reel games 500 can include distinct patterns and/or processes to facilitate increasing the minimum grow value by predetermined factor(s). Additionally, defining the minimum grow value for the grow feature may also include a predetermined factor threshold. The predetermined factor threshold may be dependent, at least in part, on the number of free spins for bonus reel game 500, such that after a predefined number of free spins, the predetermined factor may not increase for any subsequent free spins of bonus reel game 500. In a non-limiting example, the predetermined factors for increasing the minimum grow value for each free spin of bonus reel game 500 can include the following: first free spin = 0.5x wager, second free spin = 1.0x wager, third free spin 1.5x wager, fourth free spin = 2.0x wager, fifth free spin = 3.0x wager, sixth free spin = 4.0x wager, seventh free spin = 5.0x wager, eighth free spin = 6.0x wager, ninth free spin = 7.0x wager, tenth free spin = 8.0x wager, eleventh free spin = 9.0x wager, and twelfth (and greater) free spin = 10.0x wager.

In another non-limiting example, a credit value associated with COR symbol(s) 420 displayed in the plurality of reels for the base reel game outcome for base reel game 400 may define and/or determine the minimum grow value displayed in banner 438.In the example shown in FIG. 12, a single COR symbol 420 including a COR credit value of “50” is shown in reel 408. Where only a single COR symbol 420 is included in base reel game outcome, the minimum grow value displayed in grow value banner 438 is equal to the credit value associated with the single COR symbol. As such, and in the non-limiting example where the minimum grow value is defined by the COR credit value for displayed COR symbol 420,the minimum grow value displayed in grow value banner 438 is “50” credits. In other non-limiting examples discussed herein, where multiple COR symbols 420 are included in base reel game outcome, the highest credit value for a single COR symbol may establish the minimum grow value displayed in grow value banner 438. Alternatively where multiple COR symbols 420 are included in base reel game outcome, the sum of all credit values for all COR symbols 420 may establish the minimum grow value displayed in grow value banner 438. Additionally as discussed herein, once a minimum grow value is established during bonus reel game 500, COR symbols 420 displayed during subsequent free spins will be at least equal to or greater than the minimum grow value.

As similarly discussed herein, the minimum grow value displayed in grow value banner 438 defines a minimum for the COR credit values associated with COR symbols 420 that may be displayed during the bonus reel game 500. More specifically, and during each free spin of bonus reel game 500 when the grow feature is triggered, no COR symbol 420 may be included in the bonus reel game outcome that has a displayed COR credit value less than the minimum grow value displayed in grow value banner 438. In the non-limiting example where the minimum grow value is defined by the COR credit value for displayed COR symbol 420, no COR symbol 420 included in the bonus reel game outcome for the first free spin (e.g., FIG. 13) will include a COR credit value less than “50” credits.

As similarly discussed herein, he grow value displayed in grow value banner 438 may increase after each subsequent free spin of bonus reel game 500 and be added to a total winning credit displayed in win meter 422.For example, and as shown in FIG. 12, the minimum grow value (e.g., 50 credits) displayed in grow value banner 438 is established prior to the first free spin of the at least one free spin of bonus reel game 500. Once established, bonus reel game 500 may proceed with subsequent free spins, and the minimum grow value can increase based on distinct COR symbols 420 including COR credit values that are greater than the minimum grow value. Continuing the example above where the minimum grow value is defined by the COR credit values associated with displayed COR symbol(s), the grow value may increase to “150” credits for the second free spin. That is, FIG. 13 shows the bonus reel game outcome for the first free spin of bonus reel game 500. The bonus reel game outcome for the first free spin includes two COR symbols 420, displaying “150” credits and “50” credits. In the exemplary embodiment the minimum grow value may increase to “150” credits. Additionally, and as discussed herein, no COR symbol 420 may be included in the subsequent bonus reel game outcome (e.g., second free spin) that has a displayed COR credit value less than the minimum grow value (e.g., 150 credits) defined by the COR symbol 420 displayed in the bonus reel game outcome for the first free spin.

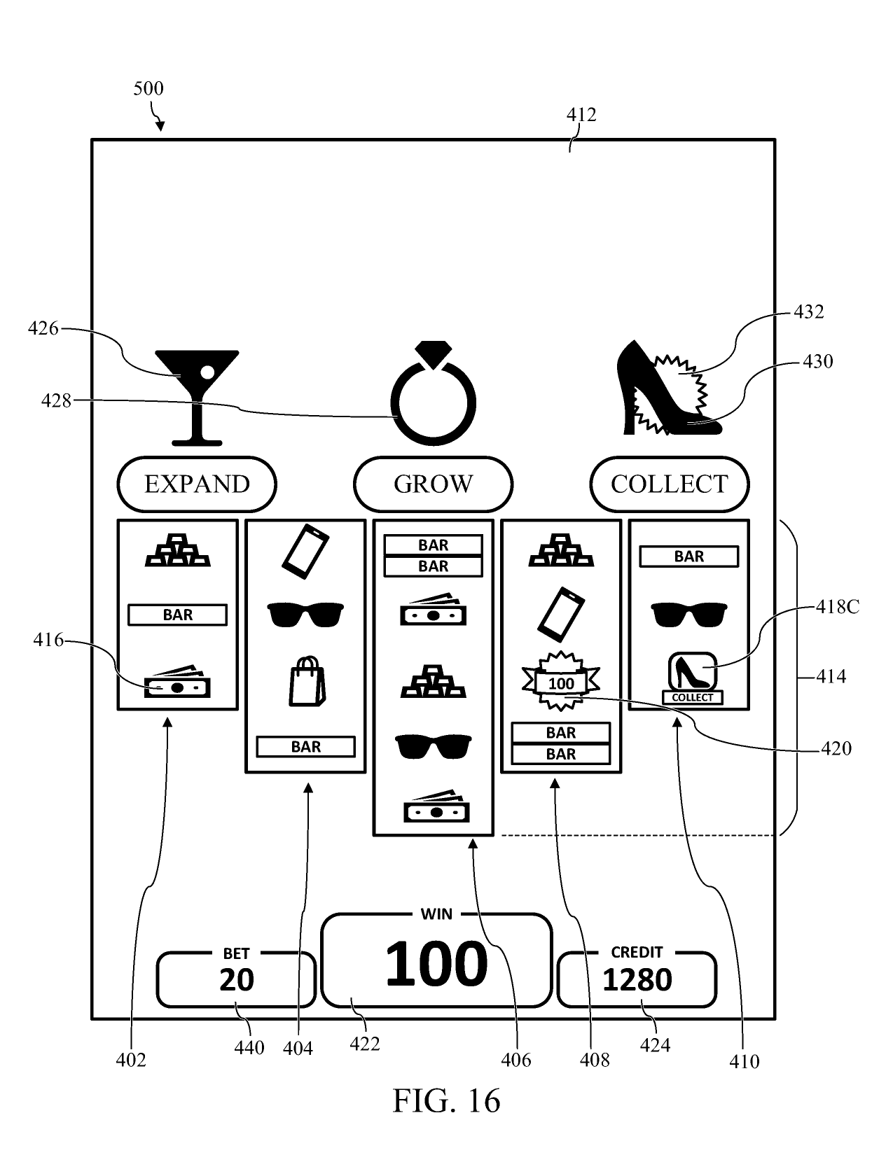

Non-limiting examples of FIGS. 16-19 depict user interfaces or screen shots of a sequence between the base reel game 400 (FIG. 16) and the bonus game 500 (FIGS. 17-19) having a collect feature. As shown in FIG. 16, in the displayed base reel game outcome of the base reel game 400, enhancement feature symbol 418C associated with the collect feature of the plurality of metamorphic enhancement features is displayed in the plurality of reels 402-410. More specifically, collect feature symbol 418C associated with the collect feature for bonus reel game 500 is shown, depicted, and/or displayed in reel 410 of the plurality of reels 402-410. Although shown and discussed herein as being depicted or included within reel 410, it is understood that collect feature symbol 418C may be shown on any of the plurality of reels 402-410 during base reel game 400 and/or bonus reel game 500.

The inclusion, depiction, and/or displaying of collect feature symbol 418C in the plurality of reels 402-410 can modify, alter, adjust, and/or transform metamorphic 430 associated with the collect feature and/or metamorphic indicator 432 associated with metamorphic 430. As shown in FIG. 16, collect feature metamorphic 430 is in an intermediate state (e.g., collect feature metamorphic 430 grows/moves, metamorphic indicator 432 present). Collect feature metamorphic 430 may be in an intermediate state in response to collect feature symbol 418C being displayed in the plurality of reels 402-410 in the outcome of the base reel game 400. In the non-limiting example shown in FIG. 17, collect feature metamorphic 430 is depicted in the active state (e.g., collect feature metamorphic 430 grows/moves/explodes, metamorphic indicator 432 at maximum size). In the example, the collect feature metamorphic 430/metamorphic indicator 432 transforming to the active state from the intermediate state (e.g., FIG. 16), visually represents that bonus reel game 500 having the collect feature of the metamorphic enhancement features is triggered. FIG. 17 also shows a user interface or screen shot prior to the first free spin of the at least one free spin for bonus reel game 500. In other examples, if the bonus reel game 500 is not triggered, the collect feature metamorphic 430 may transform or remain in the intermediate state in response to the collect feature symbol 418C being displayed in the plurality of reels 402-410 in the outcome of the base reel game 400.

As shown in FIG. 17, after collect feature symbol 418C is displayed in the plurality of reels 402-410 in the base reel game outcome of the base reel game 400, and during and/or after collect feature metamorphic 430 transforms to the active state, the bonus reel game 500 is initiated and a collect credit value is displayed and/or awarded. More specifically, upon activating or including the collect feature in bonus reel game 500, an initial collect value for bonus reel game 500 is determined, displayed,and/or added to win meter 422. The initial collect value for bonus reel game 500 is determined before the first free spin of the at least one free spin for bonus reel game 500. In a non-limiting example, collect value is determined, established, generated, and/or calculated based on a credit value associated with COR symbol(s) 420 displayed in the plurality of reels for the base reel game outcome for base reel game 400 that triggers the collect feature of the metamorphic enhancement features. In the example shown in FIG. 17, a single COR symbol 420 including a credit value of “100” is shown in reel 408. Where only a single COR symbol 420 is included in base reel game outcome, the initial collect value displayed and/or added to win meter 422 is equal to the credit value associated with the single COR symbol. In the exemplary embodiment base reel game 400 may award “100” credits for the base reel game outcome and also add the “100” credit value associated with COR symbol 420 displayed in reel 408.As such, win meter 422 displays “200” credits (e.g., 100 cr. + 100 cr. = 200 cr.) prior to the first free spin of bonus reel game 500.In other non-limiting examples discussed herein, where multiple COR symbols 420 are included in base reel game outcome (e.g., COR symbols 420A, 420B, 420C), the initial collect value determined, displayed, and/or added to win meter 422 before the first free spin of the at least one free spin for bonus reel game 500 is equal to the sum of the highest credit value plus twice the amount of each of the lower credit values (e.g., initial collect value = X + 2(Y+Z), where X > Y > Z).

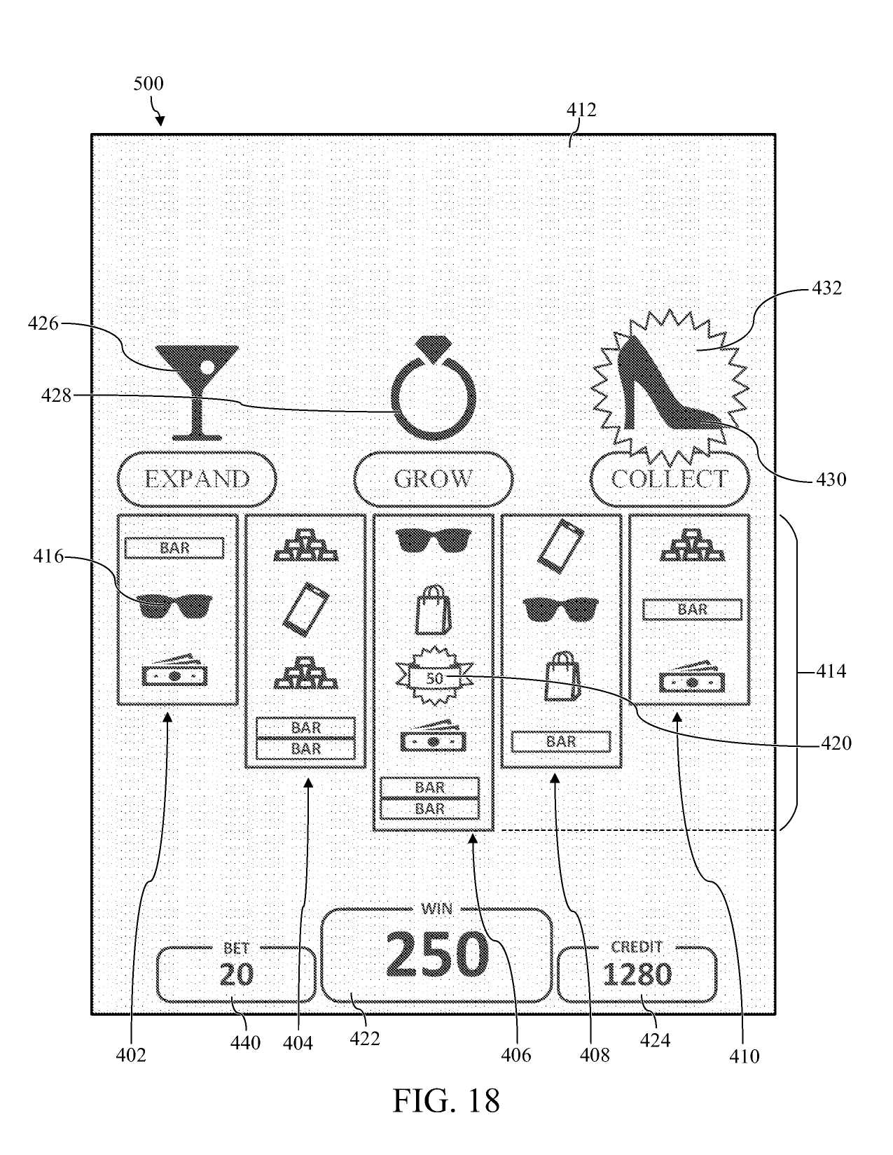

In a non-limiting example, and similar to the grow value, the collect value defined by the COR credit values associated with COR symbol(s) 420 may increase after each subsequent free spin of bonus reel game 500 and be added to win meter 422, as discussed herein. In other non-limiting examples, the collect value defined by the COR credit values associated with COR symbol(s) 420 may randomly be equal to, greater than, or less than previous COR credit values after each subsequent free spin of bonus reel game 500. For example, and as shown in FIG. 18, the collect value for the first free spin of bonus reel game 500 is equal to a “50” credit value. That is, the first free spin of bonus reel game 500 (e.g., bonus reel game outcome (1st spin)) includes a distinct COR symbol 420 having a “50” credit value. In the example, the 50 credit value for the distinct COR symbol 420 included in bonus reel game outcome is added to the 200” credits previously included in win meter 422 (see FIG. 17).

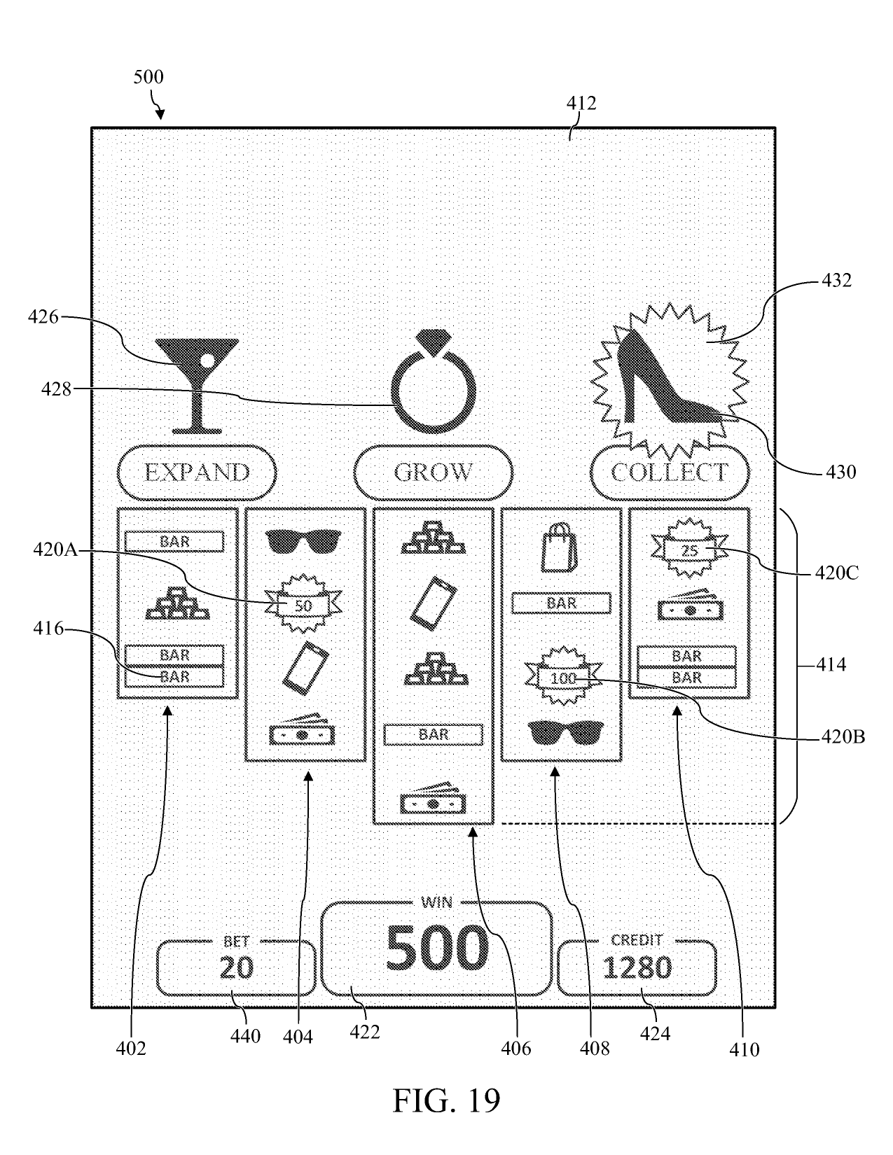

Turning to FIG. 19, a non-limiting example of collect feature included in bonus reel game 500 is shown where bonus reel game outcome includes a plurality of COR symbols 420. In the example, display 412 depicts bonus reel game 500 after a second free spin. As shown, bonus reel game outcome depicts three distinct COR symbols 420A, 420B, 420C displayed in the plurality of reels 402-410. As discussed herein, where multiple COR symbols 420 are displayed during bonus reel game 500 including collect feature, the collect value to be added to a total collect value (e.g., win meter 422) is determined by adding the highest credit value to twice the amount of each of the lower credit values. For the example shown in FIG. 19, COR symbol 420A displays a COR credit value of “50” credits, COR symbol 420B displays a COR credit value of “100” credits, and COR symbol 420C displays a COR credit value of “25” credits. As such, the collect value associated with COR symbols 420A, 420B, 420C in reels 402-410 after the second free spin is equal to: 100 cr. + 2(50 cr.+25 cr.) = 250 credits. The total number of credits included, awarded, and/or displayed in win meter 422 after the second free spin is 500” credits (250 cr. (FIG. 18) + 250 cr. (FIG. 19) = 500 cr.).

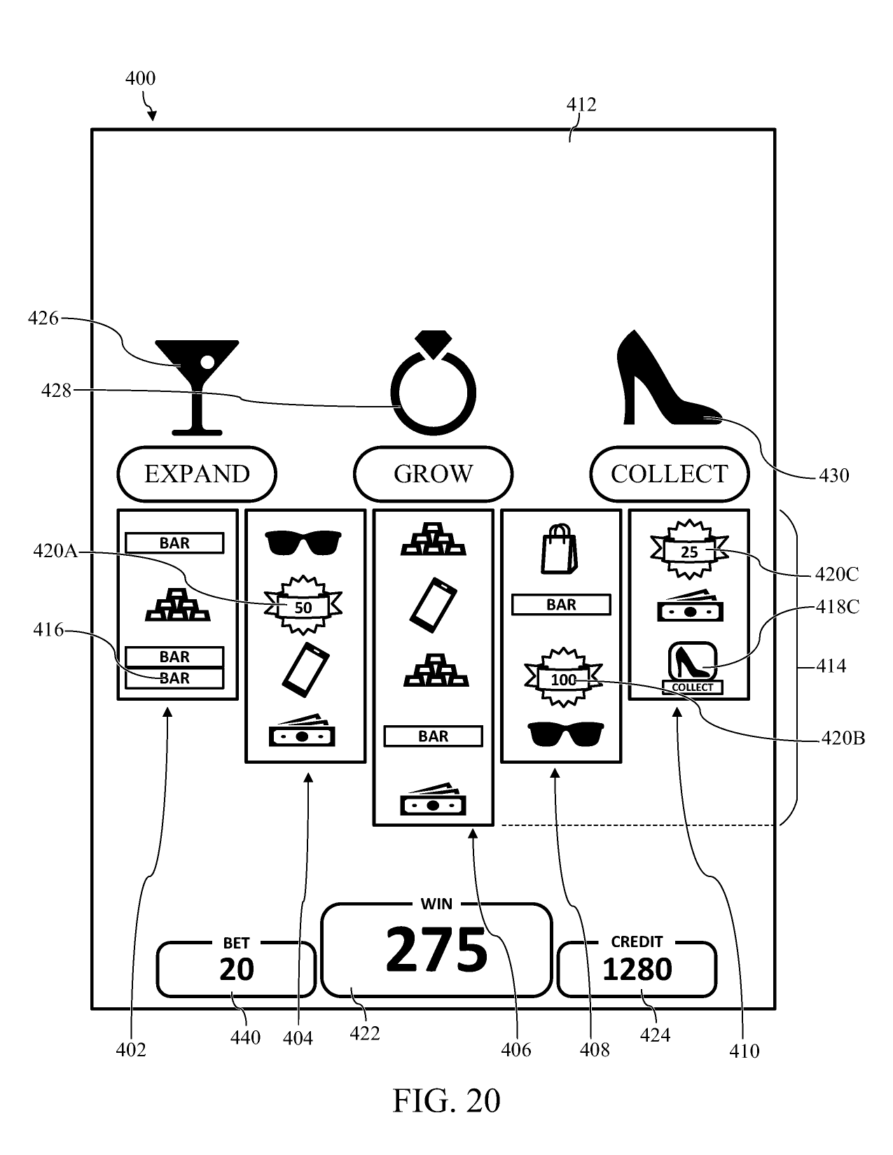

In another non-limiting example, collect feature symbol 418C associated with the collect feature for bonus reel game 500 can also adjust operations or play patterns for base reel game 400. For example, where collect feature symbol 418C is positioned in a predetermined reel (e.g., reel 410) of the plurality of reels 402-410 for the base reel game outcome, and the base reel game outcome also depicts at least one COR symbol 420 within reels 402-410, all credit values associated with the COR symbol(s) 420 can be added to win meter 422 for that base reel game 400. This COR “payout” is only dependent on and or triggered when collect feature symbol 418C is in the predetermined reel (e.g., reel 410) and the plurality of reels include at least one COR symbol 420. Additionally, the COR “payout” occurs independent of the state (e.g., inactive, intermediate, active) of collect feature metamorphic 430/metamorphic indicator 432 and/or whether a bonus reel game 500 is triggered (e.g., regardless of red screen). Turning to FIG. 20, collect feature symbol 418C is depicted in the predetermined reel 410 of the plurality of reels 402-410. Additionally, reels 404, 408, and 410 all include COR symbols 420A, 420B, 420C. In this example, win meter 422 may include a credit value of “275” that includes (1) a “100” credit award for the base reel game outcome and (2) the (175) collect credits (e.g., 50 cr. + 100 cr. + 25 cr.) associated with the COR credit values displayed on each COR symbol 420A, 420B, 420C.

Although the implementations shown in FIGS. 6-20 illustrate the bonus reel game 500 having a single enhancement feature, any of the enhancement features of the bonus reel game 500 may be mixed, matched, and combined during gameplay. For example, the bonus reel game 500 may include any combination of the expand feature, the grow feature, and/or the collect feature, such as any two of these features or all three of these features in a single bonus reel game 500.

For example, the grow feature and the collect feature may be triggered simultaneously. Although discussed herein as increasing dependent upon previous COR credit values, or alternatively having the collect value being random based on displayed COR credit values, it should be understood that the collect value for each subsequent free spin may include a predetermined minimum based on the grow feature of the metamorphic enhancement features. That is, where the grow feature and the collect feature are triggered simultaneously for bonus reel game 500, the minimum grow value displayed in banner 438 (see, FIGS. 12-15) may also determine and/or define a minimum for the collect value during each free spin. Continuing the example discussed herein, during the first free spin of bonus reel game 500,the grow value may be 0.5x the bet or wager value for base reel game 400. As such, any COR symbol 420 displayed in the bonus reel game outcome for the first free spin must display a COR credit value that is equal to or greater than 0.5x the bet or wager for base reel game 400.During a second, subsequent free spin of bonus reel game 500,the grow value may be 1.0x the bet or wager value for base reel game 400.COR symbol 420 displayed in the bonus reel game outcome for the second free spin must display a COR credit value that is equal to or greater than 1.0x the bet or wager for base reel game 400.

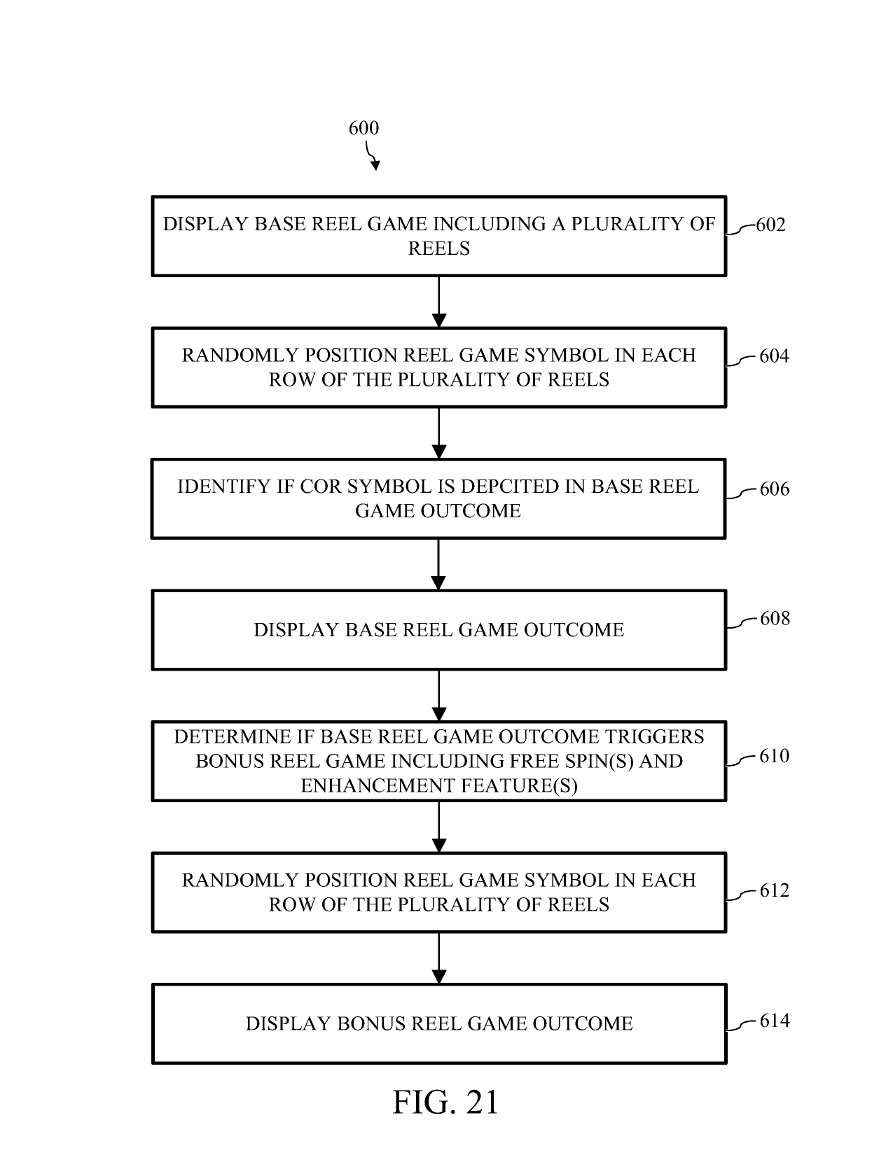

FIG. 21 illustrates an example computer-implemented method 600 of presenting one or more outcomes of a bonus reel game (e.g., the bonus game 500) having one or more enhancement features. The one or more outcomes of the bonus reel game correspond to, present, represent, and/or are determined from a primary game outcome. In the example implementation of the method 600, the primary game is a Class II (e.g., bingo) game, however, in other implementations, the primary game may be a Class III or Las-Vegas style game. The example method 600 may be implemented in a server (e.g., server computers 102)and/or a gaming device (e.g., gaming devices 104A-104X in FIG. 1 and/or gaming device 200 and/or mobile gaming device 256 in FIG. 2). For example, in an electronic gaming device, a game controller (e.g., game controller 202)includes one or more processors 204 operatively coupled to memory 208.The memory 208 can store one or more game programs 206 that provide program instructions and/or data for carrying out various implementations (e.g., game mechanics) that, when executed by the processor 204, cause the processor 204 to perform certain operations to perform the method 600.

In process 602 of the method 600 the controller (e.g., the game controller 202) and/or processor (e.g., processor 204) causes the display device (e.g., a primary game display 240 and/or a secondary game display 242) of the gaming device (e.g., gaming device 104A-104X) to display a base reel game (e.g., base reel game 400) The base reel game includes a plurality of reels depicted on the display device. Each reel of the plurality of reels for the base reel game includes a predetermined number of rows. In a non-limiting example, the predetermined number of rows may defer between at least a portion of the plurality of reels. For example, where there includes five (5) reels forming the plurality of reels, the row arrangement can include a 3x4x5x4x3 arrangement or pattern.

In process 604 of method 600, the controller and/or processor causes the plurality of reels to randomly display one game symbol of a plurality of game symbols in each row for each reel of the plurality of reels. In a non-limiting example, the plurality of game symbols include a graphic game symbol an enhancement feature symbol associated with an enhancement feature of at least one metamorphic enhancement features for a bonus reel game (e.g., bonus reel game 500),and a cash-on-reel COR symbol depicting a credit value. The enhancement feature symbols associated with the enhancement feature of the metamorphic enhancement features for the bonus reel game include, an expand feature symbol associated with an expand feature of the metamorphic enhancement features for the bonus reel game, an grow feature symbol associated with a collect feature of the metamorphic enhancement features for the bonus reel game, and/or a collect feature symbol associated with a collect feature of the metamorphic enhancement features for the bonus reel game.

In process 606 of method 600, the controller and/or processor identifies if the plurality of game symbols forming the base reel game outcome includes a COR symbol depicting a credit value. Additionally in process 606, the controller and/or processor identify if the plurality of game symbols forming the base reel game outcome includes the collect feature symbol associated with a collect feature of the metamorphic enhancement features in a predetermined reel of the plurality of reels.

In process 608 the controller and or processor causes the display device to display the base reel game outcome based on the randomly positioned plurality of game symbols in the plurality of reels. In response to identifying COR symbol(s) in the base reel game outcome and the collect feature symbol associated with a collect feature of the plurality of metamorphic enhancement features in a predetermined reel of the plurality of reels in the base reel game outcome (e.g., process 606), the controller and/or processor can also cause the display device to display and/or add a cash-on-reel COR collect value to a win meter along with the base reel game outcome. Where the COR collect value is equal to the credit value of the COR symbol or the sum of all credit values for all COR symbols included in the plurality of reels forming the base reel game outcome.

In process 610 of the method, the controller and/or processor determines that the displayed base reel game outcome (e.g., process 608) triggers a bonus reel game. The bonus reel game includes at least one free spin and at least one metamorphic enhancement feature. The at least one metamorphic enhancement features for the bonus reel game include an expand feature for increasing the predetermined number of rows for each reel of the plurality of reels during the at least one free spin, and a grow feature for increasing a minimum grow value during the at least one free spin. The metamorphic enhancement feature(s) for the bonus reel game can also include a collect feature for determining a collect value based on the COR credit value of COR symbol(s) displayed with the base reel game outcome. As such, process 610 can also include determining whether the at least one metamorphic enhancement feature includes the expand feature, the grow feature, and/or the collect feature.

In process 612 the controller and/or processor causes the plurality of reels to randomly display one game symbol of the plurality of game symbols in each row for each reel of the plurality of reels during the at least one free spin. Where the bonus reel game includes a plurality of free spins, the random positioning of the one game symbol in each row for each reel is performed as many times as there are free spins. Additionally in an example where the bonus reel game includes at least on metamorphic enhancement feature, the controller and/or processor cause other operations to be formed during process 612. For example, where the expand feature of the metamorphic enhancement feature(s) is included in the bonus reel game, the controller and/or processor causes the predetermined number of rows for each reel of the plurality of reels to be incrementally increased before the first free spin and after each subsequent free spin of the bonus reel game, until the predetermined number of rows equals a predetermined row threshold. Additionally, where the expand feature of the metamorphic enhancement feature(s) is included in the bonus reel game, the controller and/or processor causes the display device to incorporate distinct game symbols of a plurality of distinct game symbols into the plurality of game symbols used in the base reel game (e.g., process 602, 604). As such, where the expand feature is included in the bonus reel game, the controller and/or processor causes the plurality of reels to randomly position at least one of: one game symbol of the plurality of game symbols in each row for each reel of the plurality of reels during the each free spin of the at least one free spin and/or one distinct game symbol of a plurality of distinct game symbols in each row for each reel of the plurality of reels during the at least one free spin, the plurality of distinct game symbols used in combination with the plurality of game symbols.

Furthermore in process 612 where the grow feature of the metamorphic enhancement features is included in the bonus reel game, the controller and/or processor to define, determine, and/or calculate a minimum grow value based on a wager made in the base reel game. More specifically, a minimum grow value may be determined or defined for each free spin of the bonus reel game, and the minimum grow value may increase with each subsequent spin by multiplying the wager of the bonus reel game by a predetermined factor. For example, a minimum grow value for an initial or first free spin of the bonus reel game may equal half the wager of the base reel game. The minimum grow value may be increased for each subsequent free spin by multiplying the wager by a predetermined factor until the predetermine factor equals a predetermined factor threshold. The predetermined factor threshold is dependent, at least in part, on the number of free spins included in the bonus reel game. The minimum grow value may define a minimum for any COR credit value associated with COR symbol displayed in the bonus reel game outcome for subsequent free spins of the bonus reel game.

In another non-limiting example, where the grow feature of the metamorphic enhancement features is included in the bonus reel game in process 612, the controller and/or processor determines if the plurality of game symbols displaying the base reel game outcome include a COR symbol(s) depicting a credit value (e.g., COR credit value), and in response to determining, control or cause the display device to display the minimum grow value equal to the credit value of the displayed COR symbol during the first or initial free spin of the at least one free spin. Additionally where the grow feature of the metamorphic enhancement features is included in the bonus reel game, the controller and/or processor causes the minimum grow value to increase during subsequent free spins. The minimum grow value may increase during subsequent free spins when distinct COR credit value(s) associated with distinct COR symbols display credit values greater than the displayed minimum grow value.

In another non-limiting example where the collect feature of the metamorphic enhancement features is included in the bonus reel game, the controller and/or processor identifies either a single COR symbol depicting the credit value (e.g., COR credit value) present in the plurality of game symbols displaying the bonus reel game outcome for each of the at least one free spin, or a plurality of COR symbols present in the plurality of game symbols displaying the bonus reel game outcome for each of the at least one free spin. In the example, the plurality of COR symbols include a first COR symbol depicting a first credit value, and at least one distinct COR symbol depicting a distinct credit value smaller than the first credit value of the first COR symbol. Additionally, where the collect feature of the metamorphic enhancement features is included in the bonus reel game, the controller and/or processor controls the display device to display and/or add the collect value for each of the at least one free spin of the bonus reel game to the win meter. The collect value is equal to the credit value of the COR symbol where a single COR symbol is identified, or alternatively, twice the amount of the distinct credit value for the at least one distinct COR symbol added to the first credit value of the first COR symbol, where a plurality of COR symbols are identified.

In process 614 of method 600 the controller and/or processor controls or causes the display device to display the bonus reel game outcome for each of the at least one free spin. In an example, the bonus reel game outcome is based on the randomly positioned plurality of game symbols in the plurality of reels. Where the bonus reel game includes the expand feature, the bonus reel game outcome is based on the randomly positioned at least one of the plurality of the game symbols or the plurality of distinct game symbols in the plurality of reels.

A computer, controller, or server, such as those described herein, includes at least one processor or processing unit and a system memory. The computer, controller, or server typically has at least some form of computer readable non-transitory media. As used herein, the terms “processor” and “computer” and related terms, e.g., “processing device”, “computing device”, and “controller” are not limited to just those integrated circuits referred to in the art as a computer, but broadly refers to a microcontroller, a microcomputer, a programmable logic controller (PLC), an application specific integrated circuit, and other programmable circuits “configured to” carry out programmable instructions, and these terms are used interchangeably herein. In the implementations described herein, memory may include, but is not limited to, a computer-readable medium or computer storage media, volatile and nonvolatile media, removable and non-removable media implemented in any method or technology for storage of information such as computer readable instructions, data structures, program modules, or other data. Such memory includes a random access memory (RAM), computer storage media, communication media, and a computer-readable non-volatile medium, such as flash memory. Alternatively, a floppy disk, a compact disc – read only memory (CD-ROM), a magneto-optical disk (MOD), and/or a digital versatile disc (DVD) may also be used. Also, in the implementations described herein, additional input channels may be, but are not limited to, computer peripherals associated with an operator interface such as a mouse and a keyboard. Alternatively, other computer peripherals may also be used that may include, for example, but not be limited to, a scanner. Furthermore, in the exemplary implementation, additional output channels may include but not be limited to an operator interface monitor.

As indicated above, the process may be embodied in computer software. The computer software could be supplied in a number of ways, for example on a tangible, non-transitory, computer readable storage medium, such as on any nonvolatile memory device (e.g. an EEPROM ). Further, different parts of the computer software can be executed by different devices, such as, for example, in a client-server relationship. Persons skilled in the art will appreciate that computer software provides a series of instructions executable by the processor.

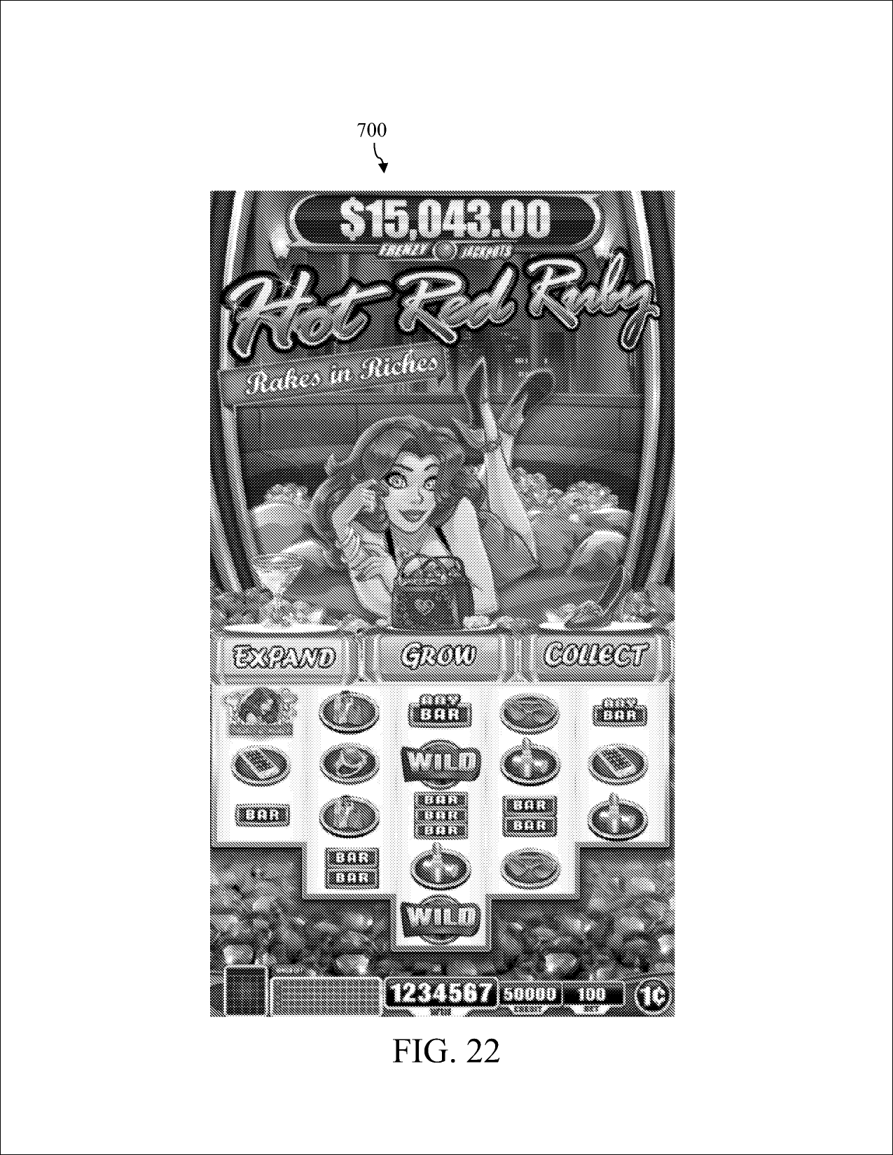

FIG. 22 is an illustrate example screenshot and/or interface 700 of an electronic game including a bonus reel game with multiple metamorphic game enhancements, as explained herein. Interface 700 shows an example of the base reel game.

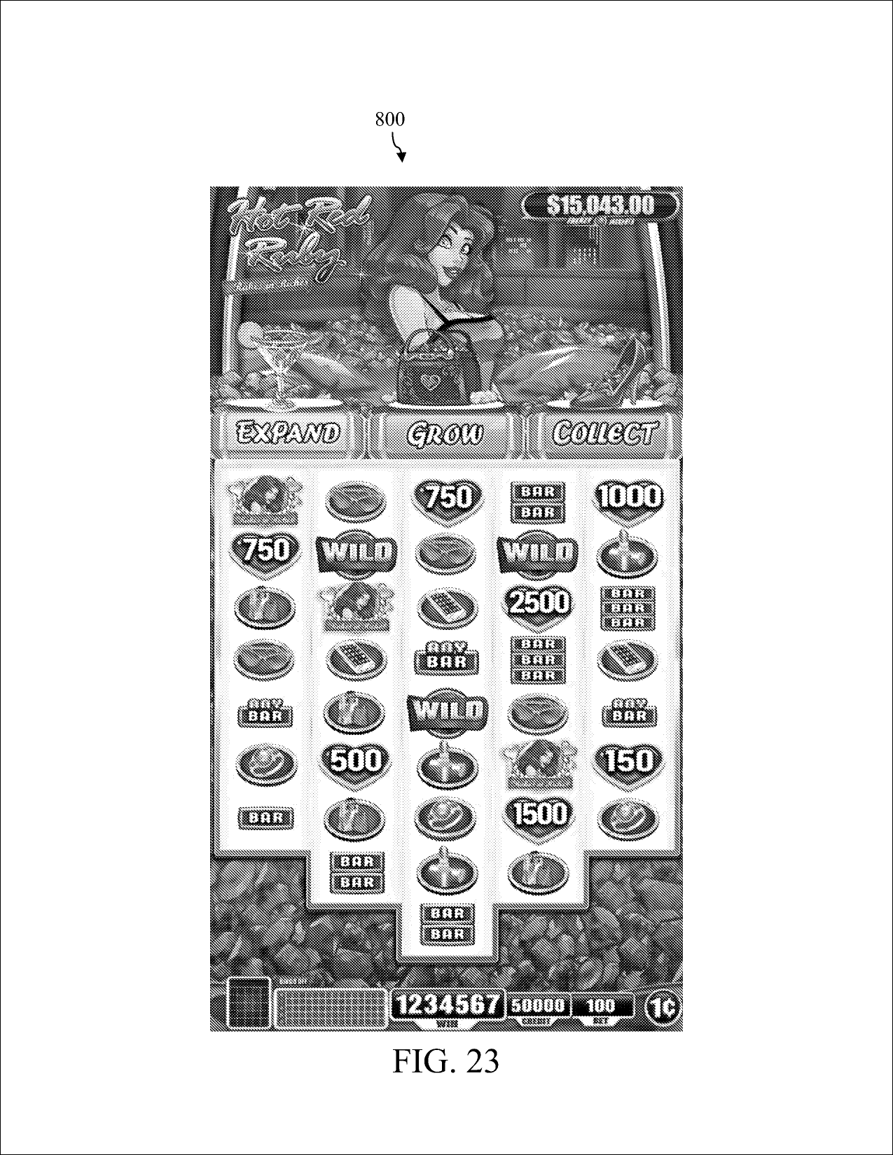

FIG. 23 is an illustrate example screenshot and/or interface 800 of an electronic game including a bonus reel game with multiple metamorphic game enhancements, as explained herein. Interface 800 shows an example of the bonus reel game including an expanded metamorphic enhancement feature.

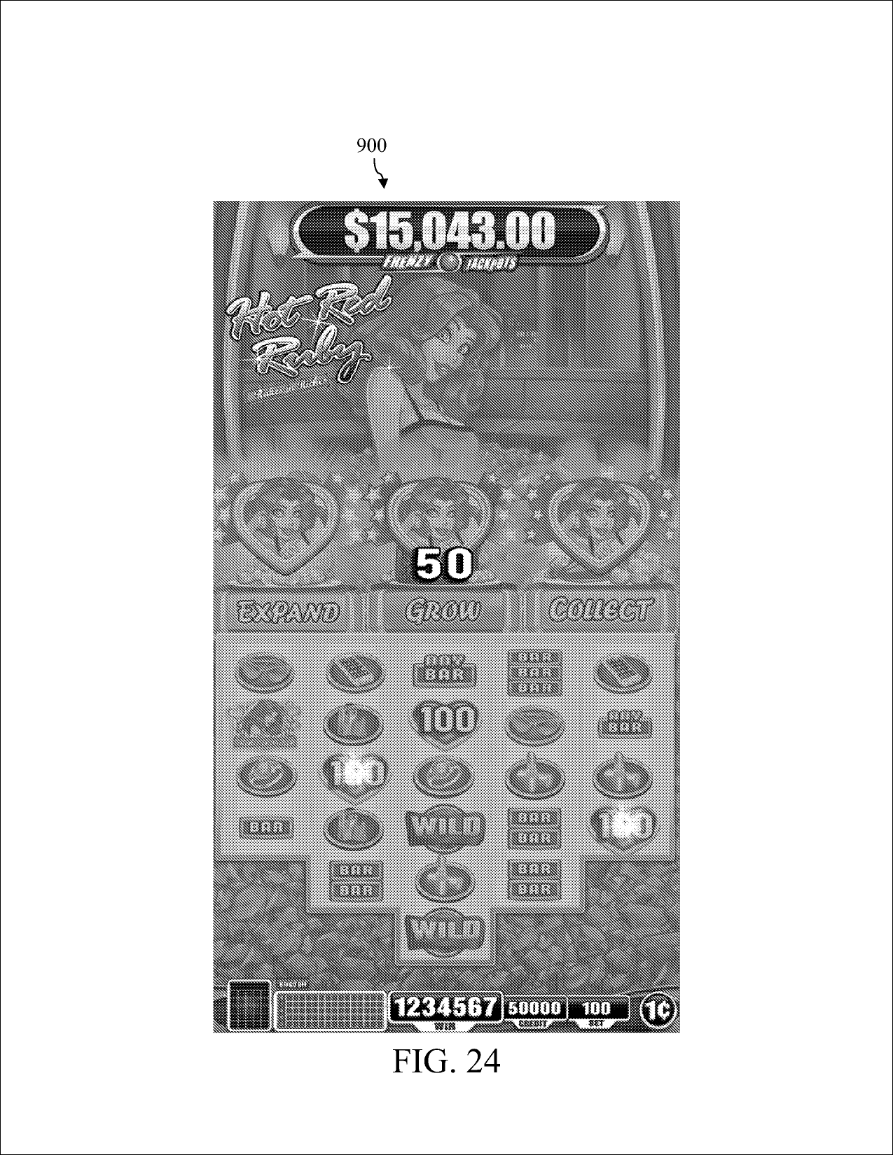

FIG. 24 is an illustrate example screenshot and/or interface 900 of an electronic game including a bonus reel game with multiple metamorphic game enhancements, as explained herein. Interface 900 shows an example of the bonus reel game including a “red screen” as well as expand, grow, and collect metamorphic enhancement features.

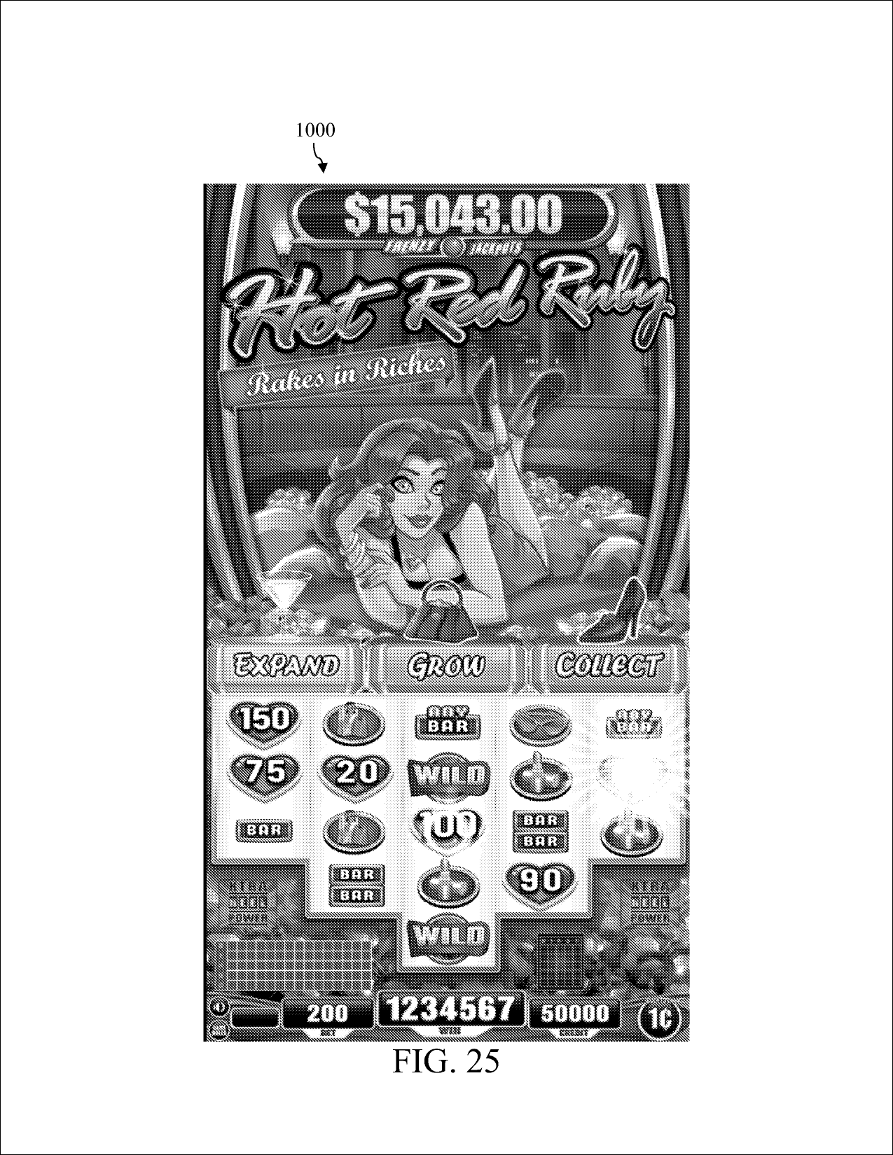

FIG. 25 is an illustrate example screenshot and/or interface 1000 of an electronic game including a bonus reel game with multiple metamorphic game enhancements, as explained herein. Interface 1000 shows an example of the base reel game including cash-on-reel (COR) symbols.

While the disclosure has been described with respect to the figures, it will be appreciated that many modifications and changes may be made by those skilled in the art without departing from the spirit of the disclosure. Any variation and derivation from the above description and figures are included in the scope of the present disclosure as defined by the claims.

What is claimed is:

1. An electronic gaming system comprising:
a display device; and
a game controller in communication with the display device, the game controller including at least one processor and at least one memory, the at least one memory for storing instructions, which when executed by the at least one processor, cause the game controller to:
control the display device to display a base reel game including a plurality of reels, each reel of the plurality of reels for the base reel game including a predetermined number of rows;
control the plurality of reels to randomly display a game symbol of a plurality of game symbols in each row of each reel of the plurality of reels;
control the display device to display a base reel game outcome based on the randomly displayed plurality of game symbols in the plurality of reels;
determine that the base reel game outcome triggers a bonus reel game, the bonus reel game including at least one free spin and a plurality of metamorphic enhancement features; and
determine the plurality of metamorphic enhancement features include:
a grow feature for increasing a minimum grow value during the at least one free spin; and
a collect feature for determining a collect value based on a cash-on-reel (COR) credit value displayed with the base reel game outcome.

2. The electronic gaming system of claim 1, wherein in response to determining that the base reel game outcome triggers the bonus reel game, the at least one processor further cause the game controller to:
control the plurality of reels to randomly display one game symbol of the plurality of game symbols in each row for each reel of the plurality of reels during the at least one free spin; and
control the display device to display a bonus reel game outcome for the at least one free spin, based on the randomly displayed plurality of game symbols in the plurality of reels.

3. The electronic gaming system of claim 2, wherein the plurality of game symbols include:
a graphic game symbol;
a metamorphic enhancement feature symbol associated with one of the plurality of metamorphic enhancement features for the bonus reel game; and
a cash-on-reel (COR) symbol depicting the COR credit value.

4. The electronic system of claim 3, wherein the instructions stored in the memory device, when executed by the processor, further cause the game controller to:
determine whether the plurality of metamorphic enhancement features include an expand feature for increasing the predetermined number of rows for each reel of the plurality of reels during the at least one free spin,
wherein the expand feature incrementally increases the predetermined number of rows for each reel of the plurality of reels after each of the at least one free spin until the predetermined number of rows equals a predetermined row threshold.

5. The electronic system of claim 4, wherein in response to the bonus reel game including the expand feature of the plurality of metamorphic enhancement features, the instructions stored in the memory device, when executed by the processor, further cause the game controller to:
in response to determining that the bonus reel game is triggered, control the plurality of reels to randomly display one of:
one game symbol of the plurality of game symbols in each row for each reel of the plurality of reels during the at least one free spin, or
one distinct game symbol of a plurality of distinct game symbols in each row for each reel of the plurality of reels during the at least one free spin, the plurality of distinct game symbols used in combination with the plurality of game symbols; and
control the display device to display the bonus reel game outcome for the at least one free spin, based on the randomly displayed at least one of the plurality of game symbols or the plurality of distinct game symbols in the plurality of reels.

6. The electronic system of claim 3, wherein the instructions stored in the memory device, when executed by the processor, further cause the game controller to:
determine that the plurality of game symbols displaying the base reel game outcome included the COR symbol depicting the COR credit value;
control the display device to display the minimum grow value equal to the COR credit value of the displayed COR symbol during an initial free spin of the at least one free spin; and
increase the minimum grow value to equal at least one subsequent COR credit value for at least one distinct COR symbol displayed during the at least one free spin subsequent to the initial free spin, the at least one subsequent COR credit value for the at least one distinct COR symbol is equal to or greater than the COR credit value of the displayed COR symbol.

7. The electronic system of claim 1, wherein the instructions stored in the memory device, when executed by the processor, further cause the game controller to:
control the display device to display the minimum grow value equal to half a wager made in the base reel game during the initial free spin of the at least one free spin; and
increase the minimum grow value by a predetermined factor for each of the at least one free spin subsequent to the initial free spin until the predetermined factor equals a predetermined factor threshold.

8. The electronic system of claim 3, wherein the instructions stored in the memory device, when executed by the processor, further cause the game controller to:
identify one of:
the COR symbol depicting the COR credit value present in the plurality of game symbols displaying the bonus reel game outcome for each of the at least one free spin, or
a plurality of COR symbols present in the plurality of game symbols displaying the bonus reel game outcome for each of the at least one free spin, the plurality of COR symbols including:
a first COR symbol depicting a first COR credit value; and
at least one distinct COR symbol depicting a distinct COR credit value smaller than the first COR credit value of the first COR symbol; and
control the display device to display the collect value for each of the at least one free spin, the collect value equal to:
the COR credit value of the COR symbol, or
. the distinct COR credit value for the at least one distinct COR symbol added to the first COR credit value of the first COR symbol.

9. The electronic system of claim 4, wherein the metamorphic enhancement feature symbol of the plurality of game symbols further include:
an expand feature symbol associated with the expand feature of the plurality of metamorphic enhancement features for the bonus reel game;
a grow feature symbol associated with the grow feature of the plurality of metamorphic enhancement features for the bonus reel game; and
an collect feature symbol associated with the collect feature of the plurality of metamorphic enhancement features for the bonus reel game.

10. The electronic system of claim 9, wherein the instructions stored in the memory device, when executed by the processor, further cause the game controller to:
identify if the plurality of game symbols displaying the base reel game outcome include the COR symbol depicting the COR credit value and the collect feature symbol in a predetermined reel of the plurality of reels; and
control the display device to display a cash-on-reel (COR) collect value with the base reel game outcome, the COR collect value equal to the COR credit value of the COR symbol.

11. A method of electronic gaming implemented on an electronic gaming machine, the method comprising:
causing to be displayed a base reel game including a plurality of reels, each reel of the plurality of reels for the base reel game including a predetermined number of rows;
controlling the plurality of reels to randomly display a game symbol of a plurality of game symbols in each row of each reel of the plurality of reels;
causing to be displayed a base reel game outcome based on the randomly displayed plurality of game symbols in the plurality of reels;
determining that the base reel game outcome triggers a bonus reel game, the bonus reel game including at least one free spin and a plurality of metamorphic enhancement features; and
determining the plurality of metamorphic enhancement features include:
a grow feature for increasing a minimum grow value during the at least one free spin; and
a collect feature for determining a collect value based on a cash-on-reel (COR) credit value displayed with the base reel game outcome.

12. The method of claim 11, further comprising:
controlling the plurality of reels to randomly display one game symbol of the plurality of game symbols in each row for each reel of the plurality of reels during the at least one free spin, in response to determining that the base reel game outcome triggers the bonus reel game; and
causing to be displayed a bonus reel game outcome for the at least one free spin, based on the randomly displayed plurality of game symbols in the plurality of reels.

13. The method of claim 11, further comprising:
determining whether the plurality of metamorphic enhancement features include an expand feature for increasing the predetermined number of rows for each reel of the plurality of reels during the at least one free spin,
wherein the expand feature incrementally increases the predetermined number of rows for each reel of the plurality of reels after each of the at least one free spin until the predetermined number of rows equals a predetermined row threshold.

14. The method of claim 11, wherein the plurality of game symbols include:
a graphic game symbol;
a metamorphic enhancement feature symbol associated with one of the plurality of metamorphic enhancement features for the bonus reel game; and
a cash-on-reel (COR) symbol depicting the COR credit value.

15. The method of claim 14, further comprising:
determining that the plurality of game symbols displaying the base reel game outcome included the COR symbol depicting the COR credit value;
causing to be displayed the minimum grow value equal to the COR credit value of the displayed COR symbol during an initial free spin of the at least one free spin; and
increasing the minimum grow value to equal at least one subsequent COR credit value for at least one distinct COR symbol displayed during the at least one free spin subsequent to the initial free spin, the at least one subsequent COR credit value for the at least one distinct COR symbol is equal to or greater than the COR credit value of the displayed COR symbol.

16. The method of claim 11, further comprising:
causing to be displayed the minimum grow value equal to half a wager made in the base reel game during the initial free spin of the at least one free spin; and
increasing the minimum grow value by a predetermined factor for each of the at least one free spin subsequent to the initial free spin until the predetermined factor equals a predetermined factor threshold.

17. The method of claim 14, further comprising:
identifying one of:
the COR symbol depicting the COR credit value present in the plurality of game symbols displaying the bonus reel game outcome for each of the at least one free spin, or
a plurality of COR symbols present in the plurality of game symbols displaying the bonus reel game outcome for each of the at least one free spin, the plurality of COR symbols including:
a first COR symbol depicting a first COR credit value; and
at least one distinct COR symbol depicting a distinct COR credit value smaller than the first COR credit value of the first COR symbol; and
causing to be displayed the collect value for each of the at least one free spin, the collect value equal to:
the COR credit value of the COR symbol, or
. the distinct COR credit value for the at least one distinct COR symbol added to the first COR credit value of the first COR symbol.

18. The method of claim 17, further comprising:
identifying if the plurality of game symbols displaying the base reel game outcome include the COR symbol depicting the COR credit value and the collect feature symbol in a predetermined reel of the plurality of reels; and
causing to be displayed a cash-on-reel (COR) collect value with the base reel game outcome, the COR collect value equal to the COR credit value of the COR symbol.

19. A non-transitory computer-readable storage medium with instructions stored thereon that, in response to execution by at least one processor, cause the at least one processor to:
control a display device to display a base reel game including a plurality of reels, each reel of the plurality of reels for the base reel game including a predetermined number of rows;
control the plurality of reels to randomly display a game symbol of a plurality of game symbols in each row of each reel of the plurality of reels;
control the display device to display a base reel game outcome based on the randomly displayed plurality of game symbols in the plurality of reels;
determine that the base reel game outcome triggers a bonus reel game, the bonus reel game including at least one free spin and a plurality of metamorphic enhancement features; and
determine the plurality of metamorphic enhancement features include:
a grow feature for increasing a minimum grow value during the at least one free spin; and
a collect feature for determining a collect value based on a cash-on-reel (COR) credit value displayed with the base reel game outcome.

20. The non-transitory computer-readable storage medium of claim 19, wherein the instructions, when executed, cause the at least one processor to:
control the plurality of reels to randomly display one game symbol of the plurality of game symbols in each row for each reel of the plurality of reels during the at least one free spin, in response to determining that the base reel game outcome triggers the bonus reel game; and
control the display device to display a bonus reel game outcome for the at least one free spin, based on the randomly displayed plurality of game symbols in the plurality of reels.
